(19) United States
(12) Patent Application Publication
(10) Pub. No.: US 2026/0300532 A1
(43) Pub. Date: Oct. 1, 2026

(54) Dynamically Inserting Guard Conditions into a Database Query to Protect Privacy and Confidentiality and Prevent Data Leak

(71) Applicant: NextLabs, Inc., San Mateo, CA (US)

(72) Inventors: Keng Lim, Atherton, CA (US); Poon Fung, Cupertino, CA (US)

(21) Appl. No.: 19/631,414

(22) Filed: Mar. 27, 2026

Related U.S. Application Data
(60) Provisional application No. 63/779,876, filed on Mar. 28, 2025.

(51) Int. Cl. G06F 21/62; G06F 21/60

(52) U.S. Cl. CPC G06F 21/6227; G06F 21/604; G06F 21/6245

(57) ABSTRACT

A method and system authorizes access or use of information or protects data across organizations via federated authorization. A user in second organization attempts to open a document on a server application in first organization. Data protection client intercepts. First policy engine determines the user belongs to second organization. Evaluate policies to make sure second organization has access to the document. Request guest policies form second policy engine. Evaluate guest policies in first policy engine to make a final decision.

### CROSS-REFERENCE TO RELATED APPLICATIONS

This patent application claims the benefit of U.S. patent application 63/779,876, filed Mar. 28, 2025, which is incorporated by reference along with all other references cited in this application.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

The present invention relates to the field of software and data protection, and more specifically, to authorize access and use of information across organizations.

Federated authorization is a model where multiple independent systems agree to trust a shared way of granting access, so a user or service can access resources across organizational or domain boundaries without needing separate accounts or permissions in each place. It builds on the broader idea of federation—a trust relationship between domains—and applies it specifically to authorization decisions.

Federation is common in enterprise environments where organizations need to share resources securely. Federation as a trust relationship that typically includes authentication and almost always includes authorization, allowing multiple organizations to share access to resources through established trust.

One common authorization method is OAuth 2.0 which delegated authorization for application programming interfaces (APIs), allowing applications to obtain limited access without passwords. OAuth 2.0 is built around tokens, not repeated logins. After the initial authentication and consent: (a) the access token is used by the client to call APIs directly; (b) the resource server validates the token and grants access; and (c) the user is not involved again unless the token is invalid or expired. This design allows applications to access resources without necessarily revealing a user's credentials or identity, relying instead on the issued access token. Most OAuth deployments issue short-lived access tokens for security. When they expire, the client typically uses a refresh token to obtain a new access token without requiring the user to log in again. Refresh tokens exist specifically to avoid repeated authentication and are used to obtain a new access token when the current access token becomes invalid or expires.

While the OAuth 2.0 approach of using a time-based token to control access is simple, it does not provide fine-gained access control to resources. A more flexible and dynamic approach such as federated authorization through declarative attribute-based access control policies is needed.

### BRIEF SUMMARY OF THE INVENTION

A method and system authorizes access or use of information or protects data across organizations via federated authorization. A user in second organization attempts to open a document on a server application in first organization. Data protection client intercepts. First policy engine determines the user belongs to second organization. Evaluate policies to make sure second organization has access to the document. Request guest policies form second policy engine. Evaluate guest policies in first policy engine to make a final decision.

In an implementation, a user in second organization attempts to open a document on a server application in first organization. Data protection client intercepts. First policy engine determines the user belongs to second organization. Evaluate policies to make sure second organization has access to the document. If first decision is allow, call second policy engine to evaluate. Final decision comes from second policy engine. Second policy engine may sit in first organization having only guest policies. Second policy engine may sit in second organization having access or use or rights control policies.

In various implementations, the first organization is separate from the second organization. Users of the first organization are managed by first information systems (e.g., hardware or software, or both) of the first organization, while users of the second organization are managed by second information systems (e.g., hardware or software, or both) of the second organization. The first and second organizations can be completely separate entities, governance wise and systems wise. The first organization can have a first wide area network (WAN) IP address (e.g., public IPv4 or IPv6 address, or both), while the second organization can have a second wide area network IP address, where the first and second wide area network addresses are different.

As further example, the first organization can maintain a first firewall. The second organization can maintain a second firewall, which is separate from the first firewall. The first and second organizations can have separate networking hardware (e.g., routers and switches), where is the hardware is connected by a wide area network (WAN) such as the Internet (e.g., only a WAN connection or only an Internet connection). Further, interconnectivity between the organizations can be via only the Internet, or can be by a dedicated or leased line between the two organizations. Respective firewalls remain in place at each organization, which are managed by systems personnel at each organization. Further, the first organization may have a company-wide firewall, while the second organization does not, and vice versa. As an example, the second organization may have second firewalls for one or more clients.

Furthermore, the first and second organizations may be subsidiaries of a parent organization. For example, the first organization may be a company of the parent in a first country or geographic location, while the second organization may be a company of the parent in a second country or geographic location, different from the first. The first organization may be a parent organization that has merged with the second organization, but first and second organizations maintain isolated information and user environments from each other. As was discussed above, the organizations may have different and independent networking hardware and firewall implementation. Other types of divisions between first and second organizations are possible and aspects described in this patent will apply.

In an implementation, a user in second organization attempts to open a web page on a server application in first organization. Data access enforcer intercepts. First policy engine determines the user belongs to second organization. Evaluate policies to make sure second organization has access to the data. Request guest policies form second policy engine. Evaluate guest policies in first policy engine to make final decision. Apply masking or filtering obligations on database queries.

In an implementation, a user in second organization attempts to view a web page on a server application in first organization. Data access enforcer intercepts. First policy engine determines the user belongs to second organization. Evaluate policies to make sure second organization has access to the data. If first decision is allow, call second policy engine to evaluate. Final decision comes from second policy engine. Second policy engine may sit in first organization having only guest policies. Second policy engine may sit in second organization having access or use or rights control policies. Apply masking and filtering to protect data.

In an implementation, embedding guest policies generated by an authorization provider into authorization claims, so that guest policies will get a ride from second organization to first organization, and guest policies will be enforced in first organization when a user in second organization accesses a document in the first organization.

In an implementation, second policy engine selects a subset of policies and evaluates to produce guest policies. Second policy engine selects a subset of policies and returns the subset as guest policies. Second policy engine selects a subset of policies and evaluates to produce an identifier. Authorization provider retrieves guest policies based on the identifier.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a simplified block diagram of a distributed computer network and clients.

FIG. 2 shows a more detailed diagram of a computer system which may be a client or server.

FIG. 3 shows a system block diagram of computer system.

FIG. 4 shows a logic diagram of a server application delegating authentication function to an identity provider.

FIG. 5 shows a logic diagram of a server application in a first organization delegating authentication of a user to a first identity provider in the first organization and a second identity provider in a second organization in a federated authentication arrangement.

FIG. 6 shows a block diagram of an identity assertion.

FIG. 7 shows a functional block diagram of an authorization provider producing authorization claims for an identity provider dynamically based on policies.

FIG. 8 shows a functional block diagram of an authorization provider using an external policy engine to make authorization claim decisions.

FIG. 9 shows a functional block diagram of an authorization provider with an integrated policy engine.

FIG. 10 shows a logic diagram of a server application delegating authentication function to an identity provider and an authorization provider producing authentication claims dynamically for an authenticated user.

FIGS. 11A-11C show a flow diagram of a user accessing a company portal using a web browser and the company portal authenticates the user by delegating authentication to an identity provider.

FIG. 12 shows a functional block diagram of federated authentication and authorization arrangements between two organizations.

FIG. 13 shows a logic diagram of a data protection client protecting access to information or documents on a server application in a first organization by enforcing guest policies obtained from a second organization while authenticating a user from the second organization in federated authentication and authorization arrangements.

FIGS. 14A-14D show a flow diagram of enforcement of guest policies from a second organization on access to a document on a server application in a first organization.

FIG. 15 shows a functional block diagram of cooperative policy enforcement across two organizations with policy engines in a peer-to-peer arrangement.

FIG. 16 shows a logic diagram of a server application in a first organization enforcing policies with a data protection client on access to information or documents by a user in a second organization where policy engines in the two organizations collaborate in making policy decisions.

FIG. 17 shows a functional block diagram of cooperative policy enforcement across two organizations with policy engines co-location.

FIGS. 18A-18C show a flow diagram of cooperative policy enforcement on access to a document on a server application in a first organization by a user from a second organization where the two organizations collaborate in making access or use control decisions.

FIG. 19 shows a functional block diagram of cooperative policy enforcement across two organizations with policy engines connected through a federated authorization server.

FIG. 20 shows a logic diagram of a server application in a first organization enforcing policies with a data protection client on access to information or documents by a user from a second organization where policy engines in the two organizations make policy decisions jointly while communicating through a federated authorization server.

FIGS. 21A-21C show a flow diagram of cooperative policy enforcement on access to a document in a first organization by a user from a second organization where policy decisions are made jointly by policy engines in the two organizations communicating through a federated authorization server.

FIGS. 22A-22C show a flow diagram of cooperative policy enforcement on viewing of data retrieved from a database in a first organization by a user from a second organization where access control and data obfuscation decisions are made jointly by policy engines in the two organizations.

FIG. 23 shows a block diagram of federated authorization servers in a hierarchical arrangement.

### DETAILED DESCRIPTION OF THE INVENTION

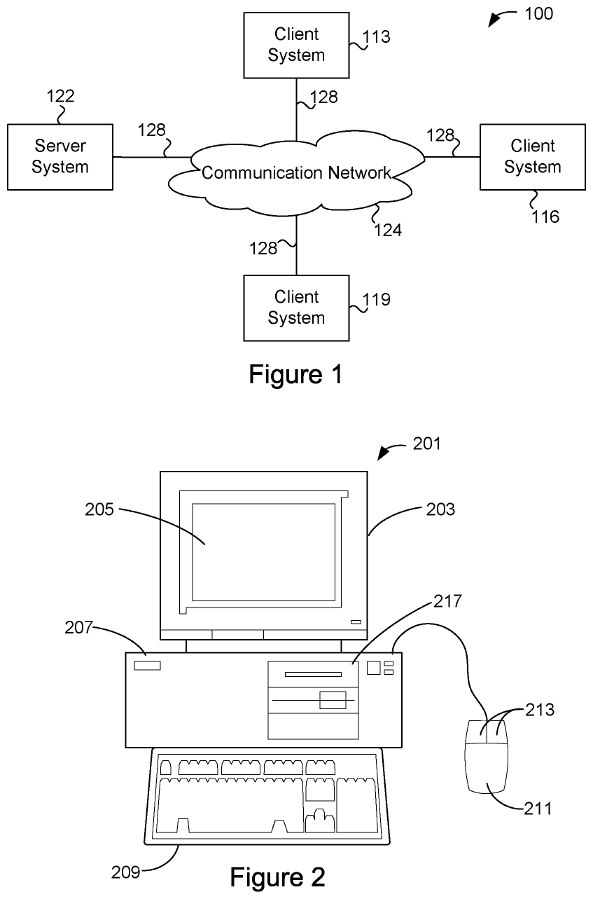

FIG. 1 shows a simplified block diagram of a distributed computer network 100 incorporating an embodiment of the present invention. Computer network 100 includes a number of client systems 113, 116, and 119, and a server system 122 coupled to a communication network 124 via a number of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, vendor-specific protocols, customized protocols, or others. While in one embodiment, communication network 124 is the Internet, in other embodiments, communication network 124 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server computer system which provides the information. For this reason, servers typically have more computing and storage capacity than client systems. However, a particular computer system may act as both as a client or a server depending on whether the computer system is requesting or providing information. Additionally, although the invention has been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server 122 or may alternatively be delegated to other servers connected to communication network 124.

Client systems 113, 116, and 119 enable users to access and query information stored by server system 122. In a specific embodiment, a “web browser” application executing on a client system enables users to select, access, retrieve, or query information stored by server system 122. Examples of web browsers include the Edge browser by Microsoft Corporation, Firefox® browser by Mozilla Foundation, Chrome browser by Google Inc., Safari browser by Apple Inc., or others.

FIG. 2 shows a more detailed diagram of a computer system which may be a client or server. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like. Mass storage devices 217 may include mass disk drives, floppy disks, USB removable storage, magnetic disks, fixed disks, hard disks, hard drives including both magnetic and flash storage in a single drive unit, CD-ROMs, recordable CDs, DVDs, DVD-R, DVD-RW, HD-DVD, Blu-ray DVD, flash and other nonvolatile solid-state storage, tape storage, reader, and other similar media, and combinations of these.

A computer-implemented or computer-executable version of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media may also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

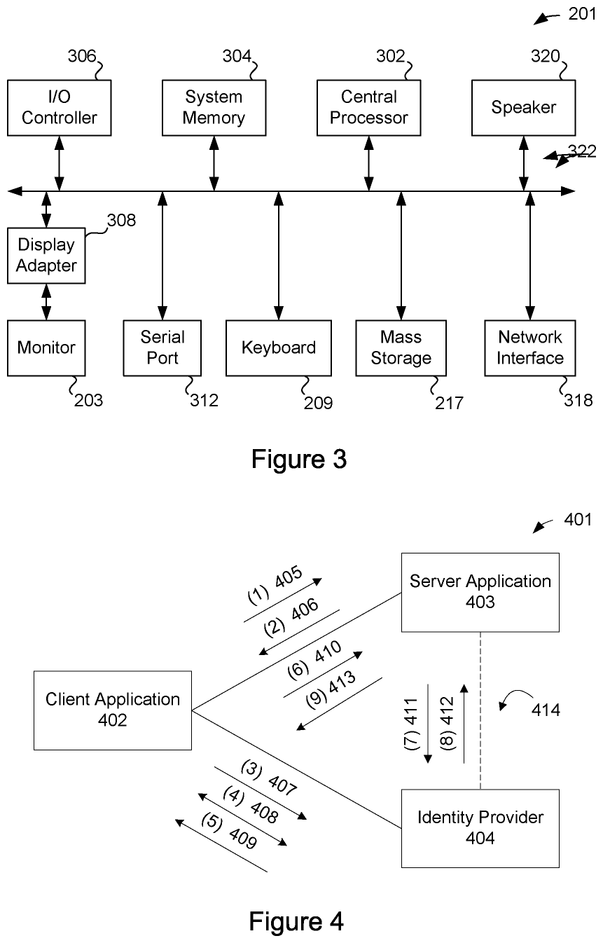

FIG. 3 shows a system block diagram of computer system 201 used to execute the software of the present invention. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory. The processor may be a multicore processor, such as the Intel Core family, AMD Ryzen family, Nvidia Grace or Vera central processing unit (CPU) families, or Apple M-series family.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. Computer system 201 shown in FIG. 2 is an example of a computer system suitable for use with the present invention. Other configurations of subsystems suitable for use with the present invention shall be readily apparent to one of ordinary skill in the art.

Computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Oracle®) or Enterprise Java Beans (EJB from Oracle®). An operating system for the system may be one of the Microsoft Windows® family of operating systems (e.g., Windows 95, 98, Me, Windows NT, Windows 2000, Windows XP, Windows Vista, Windows 7, Windows 8, Windows 10, Windows 11, Windows CE, Windows Mobile), Linux, UNIX, Sun OS, Ubuntu, or Macintosh OS X. Other operating systems may be used. Microsoft Windows is a trademark of Microsoft Corporation.

Furthermore, the computer may be connected to a network and may interface to other computers using this network. For example, each computer in the network may perform part of the task of the many series of circuit simulation steps in parallel. Furthermore, the network may be an intranet, internet, or the Internet, among others. The network may be a wired network (e.g., using copper), telephone network (e.g., public switch telephone network or PSTN), packet network, an optical network (e.g., using optical fiber), or a wireless network, or any combinations thereof. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

This patent application incorporates by reference U.S. patent application Ser. No. 11/383,159, filed May 12, 2006, Ser. No. 11/615,477, filed Dec. 22, 2006, Ser. No. 13/165,730, filed Jun. 21, 2011, Ser. No. 13/193,588, filed Jul. 28, 2011, Ser. No. 13/439,827, filed Apr. 4, 2012, 15/268,155, filed Sep. 16, 2016, Ser. No. 15/291,653, filed Oct. 12, 2016, Ser. No. 15/482,655, filed Apr. 7, 2017, Ser. No. 15/673,338, filed Aug. 9, 2017 and Ser. No. 18/332,671, filed Jun. 9, 2023.

An aspect of the invention is an information management system employs a plurality of policies to protect information or documents from unauthorized access or misuse, protect privacy and confidentiality of information or document content and prevent data leaks.

Another aspect of the invention is a first information management system in a first organization cooperates with a second information management system in a second organization to control access to information or document in the first organization accessible by a user in the second organization. Examples of organizations include companies, government entities, non-profit entities, institutions, subsidiaries, divisions, departments, projects, groups, or others.

In an embodiment, an information management system employs a plurality of policies, a policy server, a plurality of policy engines, a plurality of identity providers, a plurality of authorization providers, a plurality of data protection clients, a plurality of container service modules, a plurality of encryption service modules, a federated authorization server, or any combinations thereof to protect information or documents.

Authentication is about verifying identity-proving who you are. For example, authentication may involve means such as password, biometric, one-time code, and many more. Authorization is about granting permissions-determining what you're allowed to do after your identity is confirmed. Authentication always happens first. Once the system knows who you are, authorization decides what resources or actions you can access.

Federated authentication is a way for users to sign in once with a trusted identity provider and then access multiple independent applications or services without needing separate usernames and passwords for each one. It creates a secure “trust bridge” between systems so identity can be shared safely across organizational or domain boundaries.

Federated authentication lets a user log in through a trusted identity provider (IDP)—such as Azure Active Directory® (or Microsoft Entra ID®), Okta®, Google Identity®, or another organization—and then use that verified identity to access multiple applications or websites that trust that provider. This improves both user experience and security because credentials are never repeatedly shared with each service. Federation authentication is commonly implemented through Single Sign-On (SSO) protocols such as Security Assertion Markup Language (SAML), Open Authorization (OAuth), or OpenID Connect (OIDC).

The process works as follows: (1) a user attempts to access an application; (2) the application redirects the user to a trusted identity provider for authentication; (3) the user authenticates with the identity provider using their credentials; (4) the identity provider generates an identity assertion or token and sends it back to the application; and (5) the user gains access to the application without needing to log in again and can access other federated applications seamlessly.

Applications accept the identity assertion because they trust the identity provider. This trust relationship is the foundation of federated identity systems. The trust relationship is often established through metadata exchange, certificates, pre-configured agreements, or others. It is widely used for social logins (e.g., Google or Facebook) and enterprise SSO scenarios, reducing the need for multiple credentials and improving user experience.

Information may be retrieved from a data store, derived from existing data, or produced by an application program. Information includes data in relational databases, data in Enterprise Resource Planning (ERP) systems, data in Product Lifecycle Management (PLM) systems, data in analytics applications, data in collaboration systems such as Microsoft SharePoint®, data in Cloud applications, data on web servers, data delivered to SAPR client applications (e.g., SAP GUI), data in source code control systems, data in issue tracking systems, or others.

A document encompasses objects such as file, compound document, e-mail message, web page, on-line report, on-line form, discussion thread, result set generated by a database query (e.g., SQL), bitmap, file system object, data object attached to an e-mail message, data object managed by a document management system, data object managed by a content management server, data object in a product lifecycle management system, source code file or code fragment managed by a source code management system, data object managed by a configuration management system, data object managed by a project management system, data object in an enterprise resource planning system, data object in a customer relationship management system, data object managed or served, or both by a portal server, data object served by a web server, data object managed or served by any application server, attachments in various forms, images in various forms, compound document such as zip file, or any unit of information content stored using volatile or nonvolatile memory.

A document may be a file system or non-file system object. A document may be stored in memory or a disk of a computing device, removable storage device, document repository, database, another document, document archive, or more. If a document is a file, the file may be stored on a disk or memory of a computing device, file server, database, document management system, intranet or Internet file store, cloud storage, removable hard disk or flash drive, CD-ROM, DVD, or others.

A computing device may include an application server, database server, file server, desktop computer, laptop computer, tablet computer, smartphone, information kiosk, augmented reality system, game console, navigation system, or others. A computing device may be physical or virtual. Examples of virtual computing devices include virtual machines (VMs), containers, or others. Examples of VMs include VMware vSphere®, VMware ESXi™, Microsoft Hyper-VR, AWS EC2™ instances, Microsoft Azure Virtual Machines™, Google Compute Engine™, or others. Examples of containers include Docker®, Podman®, Kubernetes® containers, or others.

The plurality of policies in an information management system comprises at least one of access or use control policies, rights control policies, data access policies, encryption policies, authorization claim policies, or other policies that control access to or use of information or documents, protect privacy and confidentiality of information at rest or in transit, and prevent data leaks.

An access or use control policy controls access to and use of information or documents, and it is applied to prevent unauthorized access to information or documents and provide continue protection while information or documents is being processed by an application program. Examples of application programs in the context of access or use control policy include web servers, Enterprise Resource Management (ERP) applications, Product Lifecycle Management (PLM) applications, collaborative platforms, analytical and reporting applications, source code control applications, application servers, word processors, spreadsheets, presentation programs, document viewers, web browsers, e-mail clients, instant messengers, or many others. Access or use control policies are described in detail in U.S. patent application Ser. No. 11/615,477, filed Dec. 22, 2006, and U.S. patent applications aforementioned and incorporated by reference.

A rights control policy protects documents, and it is applied to control use of document content and prevent misuse based on rights granted to a user. Rights control policies are described in detail in U.S. patent application Ser. No. 15/268,155, filed Sep. 16, 2016, and U.S. patent applications aforementioned and incorporated by reference.

A data access policy protects access to data in a database, and it is applied to protect privacy and confidentiality and prevent data leaks. Data access policies may be applied to implement masking (or obfuscating, or redacting) of data (e.g., fields or columns) returned by a database query (e.g., SQL). Data access policies may also be applied to implement filtering (or restricting, or limiting) data (e.g., records or rows) returned by a database query. Data access policies may also block queries from executing successfully. Blocking a database query may cause return of an error or return an empty result set.

Examples of protecting privacy include not displaying a customer's age, a patient's health condition, a person's sexual orientation, data protected by privacy laws, or others, to a non-privileged (or unauthorized) user. Examples of privacy laws include Health Insurance Portability and Accountability Act (HIPPA), General Data Protection Regulation (GDPR), or others. Examples of protecting confidentiality including not displaying the amount on a contract that shall stay confidential, sales data of a company, design data that is a company's secret, data covered by the laws that must stay confidential (e.g., security laws, or legal judgments), data that a company is contractually obliged to keep secret, or others, to a non-privileged (or unauthorized) user. An example of security laws is International Traffic in Arms Regulations (ITAR). Examples of preventing data leaks include preventing unauthorized access to data by personnel internal or external to an organization caused by an error, a malicious hack, or others. Data access policies are described in U.S. patent application Ser. No. 18/332,671, filed Jun. 9, 2023.

Authorization claim policies are policies that produce authorization claim decisions. Authorization claim decisions are intermediate authorization instructions. Examples of authorization claim decisions include roles, access or usage permissions, rights, user attributes, resource identifiers, resource attributes, guest policies, guest policy identifiers, or others. Roles may correspond to functional roles in an organization, logical grouping of functions for selected tasks, logical grouping of resources, or others. Rights may include read, write, print, export, send, or others. User attributes may be used to control access to resources. Resource identifiers may include application names, application identifiers, Universal Resource Locators (URLs), directory or file paths, directory or file names, or others. Resource attributes may include file types, file extensions, regular expression for matching file names, or others. The authorization claim decisions may be delivered to an application program (e.g., on roles) or a policy engine where a policy decision will be made (e.g., on guest policies).

Authorization claim policies enable integration of existing application programs into an information management system described in this document. Authorization claim policies also enable extending federated authentication systems (e.g., Microsoft Active Directory® or OpenLDAP®) to support fine-gained access control of resources across organizations.

Guest policies are policies enforced in a first organization to control access to or use of information or documents in the first organization by a user in a second organization. Guest policies are created in a second organization but often deployed via federation authorization. Instead of deploying guest policies in the first organization through manual means, federated authorization allows guest policies to be deployed dynamically to provide fine-grained access or user control of information or documents collaboratively.

In an embodiment of the invention, guest policies are delivered to the first organization in an identity assertion provided by an identity provider in the second organization via federation authentication. This method allows federated authorization to leverage on existing authentication infrastructure. A limitation of this method is guest policies are deployed once at the time of authentication and remain the same throughout an authenticated session.

In an embodiment of the invention, guest policies are deployed to a first policy engine in the first organization by a second policy engine in the second organization via federated authorization. Guest policies are deployed to the first policy engine on an as-needed basis. The first policy engine may request guest policies whenever needed. Guest policies deployment frequency and granularity may adapt to implement different information management scenarios.

Guest policies are policies relevant to a user, organization, project, or others. Guest policies may be specific to a user. Guest policies may be specific to a user and information or documents in the first organization. Guest policies may be specific to a project undertook jointly by the first organization and the second organization.

Guest policies are access or use control policies, rights control policies, data access policies, encryption policies, authorization claim policies, any combination thereof, or others.

Guest policies may be declarative, executable code, or others. Guest policies may be specified in declarative language. Guest policies may include roles. Guest policies may include an expiration time or a time-to-live (TTL) parameter. Guest policies may include a time period when the guest policies may be applied. Outside of the time period, all policy decisions may be deny. Guest policies may also include location such as where a user is accessing the information or documents from and deny access if the user is not accessing from an allowable location. Guest policies may also include device information and only allowable devices may access the information or documents.

In an implementation, guest policies are produced by a policy engine.

In another implementation, guest policies are produced by an authorization provider.

In an implementation, guest policies are a subset of the plurality of policies on a policy engine relevant to a user, organization, project, resource, or any combinations thereof, or others.

In an implementation, a policy engine may evaluate a subset of the plurality of policies on the policy engine to produce a decision. The decision comprises a plurality of guest policies.

In an implementation, a policy engine may evaluate a subset of the plurality of policies on the policy engine to produce a decision. The decision comprises an identifier. An authorization provider uses the identifier to select a plurality of guest policies.

In an implementation, guest policies are dynamically generated by an authorization provide.

In an implementation, guest policies are pre-defined and stored in a database or file.

The plurality of data protection clients comprises at least one of policy enforcers, rights management clients, rights managed applications, content access governors, data access enforcers, or other modules or application programs that perform the function of a data protection client. Data protection client is described in detail in U.S. patent application Ser. No. 15/268,155, filed Sep. 16, 2016, and U.S. patent applications aforementioned and incorporated by reference.

A policy enforcer is a specific implementation of the data protection client and it enforces access or use control policies on information or documents when the information or documents are being accessed (e.g., loading a web page, opening a document, or sending an email) or being used (e.g., copying content of a web page to clipboard, printing a documenting, or making a copy of a document). A policy enforcer may be deployed to protect a wide range of information or documents accessible on a desktop or laptop computer, or on or assessable from a server application. A policy enforcer is a software module or computer code executing on a computer that is used to protect information or documents by controlling access to, use of, or rights to the information or documents. Some example operations a policy enforcer controls are whether to allow: (a) open operations (e.g., whether a user may open a document with Microsoft® Word); (b) edit operation (e.g., whether a user may copy from one document into another document; or (c) whether a user may modify an e-mail's text); (d) whether a user may connect a database; (e) masking, filtering or removing data that a user does not have privilege to view; or many others. Policy enforcer is described in detail in U.S. patent application Ser. No. 11/383,159, filed May 12, 2006, Ser. No. 11/615,477, filed Dec. 22, 2006, Ser. No. 13/193,588, filed Jul. 28, 2011, Ser. No. 15/268,155, filed Sep. 16, 2016, and U.S. patent applications aforementioned and incorporated by reference.

On the other hand, if the objective is to protect copying of high-value documents such as Microsoft® Office documents or Adobe® PDF documents, a rights management client may be deployed. A rights management client is a specific implementation of the data protection client that enforces rights control policies. A rights management client enforces rights control policies on documents including when a document is being accessed (e.g., enforcing view right) or being used (e.g., enforcing print or copy rights) by an application program (e.g., Microsoft® Word, or Adobe Reader®), or other operations on the documents. A document may be encrypted. Rights management client is described in detail in U.S. patent application Ser. No. 15/268,155, filed Sep. 16, 2016, and U.S. patent applications aforementioned and incorporated by reference.

A rights managed application is an application program that implements the information or document protection functionality of a data protection client. A rights managed application enforces rights control policies on a document when the document is being accessed (e.g., enforcing view right) or being used (e.g., enforcing print or copy rights) by the rights managed application. Rights managed application is described in detail in U.S. patent application Ser. No. 15/291,653, filed Oct. 12, 2016, which is incorporated by reference.

A content access governor provides policy decisions to an application server (e.g., secured viewing server) when a user attempts to access information or a document on an application server. A content access governor implements the information or document protection functionality of a data protection client, except the interception and enforcement functions typically implemented in a policy enforcement point. Optionally, a content access governor provides a plurality of rights to an application server on information or a document being accessed. A content access governor may also provide an encryption key to a container manager to encrypt or decrypt information or a document. Content access governor is described in detail in U.S. patent application Ser. No. 15/291,653, filed Oct. 12, 2016, which is incorporated by reference.

A managed document container (sometimes referred to as a protected document) is a file or data object that stores information or a document to be protected (or payload) and metadata used by a data protection client to protect the information or document. A managed document container may also store metadata not used by a data protection client. Examples of metadata include attributes, keywords, lineage, discretionary policies, expiration date, maximum number of accesses, access and use history, or many others. The payload in a managed document container may be encrypted. A cryptographic signature is included in a managed document container to protect its unprotected data from being altered.

A container service module provides access to content of documents in managed document containers to application programs. A container service module makes access to content of a document in a managed document container transparent to an application program thereby an application program may access content of a document without being aware of the document being stored in a managed document container. With a container service module, an application program does not need to be altered to access a document stored in a managed document container. A container service module also provides access to metadata in a managed document container to a data protection client. Container service module is described in detail in U.S. patent application Ser. No. 15/268,155, filed Sep. 16, 2016, and U.S. patent applications aforementioned and incorporated by reference.

An encryption service module provides unencrypted content of protected documents to application programs or encrypts unencrypted content before storing it in protected documents. An encryption service module encrypts a document or decrypts an encrypted document independent of an application program, thereby encryption and decryption are transparent to an application program that accesses the document. An encryption service module also performs the functions of a container service module. An encryption service module does not make access control decisions or enforce policies on a document. All access control decisions and enforcement actions on a document are performed by a data protection client. Encryption service module is described in detail in U.S. patent application Ser. No. 15/268,155, filed Sep. 16, 2016, and U.S. patent applications aforementioned and incorporated by reference.

A policy server manages a plurality of policies and distributes the plurality of policies or subsets of it to the plurality of data protection clients. Policy server is described in detail further below.

A policy engine (also referred to as policy decision point) evaluates a plurality of policies or subsets of it to produce a policy effect (also referred to as decision, or policy decision; e.g., allowed or deny) and optionally, one or more policy obligations (also referred to as obligations, obligation tasks or instructions). The policy effect and policy obligations (if any) are implemented by a data protection client. Policy engine is described in detail further below.

An aspect of the invention is a policy language for the information management system that includes policies and policy abstractions. Policies may also be referred to as rules or policy object, and policy abstractions may also be referred to as abstractions, abstraction objects or variables. There may be any number of policies, policies abstractions, or both. Typically, an information management system shall have hundreds, thousands, millions, or greater number of policies. Because many policies are typically used to manage information in a company effectively, policy abstractions may be used to simplify maintenance of the policies and there should be a system to effectively managing policies and policy abstractions.

In an embodiment, a policy object may comprise of a set of predefined building blocks (or abstraction objects) strung together according to a precise syntax. Because the abstraction objects are often logical representation of specific physical entities, policy objects constructed based on the abstraction objects also possess great flexibility in covering activities (or actions) and entities in the physical network with little regard to how the activities and entities change and evolve over time.

In an embodiment, a policy (or rule) includes an expression. A premise may be an expression or statement. More specifically, a premise may contain an expression, and an expression may be a statement. An expression may be “a=true and b=c.” An expression may also include a comma delimited list. For example, one may check whether an action is one of the actions listed in a comma delimited list. A statement may be “FOR expression ON expression BY expression WHERE expression DO statement,” or any non-logical or mathematical expression. A statement includes expressions, potentially multiple expressions, each of which may be nested. A statement may also include nested statements.

$$policy := premise + consequence + directives$$

A premise generally refers to terms such as events, resources, subjects, context, policy abstractions and directives. Not all of the terms in a premise are required. A premise is sometimes called a condition or predicate. A premise may be a simple Boolean expression that evaluates to true or false at run time, a simple statement with at least one expression, or a complex statement composes of multiple parts, each part consists of nested statements or subexpressions, and more. Any one of the above terms may appear one or more time in an expression, a subexpression, or a statement. Each term may also appear in more than one expression, subexpression, or statement within the premise. A consequence generally refers to an effect (or policy effect, or decision), obligation tasks (or policy obligation), remediation tasks, or any combination of these. For a policy that prevents data leaks or protects privacy and confidentiality, an effect may be optional, and obligation tasks specify how a database query (e.g., SQL) should be alerted to guard against data leaks and address privacy and confidentiality concerns. For a policy that implements control function, an effect is required, but obligation tasks and remediation tasks are optional. In a policy that does not implement control function, an effect is optional. A policy may contain any number of directives to assist in policy deployment, affect policy evaluation or carry instruction that influence any one of the stages in a policy lifecycle.

A policy is sometimes referred to as an attribute-based policy when its premise is expressed using a collection of object attributes. The objects where their attributes are used to compose a policy include resources, events, subjects, context, or others. A policy may be specified using attributes from one or more objects. Examples of resources include files, email messages, application programs, computing devices, tables in a database, columns in a database table, or others. Examples of events include opening a file, sending an email, copying content to clipboard, a select database operation, an insert database operation, an update database operation, or others. Examples of subjects include current user who has logged on to a computer; a user who has logged on to an application program that trigged an event; or others. Examples of user attributes include an attribute that specifies a user is given permission to access export control documents (e.g., ITAR); an attribute specifies a user participates in a particular project; an attribute specifies a user has completed training required to access confidential documents; or others. Examples of context include locations, time, application programs, computing devices, databases, database tables, data in a column in a database table, or others.

In an embodiment of the invention, the policies or rules are decoupled from the physical resources using policy abstractions. For example, the following is a policy that says legal documents may only be viewed by legal team. “Legal-Docs” is an abstraction object which is specified separately from the policy. One abstraction may apply to more than one policy.

FOR Legal-Docs
ON OPEN
BY Legal-Team
DO ALLOW OTHERS DENY

For the above example, both Legal-Docs and Legal-Team are abstractions in the policy. The exact definition of these abstractions is decoupled from the policy.

A further aspect of the invention is that decoupling of the rules from data protection client (or agents) where the rules or policy abstractions, or both, are evaluated. For example, some rules are relevant to server agents (or data protection clients) while some rules are relevant to client agents. However, user or policy author does not need to know where a rule is applied, the selection (or target binding) process is done automatically. This makes rules management much easier. This also makes supporting different clients and new type of clients easier.

In some implementations, a policy abstraction may include two or more variable definitions. Each variable in the policy abstraction includes a name and a definition. A variable definition may comprise an expression or a statement where the expression or statement may refer to another variable in the policy abstraction or another policy abstraction.

A policy may be defined (or created) independent of a user, information or a document. An access or use control policy or a right control policy may control access to or use of a plurality of information or documents. A data access policy may protect access to data in a database from leaks or make sure privacy and confidentiality are respected. A policy may be defined before a user who is affected by the policy is added to an information management system, yet the policy applies to the user. A policy may be defined in an information management system before information or a document is added or created, yet access to the information or document is controlled by the policy. A new policy may be defined, or an existing policy may be updated after information or a document is created, yet the new or existing policy shall be applied to control access to or use of the information or document once it is deployed. In another word, policies in an information management system are not static, which is unlike how policies work in many digital rights management systems. Policy and policy abstraction including their syntax, applications, deployment and evaluation are described in detail in U.S. patent application Ser. No. 11/615,477, filed Dec. 22, 2006, and U.S. patent applications aforementioned and incorporated by reference.

In an implementation, an information management system enforces centralized policies, discretionary policies, guest policies, or combination of these to protect information or documents. Centralized policies are policies managed by a policy server and are intelligently deployed to a plurality of data protection clients or a plurality of policy engine servers. Centralized policies are typically applied to a wide range of information or documents. Discretionary polices are policies embedded in documents or objects. Discretionary policies are typically applied to a particular document or object. Centralized and discretionary policies are described in detail in U.S. patent application Ser. No. 15/268,155, filed Sep. 16, 2016, which is incorporated by reference.

In an implementation of a policy language, the policy language is used to protect access to or use of information or documents. A policy specified using the policy language is an access or use control policy. An access or use control policy may be used to permit or block an application program operation access to or use of a resource. A resource includes information or a document described above. The general form of an access or use control policy includes at least one resource, one action (e.g., open or edit), one user, one effect (e.g., ALLOW or DENY) and optionally a context. For example, an access control policy may specify only a user in a group Executive may open a document classified as Financial and Confidential when a computer is connected to a network in the office. A use control policy may specify all users may not send a document classified as “top secret” in an e-mail message. Access or use control policies including their syntax, applications, deployment and evaluation are described in detail in U.S. patent application Ser. No. 11/615,477, filed Dec. 22, 2006, and U.S. patent applications aforementioned and incorporated by reference.

In an implementation of a policy language, the policy language grants or revokes rights (or digital rights) on information or a document. A policy specified using the policy language is a rights control policy. A rights control policy may be used to grant a right to a resource to a user or revoke a right to a resource granted to a user. A rights control policy is different from an access or use control policy that a rights control policy specifies one or more rights a user may have on a resource, whereas an access or use control policy specifies what actions a user is allowed (or denied) to perform on a resource. Rights control policies and access or use control policies have similar applications-controlling access to or use of a resource.

Unlike an access control policy or use control policy which specifies what policy effect should be enforced when a user takes a particular action on a resource, a rights control policy declares what rights a user has on a resource. Further, an access control policy or use control policy is evaluated to determine what policy effect to enforce when an associated action is intercepted. A rights control policy is evaluated when a user accesses a resource, and the evaluation determines a plurality of rights the user has on the resource. If a user is allowed to access the resource, the plurality of rights is passed to a data protection client so that the plurality of rights may be implemented at the data protection client without further policy evaluation.

The rights in rights control policies and their definitions are specific to an information management system. Examples of rights that may be granted to or revoked from a user include view, edit, copy, extract, convert, print, send, decrypt, annotate, classify, assign, screen capture, or many others. The rights described herein are for illustration purposes only. An information system may enforce a different set of rights using the techniques described in this document. Variations such as naming of a right, adding a new right, deleting an existing right, or modifying definition of an existing right may be accommodated easily. For example, a send right may be modified to enforce uploading of a document to a website; an upload right may be added to enforce uploading of a document to a website; or a copy right may be renamed as a duplicate right. Rights control policies including their syntax, applications, deployment and evaluation are described in detail in U.S. patent application Ser. No. 15/268,155, filed Sep. 16, 2016, which is incorporated by reference.

In an embodiment, a policy language is used to control access to or use of information or documents, enforce rights on document content, protect privacy and confidentiality and prevent data leaks on data retrieved from databases, and more. A data access policy is a specific implementation of the policy language for protecting privacy and confidentiality and preventing data leaks. The policy language syntax is:

# <comment>
policy := FOR <resource expression>
ON <event expression >
BY <subject expression>
WHERE < context expression >
DO <positive consequence>
OTHERS <negative consequence>
positive consequence := effect AND <obligation tasks>
negative consequence := effect AND <obligation tasks>

A “#” character in a policy statement denotes the start of a comment and the comment extends to the end of current line. The premise is comprised of a resource element (or FOR element), an event element (or ON element, or action element), a subject element (or BY element, or user element), and a context element (or WHERE element, or context element). The consequence is comprised of a positive consequence element (or DO element) and a negative consequence element (or OTHERS element). Not all elements in a premise are required. Negative consequence element is optional.

The resource element in the policy language specifies a logical expression (i.e., resource expression) that describes one or more policy abstractions (e.g., “SAP-servers:=server=‘SAP-AppServer-1’OR server=‘SAP-AppServer-5’”), application programs, servers, databases, database tables (e.g., “table=‘server1.dept03db.orders’”), or any combination of these.

The event element specifies a comma separated list of database query operations. The event expression comprises at least one database query operation including select, insert, update, delete, call (i.e., calling stored procedure), or more.

The subject element specifies a comma separated list of users. A user may be the one who is currently logged on to an application program (e.g., SAP C/4HANA®) that initiated current database operation (this user is also referred to as application user). A user may also be the one who is using a desktop computer to access information in a database that initiated current database operation (this user is also referred to as desktop user). A user may also refer to the account that is used to connect to a database (this user is also referred to as database user).

The context element specifies a logical expression (i.e., context expression) comprises of one or more predicates. For example, the context expression may take on the syntax of a WHERE clause in SQL, the international standard.

The positive consequence element includes a positive consequence statement. A positive consequence statement may contain a policy effect (e.g., ALLOW, DENY, query user, custom effect handler, or DELEGATE), optionally one or more obligation tasks (or policy obligations). A positive consequence is adopted during policy evaluation when a policy's premise is evaluated to true.

The negative consequence element includes a negative consequence statement. A negative consequence element has the same structure as the positive consequence statement. Negative consequences are adopted during policy evaluation when a policy's premise is evaluated to false. Negative consequences are optional in a policy.

A typical data access policy specifies an event (e.g., select, insert, update, delete, or call) that corresponds to a database query operation of the same name in SQL. A resource element specifies one or more policy abstractions, application programs, servers, databases, database tables (or tables), or others. A subject element specifies one or more application users, desktop users, database users, or others. A context element specifies one or more predicates (e.g., users.role=“supervisor” AND users.department=“customer support”). The policy outcome may be ALLOW or DENY, and the policy may specify one or more policy obligations (e.g., filtering policy obligations, masking policy obligations, or blocking policy obligation).

A policy obligation (or obligation task) is a task to be performed by a data protection client or policy engine when a policy specifying the policy obligation is in the subset of policies being evaluated and invocation condition (i.e., premise) of the policy obligation is satisfied. Policy obligation is an optional element of a policy. Policy evaluation may not produce a policy obligation. Examples of policy obligations include: (a) filtering policy obligation (or filtering obligation) that restricts what data may be returned by a database query; (b) masking policy obligation (or masking obligation) that partially or completely redacts the data in a column in a result set; (c) log policy obligation (or log obligation) that logs data to a log server; (d) automatic tagging policy obligation (or automatic tagging obligation) that inserts one or more document attributes into a document or document container; (e) an interactive tagging policy obligation (or interactive tagging obligation) that queries a user to enter one or more document attributes and inserts the one or more document attributes into a document or document container; (f) strip attachment policy obligation (or strip attachment obligation) that removes an attachment from an e-mail message; (g) encryption policy obligation (or encryption obligation) that encrypts a document and saves the encrypted document in a managed document container; (h) security overlay policy obligation (or security overlay obligation) that renders one or more security markers on top of content of a document being displayed; (i) blocking database query policy obligation (or blocking database query obligation) that alters a database query so that executing the altered database query always generates an empty result set; or many more.

A policy obligation in a data access policy may insert one or more guard conditions into a database query. A guard condition may add a boundary that limits the amount of information a database query may return (e.g., WHERE orders.orderDate>=DATEADD (DAY, −30, GETDATE( )). A guard condition may alter a database query to mask (or obfuscate, or redact) data in a column of a result set produced by a database query. A guard condition may force a database query to return no data (i.e., zero row in a result set). A guard condition may force a database query to return an error status. The most common data access policy obligations are filtering policy obligation, masking policy obligation and blocking database query policy obligation.

An information management system may employ one type of policies, or it may employ more than one type of policies to protect information or documents.

In an implementation, an information management system employs a plurality of access or use control policies, a policy server, and a plurality of policy enforcers to protect information or documents. A policy engine is embedded in each policy enforcer to facilitate policy enforcement.

In an implementation, an information management system employs a plurality of rights control policies, a policy server, a plurality of rights management clients, and a plurality of encryption service modules to control usage of content in protected documents. A policy engine is embedded in each right management client to facilitate policy enforcement.

In an implementation, an information management system employs a plurality of data access policies, a policy server, a policy engine, and a data access enforcer to protect access to data in a database.

A data access enforcer may prevent unauthorized viewing of data retrieved from a database by altering (or modifying) a database query before sending the database query to a database to selectively apply masking (or obfuscating, or redacting) or filtering (or restricting, or limiting) data in the results produced by the database query that a user does not have privilege to view. In an example, masking a field having data “Jane Doe” is replacing the data with “**********”. In another example, masking a field with data “1234.56” is replacing the data with “9999.99”.

Alternatively, a data access enforcer may prevent unauthorized viewing data retrieved from a database by altering (or modifying) the results of a database query before returning the results produced by the database query to an application program to selectively apply masking (or obfuscating, or redacting) or filtering (or removing) data in the results produced by the database query that a user does not have privilege to view. In an example, if a user is authorized to see data associated with “ABC Company” only, the results produced by a database query will not show any record not associated with “ABC Company”.

A data access enforcer may prevent unauthorized access to or use of data by blocking execution of a database query or causing a database query to return no data to an application program.

A policy engine may run on the same computer as the data access enforcer. Alternatively, a policy engine server (or external policy engine) separated from the data access enforcer may handle policy evaluation requests from the data access enforcers. A data access enforcer and the application it protects may run on the same computer. Alternatively, a data access enforcer and the application it protects may run on separate computers and the data access enforcer monitors communications between the application and a database and enforces policies on the communications. Furthermore, a data access enforcer and a database may run on the same computer and the data access enforcer intercepts requests sent to the database and enforces policies on the requests before the requests reach the database.

The policies outlined in this document are specified using a declarative syntax. However, these policies may also be expressed using other syntax or techniques. In an example, policies are composed using a graphical user interface and stored in a file or database. In another example, policies are expressed in XML or JSON format and stored in a file. In yet another example, parameters of policies are stored in a file or database, and a policy engine reconstitutes the policies based on the parameters and evaluates the reconstituted policies, or a policy engine evaluates based on the parameters. Those skilled in the art shall be able to devise methods that are appropriate for a particular implementation based on the teaching in this document.

A policy server manages a plurality of policies and distributes the plurality of policies or subsets of it to a plurality of data protection clients, a plurality of policy engine servers, and any combinations thereof. The plurality of policies is stored in a policy database accessible by the policy server. A policy server manages the lifecycle of a policy including create, deploy, edit, redeploy (or update), enable, disable and delete. In one implementation, a policy server provides an authoring tool for creating and editing policies via a web browser.

A policy server may optimize a policy to improve its efficiency or remove a condition not relevant to a particular data protection client. A policy server may translate a policy to a format that is supported by a data protection client.

The plurality of policies is intelligently deployed to the plurality of data protection clients. A policy server has the ability to decide if a single policy, multiple policies, or a subset of policies are applicable to a data protection client. The plurality of policies or a subset of the plurality of policies may be distributed to one or more data protection clients. In one implementation, a policy server deploys the plurality of policies to a data protection client or policy engine server. In another implementation, a policy server deploys a subset of the plurality of policies to a data protection client or policy engine server. In yet another implementation, a policy server optimizes a policy before deploying it to a data protection client or policy engine server. Data protection client and policy engine server are described in detail further below.

A policy server stays in contact with a data protection client or policy engine server so the data protection client or policy engine server may receive updated policies from the policy server periodically. In addition, a policy server may also deploy configuration data, data that supports evaluation of policies, software updates, or other data to a data protection client or policy engine server. Policy server, policy deployment, policy optimization and policy translation are described in detail in U.S. patent application Ser. No. 11/615,477, filed Dec. 22, 2006, and U.S. patent applications aforementioned and incorporated by reference.

A policy engine is an execution unit that processes and executes policies or rules to produce policy decisions (also referred to as policy effects, or decisions). A policy engine takes the data collected by an interceptor (e.g., including data extracted from a database query) and contextual information and applies policies supplied by a policy server to the data to produce a consequence (also referred to as policy decision).

Contextual information refers to data relevant to evaluating policies which may include the user who is currently logged on to a computer, the user who has logged on to an application program, the user who shall view the data to be returned by a request, the role of a user, the department a user belongs to, the organization a user belongs to, user attribute, the application program that makes a request, the database management server that shall receive a request, the computer where a request originated from, the computer where a request shall be delivered to, action or operation being intercepted or detected, resource identifier, resource attribute, location, time, security setting, historical data from prior interceptions, configuration and environment data, data entered by a user, or some other data.

A consequence may include an effect (also referred to as decision, policy decision, or policy effect in this document; e.g., ALLOW, DENY, evaluate another policy, query user, or call a custom effect handler) and optionally one or more obligation or remediation tasks (obligation tasks are also referred to as policy obligations or obligations). The use of historical data in policy evaluation is optional. As part of a policy evaluation process, a policy engine may decide that it needs to obtain input from a user before it may proceed with or complete policy evaluation. At that time, the policy engine may invoke a user interface element to query the user for input. For example, such input is related to classifying a document (which produces document attribute values) that is required to complete a policy evaluation. A policy engine may also decide that it needs additional information to proceed with or complete policy evaluation. At that time, the policy engine may request additional information from a data source.

In an implementation, a policy engine supports evaluating rights control policies, the policy engine also determines the rights to be granted based on a plurality of policies.

A policy engine optionally performs one or more obligation tasks, performs one or more remediation tasks, invokes a custom effect handler, or a combination of these, if one is defined in a policy.

The implementation of a policy engine is policy system architecture specific. Depending on what policy system architecture is selected, the implementation of a policy engine may vary significantly. Some examples of policy system architectures include: (a) distributing a full set of centralized policies to a data protection client or policy engine server; (b) distributing a subset of centralized policies to a data protection client or policy engine server; (c) organizing centralized policies based on the type of data protection client the policies target; (d) using centralized policies defined in Extensible Access Control Markup Language (XACML) format; (e) using centralized policies defined in NextLabs Compliant Enterprise Active Control Policy Language™ (ACPL) format that uses a declarative approach to policy specification; or others. More detailed information about the ACPL language may be found in U.S. patent applications 60/870,195, filed Dec. 15, 2006, and Ser. No. 11/615,477, filed Dec. 22, 2006, which are incorporated by reference.

A policy engine may run in a process separate from a data protection client. The policy engine process and data protection client processes may run on the same computer or on separate computers. A policy engine may be integrated into a data protection client or may operate independent of a data protection client. When a policy engine operates independent of a data protection client, the policy engine communicates with the data protection client through a secured communication channel. The secured communication channel may be implemented using standard (e.g., IPSec or HTTPS) or propriety protocol. A policy engine that operates independent of a data protection client may run as a standalone policy engine server (or external policy engine) and provides policy decisions and optionally granted rights to one or more data protection clients. A policy engine that operates independently of a data protection client may be an integral part of a policy server. Policy engine is described in detail in U.S. patent application Ser. No. 11/615,477, filed Dec. 22, 2006, and U.S. patent applications aforementioned and incorporated by reference.

An aspect of the invention is a data protection client that enforces a plurality of polices to protect information or documents from unauthorized access or misuse, protect privacy and confidentiality of information or documents, and prevent data leaks. Implementations of data protection clients differ depending on their operating environment or types of policies being enforced. For example, a data access enforcer is a specific implementation of data protection client for database operations that enforces data access policies to protect privacy and confidentiality and prevent data leaks on database operations.

A data access enforcer protects information stored in a database. A policy enforcer is a specific implementation of data protection client for desktop or server computer, and it enforces access or use control policies to prevent unauthorized access to information or documents and misuse of information or document content. Rights management client and rights managed application are specific implementations of data protection client for digital rights management and they enforce rights control policies and rights assigned to a user on specific information or document content. A content access governor and a secured viewing server together implement the functions of a data protection client, and they enforce access or use or rights control policies to extend protection of protected documents to a web browser. An information management system may deploy one or more types of data protection clients to achieve its data protection objectives.

A data protection client may have one or more policy enforcement points (PEPs) which intercept application programs, database client interfaces, database client interface handlers, or operating system operations and implement policy effects. A PEP may have one or more interceptors. Typically, an interceptor runs in an application program instance (e.g., a process), an operating system kernel, or a standalone server (e.g., as a reverse proxy or gateway). When an interceptor of a PEP intercepts a request (or operation, function call, method call, or message) in an application program, database client interface, database client interface handler or operating system module, the PEP collects (or gathers) contextual information relevant to evaluation of policies. The PEP queries a policy engine with the intercepted request and contextual information for a policy decision (or decision, or policy effect).

Contextual information may include the application program that initiated current intercepted request, the user who is going to view the data returned by current request, the user who is currently logged on to the application program, the role of the user who has logged on to an application program, the department of the user who has logged on to an application program, user attribute, resource identifier, resource attribute, action or operation attribute, the location of the user, time, or many others. The data protection client may obtain some contextual information through a policy context provider.

A policy context provider is a component or code module that retrieves contextual information to support policy evaluation on behalf of a data protection client. A policy context provider may be invoked on each interception or may be invoked once and the contextual information collected is cached in the data protection client for use in subsequent interceptions. In an implementation, a policy context provider runs in an application program instance (i.e., in the process space of an application program) that initiated the intercepted request. In another implementation, a policy context provider runs in a process separated from the application program that initiated the intercepted request. In yet another implementation, a policy context provider runs in the process of a data protection client. In yet another implementation, a policy context provider and a policy engine run on the same computer and the policy engine requests contextual information from the policy context provider. In yet another implementation, the policy context provider retrieves contextual information from a directory service (e.g., Microsoft Active Directory® or OpenLDAP®). A policy context provider is an optional component.

The policy engine selects a first subset of policies from a plurality of policies in a local policy repository that is relevant to the intercepted request and evaluates the first subset of policies to produce a policy decision. The policy decision includes ALLOW or DENY and optionally one or more policy obligations (or obligations). A policy obligation is a task to be carried out by a data protection client, and it is an optional element of a policy. If a policy effect is ALLOW, the policy engine returns policy effect ALLOW to the PEP. The PEP implements a policy effect ALLOW by allowing the intercepted request to execute to completion. If a policy effect is DENY, the policy engine returns policy effect DENY to the PEP. The PEP implements a policy effect DENY by blocking the intercepted request.

In an implementation where a data protection client protects access to data in a database, a policy engine may produce a plurality of policy obligations for altering a database query to implement filtering, masking (or redaction, or obfuscation) or blocking function.

In an implementation, the plurality of policies in the local policy repository is distributed from a policy server. The local policy repository may function as a policy cache that caches centralized policies from the policy server. In another implementation, the local policy repository is a persistent data store of centralized policies distributed from a policy server, and it supports policy evaluation when a connection to the policy server is not available. In yet another implementation, the plurality of policies in the local policy repository is deployed manually.

A key management service (also referred to as encryption key management service) manages encryption keys at a data protection client. Functions of a key management service include encryption key generation, encryption key lookup with a key management server, encryption key caching, encryption key expiration, encryption key revocation, or more. A key management service requests encryption keys from a key management server (also referred to as encryption key management server), caches encryption keys locally and releases encryption keys to an encryption service module. A key management service is an optional component of the data protection client.

The key management service releases an encryption key to an encryption service module only if an application program process that access decrypted information or document may be trusted. To determine if the application program process is to be trusted with decrypted information or document, the key management service checks a policy evaluation cache for a recent policy evaluation on the information or document by a user (i.e., the user that the application program process is running under) where policy effect is ALLOW. If a matching policy evaluation is found, the key management service trusts the application program process with decrypted information or document and releases the encryption key to the encryption service module to decrypt the information or document. Key management service, encryption service module and key management server are described in detail in U.S. patent application Ser. No. 13/193,588, filed Jul. 28, 2010, Ser. No. 15/268,155, filed Sep. 16, 2016, and U.S. patent applications aforementioned and incorporated by reference.

If the policy decision produces a policy obligation, a corresponding obligation handler is invoked to carry out the policy obligation. A data protection client may implement one or more obligation handlers. Obligation handler is an optional component of a data protection client.

In an implementation where a data protection client supports rights enforcement, a policy engine may produce a plurality of rights granted to a user on a resource (e.g., document) and pass the plurality of rights to a PEP when it processes an access query on the resource (e.g., opening a file). By providing a PEP with a plurality of rights granted, a data protection client empowers the PEP to process subsequent interceptions (i.e., covered by the granted rights) based on the plurality of rights granted without querying the policy engine for policy decisions.

In an implementation, a policy engine produces a plurality of rights granted based on the first subset of policies. In another implementation, a policy engine selects a second subset of policies from the plurality of policies in the local policy repository based on the user and the resource and analyzes the second subset of policies to produce the plurality of rights granted. In yet another implementation, a PEP may make an addition query to a policy engine on a plurality of rights of interest to a PEP and the policy engine composes a plurality of rights granted to a user on a resource in respond to the query. In yet another implementation, a plurality of rights granted to a user on a resource is composed based on a subset of centralized policies and a plurality of discretionary policies associated with information or a document.

An auditor logs interceptions and policy evaluations at a data protection client. It also gathers additional information on the computing environment that may be used in an audit, performance analysis or diagnosis. An auditor typically caches log data locally so that it may continue to operate while a client computer is offline. Log data is transmitted to a central log server (or report server) when a client computer is online. The log data collected in a log server may be used to analyze information or documents usage patterns, analyze policy effectiveness, identify threats, generate alerts, or produce reports.

A communication and synchronization module is responsible for transmitting policy updates from a policy server to the local policy repository, and log data from an auditor to a central log server. A communication and synchronization module may communicate with a policy context provider to obtain contextual information to support policy evaluation.

A data protection client may have several components such as policy engine, local policy repository, policy enforcement point, key management service, obligation handler, auditor, communication and synchronization, combinations of these, or others. The components may run: (a) in a single process; (b) in multiple processes; (c) on a single computing device; (d) on multiple devices; (e) in a process of an application program; (f) in a process separated from the application program; (g) in processes of an application program and separated from the application program; or (h) others. The components may also be deployed in one package or separately in multiple packages.

In an implementation where a data protection client includes the function of making policy decisions, the data protection client is also responsible for storing a plurality of centralized policies locally to support policy evaluation and a communication and synchronization module is an optional component of the data protection client.

In an implementation where a data protection client does not include the function of making policy decisions, the data protection client is responsible for communicating with a policy engine server (or external policy engine) to obtain policy decisions. The policy engine server and the data protection client run on separate computing devices.

Intercepting information or document access or use operations, enforcing policy decisions and optionally effectuating information or document rights granted are functions of a policy enforcement point. A data protection client may include one or more policy enforcement points.

A data protection client may instrument an application program, a database client interface, a database client interface handler, or an operating system to intercept requests (or operations, function calls, method calls, or messages) using one of application plug-in, code injection, operating system management interface, operating system service provider, device driver, replacing code module, or others. Techniques on instrumenting application program or operating system are described in detail in U.S. patent application Ser. Nos. 11/383,159, 11/383,161, 11/383,164, filed May 12, 2006, Ser. No. 11/615,477, filed Dec. 22, 2006, and U.S. patent applications aforementioned and incorporated by reference.

In an implementation where a data protection client protects access to data in a database, a data protection client alters a database query before sending the database query to a database management server. Altering the database query includes inserting a condition into the database query to carry out filtering, masking or blocking operation.

In an implementation where a data protection client protects access to data in a database, a data protection client alters the data produced by a database query before passing the data to an application program. Altering the data includes filtering, masking or blocking operation.

An aspect of the invention is policy-based federated authorization. Policy-based federated authorization inherits the benefits of basic authorization incorporated in traditional federated authentication processes (e.g., SAML or OIDC). The roles or resource attributes transmit through authorization claims integrate well with traditional server applications that implement role-based authorization. However, role- or resource-based authorization cannot satisfy the secure requirements of modern organizations or enterprises. A more fine-grained, flexible and dynamic federated authorization technique is needed to secure information and documents in an organization. Policy-based authorization within an organization is described in detail in U.S. patent application Ser. No. 11/615,477, filed Dec. 22, 2006, Ser. No. 15/268,155, filed Sep. 16, 2016, Ser. No. 18/332,671, filed Jun. 9, 2023, and U.S. patent applications aforementioned and incorporated by reference. To extend policy-based authorization beyond an organization requires federation of authorization.

In one embodiment, federated authorization leverages on existing federated authentication process (e.g., SAML or OIDC). In federated authentication, when a user is successfully authenticated, an identity provider creates an identity assertion and delivers the identity assertion to a target application server. The identity assertion comprises authentication claims and authorization claims. Traditionally, authorization claims comprise roles, resource attributes, or others. Extending authorization claims to include guest policies associated with a user being authenticated allows guest policies to be delivered dynamically. This approach allows guest policies to be delivered dynamically during log on and enforced while the log on session remains active.

In another embodiment, federated authorization extends policy-based authorization process of an information management system beyond an organization through guest policies. Federation occurs at the policy engines (or policy decision points) of two or more organizations. A trust relationship is set up between a first policy engine in a first organization and a second policy engine in a second organization. The trust relationship may be established through metadata exchange, certificate, pre-configured agreement, application program interface (API) token, pin, or others. When the first policy engine determines the user it is making a policy decision on belongs to the second organization and it does not have guest policies on the user stored locally, it requests guest policies on the user from the second policy engine. The guest policies will be evaluated at the first policy engine to determine if the user is allow access information or a document in the first organization.

In yet another embodiment, federated authorization extends policy-based authorization process of an information management system beyond an organization by delegation. Federation occurs at the policy engines (or policy decision points) of two or more organizations. A trust relationship is set up between a first policy engine in a first organization and a second policy engine in a second organization. The trust relationship may be established through metadata exchange, certificate, pre-configured agreement, application program interface (API) token, pin, or others. When the first policy engine determines the user it is making a policy decision on belongs to the second organization, it makes a request to the second policy engine for a policy decision.

In an implementation, the first policy engine evaluates a subset of the first plurality policies on the first policy engine to produce a first decision. If the first decision is allow, the first policy engine requests a policy decision from the second policy engine. The second policy engine evaluates a subset of the second plurality policies on the second policy engine to produce a second decision. The second policy engine returns the second decision to the first policy engine. The first policy engine returns the second decision to a policy enforcer.

In another implementation, the first policy engine evaluates a subset of the first plurality policies on the first policy engine to produce a first decision. In addition, the first policy engine requests a policy decision from the second policy engine. The second policy engine evaluates a subset of the second plurality policies on the second policy engine to produce a second decision. The second policy engine returns the second decision to the first policy engine. The first policy engine combines the first decision and second decision using a combining algorithm to produce a third decision. The first policy engine returns the third decision to a policy enforcer.

In another implementation, the first policy engine requests a policy decision from the second policy engine. The second policy engine evaluates a subset of the plurality policies on the second policy engine to produce a decision. The second policy engine returns the decision to the first policy engine. The first policy engine returns the decision to a policy enforcer.

An aspect of the invention is a policy engine in a first organization evaluating guest policies from a second organization. A policy engine may evaluate local policies, guest policies, or both to produce a decision. Local policies are policies that control access to or use of information or documents in a first organization. A policy engine in the first organization applies local policies to make decisions when users in the first organization accesses information or documents in the first organization. Guest policies are policies provided by a second organization for controlling access to or use of information or documents in the first organization by a user in the second organization.

A policy engine may combine local and guest policies and evaluate both together to produce a decision. A policy engine may evaluate local and guest policies separately and use a combining algorithm to combine the evaluation results to produce a decision. A policy engine may evaluate only guest policies on a user from the second organization to produce a decision. A policy engine may evaluate local policies on the second organization and information or a document being accessed to make a first decision. If the first decision is allow, the policy engine evaluates guest policies to produce a second decision. If the second decision is allow, the user is allowed to access the information or document. Otherwise, the user is denied access to the information or document.

In an example, when a user in a second organization accesses information or a document on an application server in a first organization, a policy enforcer on the application server intercepts or detects an operation (e.g., open a document, open a web page, or send a database query to a database) by the application server on the information or document. Examples of intercepted operations include opening a file, copying a file, copying data to a clipboard, sending an email, exporting data, sending a database query to a database, or others. The policy enforcer queries a first policy engine in the first organization with information about the operation, user, information, or document.

The first policy engine determines the user belongs to the second organization. The first policy engine confirms that it has a trust relationship with a second policy engine and decisions may be made in cooperation with the second policy engine. The first policy engine will determine if the operation shall be allowed or denied based on policies of both the first and second organizations.

As a first step, the first policy engine will decide if a user from the second organization has access to the information or document. To make such decision, the first policy engine selects a subset of the plurality of policies on the first policy engine relevant to the operation, second organization and information or document. The first policy engine evaluates the subset of the plurality of policies to produce a first decision. The first decision comprises allow or deny, and optionally a plurality of obligations. Obligations are tasks to be carried out by the first policy engine or the policy enforcer. If the first decision is deny, the first policy engine returns a deny policy decision to the policy enforcer. The policy enforcer denies access to the information or document by the operation. The application server returns an error code indicating access to the information or document has failed.

As a second step, the first policy engine proceeds to check if the user is allowed to access the information or document according to the second organization's policies. If the first decision is allow and guest policies are stored on the first policy engine, the first policy engine evaluates the stored guest policies to make a second decision. If the first decision is allow and guest policies are not available, the first policy engine requests guest policies from the second policy engine. The guest policies are evaluated to make a second decision. In both cases, the second decision is returned to the policy enforcer. If the second decision is allow, the policy enforcer allows the operation. The application server returns the information or document to the user. If the second decision is deny, the policy enforcer denies access to the information or document by the operation. The application server returns an error code indicating access to the information or document has failed.

In an implementation, the first policy engine sends a guest policy request to the second policy engine with information on the operation, user and information or document. The second policy engine selects a subset of the plurality of policies on the second policy engine relevant to the operation, user and information or document (or Guest Policies I) and returns Guest Policies I to the first policy engine. Guest Policies I controls access to the information or document in the first organization by the user. The first policy engine evaluates Guest Policies I to produce a second decision. The second decision comprises allow or deny, and optionally a plurality of obligations. If the second decision is allow, the application server accesses the information or document successfully. If the second decision is deny, the application server fails to access the information or document.

In another implementation, the first policy engine sends a guest policy request to the second policy engine with information on the user. The second policy engine selects a subset of the plurality of policies on the second policy engine relevant to the operation, user (or Guest Policies II) and returns Guest Policies II to the first policy engine. Guest Policies II controls access to information or documents in the first organization by the user. The first policy engine stores Guest Policies II. The first policy engine will use Guest Policies II to make decisions on subsequent access to information or documents by the user. The first policy engine evaluates Guest Policies II to produce a third decision. The third decision comprises allow or deny, and optionally a plurality of obligations. If the third decision is allow, the application server accesses the information or document successfully. If the third decision is deny, the application server fails to access the information or document.

An aspect of the invention is distribution of guest policies from a second organization to a first organization. Guest policies are policies developed in the second organization to control access to information or documents by a user in the second organization, but enforcement of the guest policies takes place in the first organization on information or documents in the first organization. Guest policies may be delivered and installed in the first organization manually. One approach to deliver guest policies from the second organization to the first organization is through federation. Federated authorization delivers guest policies on-demand, and it avoids the need to regularly update guest policies.

In one embodiment, federated authorization leverages on existing federated authentication process (e.g., SAML or OIDC). In federated authentication, when a user is successfully authenticated, an identity provider creates an identity assertion and delivers the identity assertion to a requesting application server. The identity assertion comprises authentication claims and authorization claims. Traditionally, authorization claims comprise roles, resource attributes, or others. Extending authorization claims to include guest policies associated with the user being authenticated allows guest policies to be delivered dynamically. This approach allows guest policies to be delivered dynamically during log on and enforced while the log on session remains active.

In one implementation, an application server in a first organization delegates authentication of a user in a second organization to a first identity provider in the first organization. The first identity provider delegates authentication of the user to a second identity provider in a second organization. When the user is authenticated, the second identity provider delivers an identity assertion to the application server.

In another implementation, an application server in a first organization delegates authentication of a user in a second organization to a first identity provider in the first organization. The first identity provider delegates authentication of the user to a second identity provider in a second organization. When the user is authenticated, the second identity provider delivers an identity assertion to the first identity provider.

In another embodiment, federated authorization extends policy-based authorization process of an information management system beyond an organization. Guest policies are requests only when a user in the second organization accesses information or documents in the first organization.

When a policy enforcer in the first organization requests a policy decision from a first policy engine in the first organization, the first policy engine examines information on the user and determines the user does not belong to the first organization. Examples of information on a user that can indicate the organization the user belongs to include: (a) email address the user used to login (e.g., domain name in an email address such as joe@nextlabs.com); (b) down-level login name the user used to login (e.g., domain name in NEXTLABS\joe); (c) domain name or organization name explicitly provided by a user during login; or others. The information on the user indicates the user belongs to the second organization. The first policy engine confirms that it has a trust relationship with a second policy engine in the second organization. The first policy engine sends a request to the second policy engine with information on the user and optionally information or document being accessed. The second policy engine examines information on the user and determines the user belongs to the second organization. The second policy engine returns guest policies to the first policy engine. The first policy engine evaluates guest policies on the user and information or document being accessed to produce a decision. The decision is returned to the policy enforcer. The policy enforcer implements the decision.

In an implementation, the second policy engine selects a subset of the plurality of policies relevant to the user on the second policy engine to produce the guest policies.

In another implementation, the second policy engine evaluates a subset of the plurality of policies relevant to the user on the second policy engine to produce the guest policies.

In yet another implementation, the second policy engine retrieves guest policies relevant to the user from a file, policy server, external source, or others.

In an implementation, the guest policies are relevant to the user and information or document being accessed.

In another implementation, the guest policies are relevant to the user and information or documents in the first organization including the information or document being accessed.

In yet another implementation, the guest policies are relevant to the second organization and information or documents in the first organization including the information or document being accessed.

In an implementation, the first policy engine stores the guest policies and applies the guest policies on subsequent policy decisions on the user or a user from the second organization.

In an implementation, the first policy engine requests guest policies relevant to the user from the second policy engine when the user accesses a resource the first time. The guest policies are stored on the first policy engine and applied to the user in subsequent access to the resource. Examples of resources include an application server, a group of application servers, information or a document, a group of information or documents, or others.

An aspect of the invention is a first policy engine in a first organization makes policy decisions based on a first plurality of policies of the first organization to protect information or documents in the first organization delegates policy evaluation to a second policy engine that makes policy decisions based on a second plurality of policies of the second organization when the information or documents in the first organization are accessed by a user in the second organization and the two policy engines participate in making policy decisions in a federated authorization arrangement.

In an implementation, a first policy engine resides in a first organization makes policy decisions on access to information or documents in the first organization by users in the first organization. A second policy engine resides in the second organization makes policy decisions on access to the information or documents by users in the second organization. The first policy engine makes policy decisions based on a plurality of policies of the first organization deployed from a first policy server of the first organization. The second policy engine makes policy decisions based on policies of the second organization deployed from a second policy server in the second organization. The first policy engine and the second policy engine maintain an established trust relationship. When a user in the second organization accesses information or a document in the first organization, the first policy engine requests the second policy engine to assist in making an policy decision.

In another implementation, a first policy engine and a second policy engine reside in a first organization. The first policy engine makes policy decisions on access to information or documents in the first organization by users in the first organization. The second policy engine makes policy decisions on access to the information or documents in the first organization by users in the second organization. The first policy engine makes policy decisions based on a plurality of policies of the first organization deployed from a first policy server in the first organization. The second policy engine makes decisions based on a plurality of guest policies of the second organization deployed from a second policy server. When a user in the second organization accesses information or a document in the first organization, the first policy engine requests the second policy engine to assist in making an policy decision.

In an implementation, when a user in a second organization accesses information or a document in a first organization, a first policy engine in the first organization makes a first decision based on a first plurality of policies of the first organization. If the first decision is allow, the first policy engine makes a request to a second policy engine. The second policy engine makes a second decision based on a second plurality of policies of the second organization, thereby the first policy engine and the second policy engine make policy decisions collaboratively. Consequently, the user is allowed to access the information or document only if the first decision and second decision are allow.

In another implementation, when a user in a second organization accesses information or a document in a first organization, a first policy engine makes a request to a second policy engine. The second policy engine makes a first decision based on a second plurality of policies of the second organization. If the first decision is allow, the first policy engine in the first organization makes a second decision based on a first plurality of policies of the first organization, thereby the first policy engine and the second policy engine make policy decisions collaboratively. Consequently, the user is allowed to access the information or document only if the first decision and second decision are allow.

In yet another implementation, when a user in a second organization accesses information or a document in a first organization, a first policy engine in the first organization makes a first decision based on a first plurality of policies of the first organization. In addition, the first policy engine makes a request to a second policy engine. The second policy engine makes a second decision based on a second plurality of policies of the second organization. The first policy engine combines the first decision and second decision using a combination algorithm to produce a third decision. Consequently, the user is allowed to access the information or document only if the third decision is allow.

In yet an implementation, when a user in a second organization accesses information or a document in a first organization, a first policy engine in the first organization delegates policy decisions to a second policy engine in the second organization, thereby only one policy engine makes policy decisions under this arrangement.

In an example, a first policy engine is assigned to evaluate a first plurality of policies, and a second policy engine is assigned to evaluate a second plurality of policies. When the first policy engine receives a request for a policy decision, it determines the policy decision cannot be made with the first plurality of policies. The first policy engine forwards the request to the second policy engine for a policy decision. The second policy engine receives the forwarded request and determines a policy decision can be made with the second plurality of policies. The second policy engine evaluates a subset of the second plurality policies relevant to the request to produce a policy decision.

In another example, a user in a second organization accesses a document on an application server in a first organization. A policy enforcer on the application server intercepts a file open operation on the document. The policy enforcer sends a request with information on the file open operation, user and document to a first policy engine in the first organization for a policy decision. The first policy engine determines the user belongs to the second organization and it needs to collaborate with a second policy engine in the second organization to make policy decision.

As a first step, the first policy engine will decide if a user in the second organization has access to the document. To make such decision, the first policy engine selects a subset of the first plurality of policies of the first organization on the first policy engine relevant to the file open operation, second organization and document. The first policy engine evaluates the subset of the first plurality of policies to produce a first decision. If the first decision denies access to the document, the first policy engine returns a deny policy decision to the policy enforcer and the application server denies the user access to the document.

As a second step, if the first decision allows access to the document, the first policy engine queries the second policy engine to determine if the user should have access to the document. The first policy engine forwards the request to the second policy engine with information on the file open operation, user and document. The second policy engine receives the forwarded request, and determines the user belongs to the second organization. The second policy engine selects a subset of the second plurality of policies of the second organization on the second policy engine relevant to the file open operation, user and document. The second policy engine evaluates the subset of the second plurality of policies to produce a second decision. The second policy engine returns the second decision to the first policy engine.

If the second decision allows access to the document, the first policy engine returns an allow policy decision to the policy enforcer and the application server allows the user to access the document. If the second decision denies access to the document, the first policy engine returns a deny policy decision to the policy enforcer and the application server denies the user access to the document.

An authorization provider is an integration point between an information management system and a federated authentication system. To an identity provider, an authorization provider is a source of authorization claims for a user. An identity provider creates an identity assertion with the authorization claims.

Authorization claims comprise roles, access or usage permissions, rights, user attributes, resource identifiers, resource attributes, guest policies, or others. Roles may correspond to functional roles in an organization, logical grouping of functions for selected tasks, logical grouping of resources, or others. Rights may include read, write, print, export, send, or others. User attributes may be used to control access to resources. Resource identifiers may include application names, application identifiers, Universal Resource Locators (URLs), directory or file paths, directory or file names, or others. Resource attributes may include file types, file extensions, regular expression for matching file names, or others.

Guest policies are policies relevant to a user or organization. Guest policies may be declarative, executable code, or others. Guest policies may be stored in NextLabs Compliant Enterprise Active Control Policy Language™ (ACPL), Extensible Access Control Markup Language (XACML), JavaScript Object Notation (JSON), or other formats in an authorization claim. Guest policies may be stored in one authorization claim or many authorization claims.

In an implementation, an authorization provider queries a policy engine to produce a decision. The authorization provider converts the decision into authorization claims.

In another implementation, an authorization provider queries a policy engine to produce authorization claims.

In yet another implementation, an authorization provider retrieves authorization claims from a database, file, or others.

An aspect of the invention is federated authorization services. Federated authorization services is a collection of services that enable federation of policy distribution and evaluation across organizations. Examples of federated authorization services include discovery, name services, registration, routing of policy evaluation requests, routing of guest policies requests, request filtering, load balancing, or others. Discovery allows a policy engine in a first organization to locate another policy engine in a second organization. Name services provide a unified approach in naming organizations and policy engines to facilitate routing of requests. Name services also enable use of address spaces to organize policy engines in different organizations. Registration allows a policy engine to communicate with a plurality of policy engines in a plurality of organizations by subscribing to one federated authorization services. Request filtering allows a policy engine to decide the types of requests or sources of requests it will accept or reject, so that only requests that are acceptable to a policy engine will be router to the policy engine. Load balancing allows grouping of a plurality of policy engines that can handle the same requests into a logical unit.

A federated authorization server is a server application that implements federated authorization services. Federated authorization servers accept connections from policy engines and facilitate communication between policy engines. Federated authorization servers may be deployed in different topologies including stand-alone, peer-to-peer, hierarchal, any combinations thereof, or others to support different operational requirements.

FIG. 4 shows a logic diagram 401 of a server application (also referred to as relying application in federated authentication) 403 delegating authentication function to an identity provider 404. Examples of server applications include web servers, Enterprise Resource Management (ERP) applications, Product Lifecycle Management (PLM) applications, collaborative platforms, analytical and reporting applications, source code control applications, application servers, or many others. An identity provider 404 provides authentication services to server applications. The identity provider also manages identity information of users (also referred to as principals in federated authentication). The methods the identity provider uses to authenticate a user include user name/password, multi-factor authentication, biometric, pin, or others. Examples of authentication protocols that an identity provider implement include OpenID Connect (OIDC), Security Assertion Markup Language (SAML), or others. The server application may establish trust with the identity provider via a certificate, application programming interface (API) token, or others.

Authentication process begins when a user attempts to log on to a server application 403 using a client application 402. Examples of client applications include web browsers, application programs running on Microsoft Windows®, application programs running on Linux®, apps running on Apple iPhone®, or other. Log on process typically starts with a client application sending an authentication request to a server application.

In step (1) 405, the user attempts to log on to the server application 403. The client application 402 sends a first authentication request to the server application. If the client application is a web browser, the first authentication request is a HTTP or HTTPS request.

In step (2) 406, the server application receives the first authentication request from the client application. The server application and the identity provider 404 have an established trust relationship 414. The server application delegates authentication to the identity provider.

The server application responds to the first authentication request from the client application. The response comprises a first redirection instruction, redirecting authentication to the identity provider.

In step (3) 407, the client application receives a response to the first authentication request from the server application. The response comprises the first redirection instruction. The client application sends a second authentication request to the identity provider. If the first authentication request is a HTTP or HTTPS request, the second authentication request is a redirection of the HTTP or HTTPS request.

In step (4) 408, the identity provider receives the second authentication request from the client application. The identity provider attempts to authenticate the user. The authentication process may require additional exchanges between the identity provider and the client application. The identity provider and the client application exchange information according to the authentication protocol being used. Examples of authentication protocols include challenge-response protocol, Challenge-Handshake Authentication Protocol (CHAP), Extensible Authentication Protocol (EAP), Remote Authentication Dial-in User Service (RADIUS), Kerberos, or others.

If the identity provider successfully authenticated the user, the identity provider creates an identity assertion 601 comprising a plurality of authentication claims 602 and a plurality of authorization claims 603. The identity assertion may be encrypted or digitally signed 604.

In step (5) 409, the identity provider responds to the second authentication request from the client application. If the identity provider successfully authenticated the user, the response comprises the identity assertion and a second redirection instruction, redirecting the response to the server application. If the identity provider fails to authenticate the user, the identity provider returns an error to the client application. The client application displays an error message, and the user login has failed.

In step (6) 410, the client application receives the response to the second authentication request from the identity provider. If authentication is successful, the client application sends a third authentication request to the server application with the identity assertion according to the second redirection instruction. If the second authentication request is a HTTP or HTTPS request, the third authentication request is a redirection of the HTTP or HTTPS request.

In SAML implementation, the server application validates the identity assertion. If validation is successful, the authentication process completes successfully. SAML does not require steps (7) and (8), continue with step (9).

In OIDC implementation, the identity assertion is validated in a redemption step. Redemption is covered in steps (7) and (8).

In step (7) 411, the server application sends a redemption request to the identity provider with the identity assertion.

In step (8) 412, the identity provider receives the redemption request from the server application. The identity provider validates the identity assertion. If validation is successful, the identity provider responds with additional authentication claims and optionally with authorization claims. If validation fails, the identity provider returns an error.

In step (9) 413, the server application responds to the third authentication request from the client application. If the identity assertion is validated successfully, the server application extracts information from the plurality of authentication claims and the plurality of authorization claims in the identity assertion. The server application uses the extracted information to construct a landing page for the user. A landing page is the first page displayed after a user logs on to a server application. A landing page is often called a user's home page in a web application. For example, if a user enters a Universal Resource Locator (URL) to a particular web page on a web browser, a server application constructs the particular web page and return the particular web page to the web browser. The response comprises the landing page. The client application displays the landing page.

If the identity assertion is not validated successfully, the response comprises an error code indicating authentication has failed. The client application displays an error message.

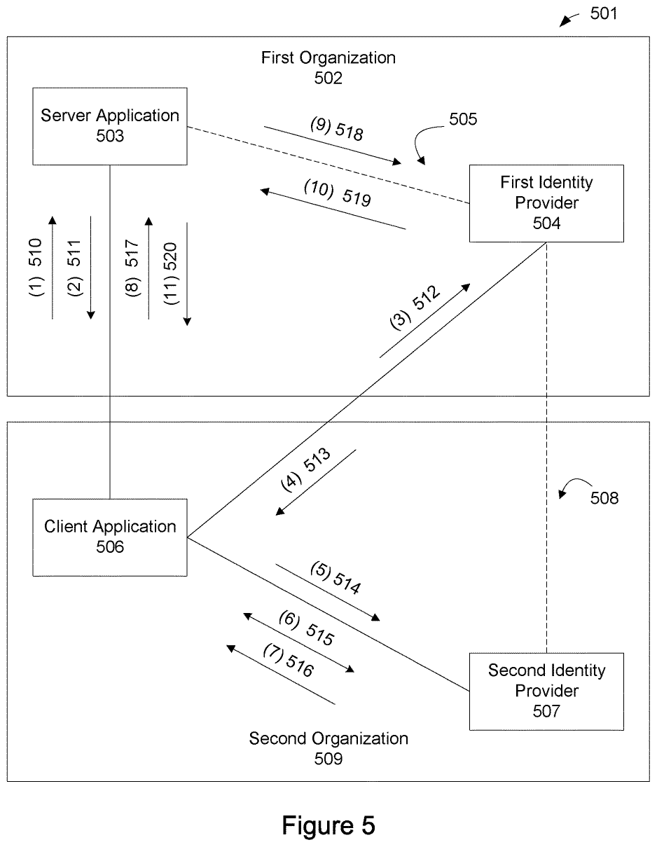

FIG. 5 shows a logic diagram 501 of a server application 503 in a first organization 502 delegating authentication of a user to a first identity provider 504 in the first organization and a second identity provider 507 in a second organization 509 in a federated authentication arrangement. The second organization has an agreement with the first organization where employees in the second organization are given access to the server application (e.g., partner portal) in the first organization. Instead of creating new usernames/passwords in the first organization for the employees, federated authentication is used to authenticate the employees. Examples of server applications include web servers, Enterprise Resource Management (ERP) applications, Product Lifecycle Management (PLM) applications, collaborative platforms, analytical and reporting applications, source code control applications, application servers, or many others. The identity provider provides authentication services to server applications. They also manage identity information of users (also referred to as principals in federated authentication) in their respective organizations.

Authentication process begins when a user in a second organization 509 accesses a server application 503 in a first organization 502 using a client application 506. Examples of client applications include web browsers, application programs running on Microsoft Windows®, application programs running on Linux®, apps running on Apple iPhone®, or other. Log on process typically starts with a client application sending an authentication request to a server application.

In step (1) 510, the user attempts to log on to the server application 503. The client application 506 sends a first authentication request to the server application. If the client application is a web browser, the first authentication request is a HTTP or HTTPS request.

In step (2) 511, the server application receives the first authentication request from the client application. The server application and the first identity provider 504 have an established trust relationship 505. The server application delegates authentication to the identity provider.

The server application responds to the first authentication request from the client application. The response comprises a first redirection instruction, redirecting authentication to first the identity provider.

In step (3) 512, the client application receives the response to the first authentication request from the server application. The response comprises the first redirection instruction. The client application sends a second authentication request to the first identity provider. If the first authentication request is a HTTP or HTTPS request, the second authentication request is a redirection of the HTTP or HTTPS request.

In step (4) 513, the first identity provider receives the second authentication request from the client application. The first identity provider determines the user is not a member of the first organization. The first identity provider locates a second identity provider 507 in the second organization that may authenticate the user. The first identity provider confirms that it has a trust relationship 508 with the second identity provider.

The first identity provider may use one or more methods to determine which organization a user belongs to. The methods include login name, user information stored in a database, organization name provided explicit during login, or others. Common login name that contains information on an organization includes User Principal Name (UPN) and down-level login name. UPN has a format user@domain and a common UPN is email address. An example for UPN is john.doe@nextlabs.com. Down-level login name has format domain\user. An example for down-level login name is NEXTLABS\john.doe. In an example, a user may login with an email address john.doe@organizationb.com where domain name organizationb.com in the email address can be used to determine the organization that the user belongs to.

The first identity provider responds to the second authentication request from the client application. The response comprises a second redirection instruction, redirecting authentication to the second identity provider.

In step (5) 514, the client application receives a response to the second authentication request from the first identity provider. The response comprises the second redirection instruction. The client application sends a third authentication request to the second identity provider. If the second authentication request is a HTTP or HTTPS request, the third authentication request is a redirection of the HTTP or HTTPS request.

In step (6) 515, the second identity provider receives the third authentication request from the client application. The second identity provider attempts to authenticate the user. The authentication process may require additional exchanges between the second identity provider and the client application. The second identity provider and the client application exchange information according to the authentication protocol being used. Examples of authentication protocols include challenge-response protocol, Challenge-Handshake Authentication Protocol (CHAP), Extensible Authentication Protocol (EAP), Remote Authentication Dial-in User Service (RADIUS), Kerberos, or others.

If the second identity provider successfully authenticated the user, the second identity provider creates an identity assertion 601 comprising a plurality of authentication claims 602 and a plurality of authorization claims 603. The identity assertion may be encrypted or digitally signed 604.

The plurality of authentication claims bears information about a user. Examples of authentication claims include user name, title, organizations, departments, intended audience, authentication request time, identity assertion expiration time, or others. The plurality of authorization claims bears information related to permissions granted to a user. Examples of authorization claims include roles, access or usage permissions, rights, user attributes, resource identifiers, resource attributes, guest policies, or others.

In step (7) 516, the second identity provider responds to the third authentication request from the client application. If the second identity provider successfully authenticated the user, the response comprises the identity assertion and a third redirection instruction, redirecting the response to the server application. If the second identity provider fails to authenticate the user, the second identity provider returns an error code to the client application. The client application displays an error message, and the user login has failed.

In step (8) 517, the client application receives the response to the third authentication request from the second identity provider. If authentication is successful, the client application sends a fourth authentication request to the server application with the identity assertion according to the third redirection instruction. If the third authentication request is a HTTP or HTTPS request, the fourth authentication request is a redirection of the HTTP or HTTPS request.

In SAML implementation, the server application validates the identity assertion. If validation is successful, the authentication process completes successfully. SAML does not require steps (9) and (10), continue with step (11).

In OIDC implementation, the identity assertion is validated in a redemption step. Redemption is covered in steps (9) and (10).

In step (9) 518, the server application sends a redemption request the first identity provider with the identity assertion.

In step (10) 519, the first identity provider receives the redemption request from the server application. The first identity provider validates the identity assertion. If validation is successful, the first identity provider responds with additional authentication claims and optionally with authorization claims. If validation fails, the first identity provider returns an error.

In step (11) 520, the server application responds to the fourth authentication request from the client application. If the identity assertion is validated successfully, the server application extracts information from the plurality of authentication claims and the plurality of authorization claims in the identity assertion. The server application uses the extracted information to construct a landing page for the user. A landing page is the first page displayed after a user logs on to a server application. A landing page is often called a user's home page in a web application. The response comprises the landing page. The client application displays the landing page.

If the identity assertion is not validated successfully, the response comprises an error code indicating authentication has failed. The client application displays an error message.

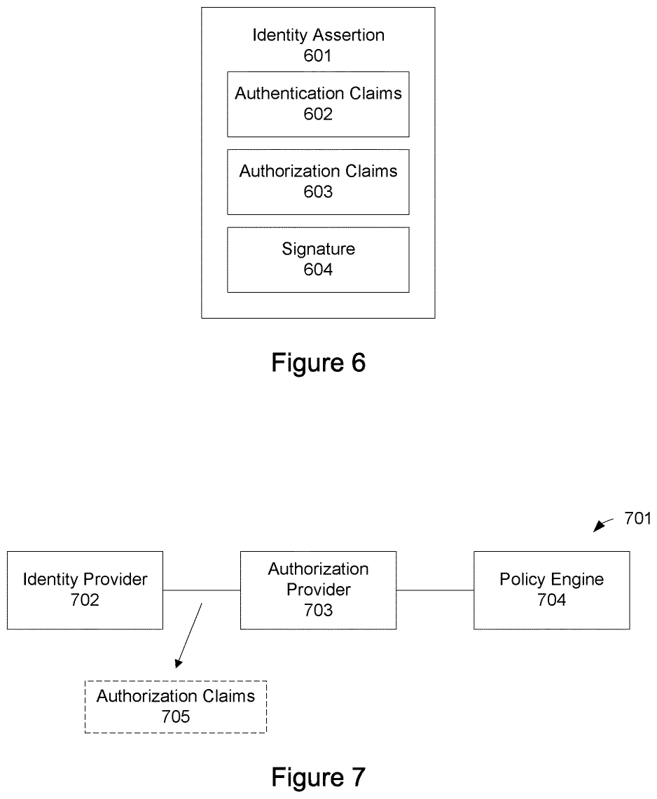

FIG. 6 shows a block diagram of an identity assertion 601. An identity assertion comprises a plurality of authentication claims 602, a plurality of authorization claims 603 and a signature (also referred to as cryptographic signature) 604. The plurality of authentication claims bear information about a user. Examples of authentication claims include user name, title, organizations, departments, intended audience, authentication request time, identity assertion expiration time, or others. The plurality of authorization claims bear information related to permissions granted to the user. Examples of authorization claims include roles, access or usage permissions, rights, user attributes, resource identifiers, resource attributes, guest policies, or others. Roles may correspond to functional roles in an organization, logical grouping of functions for selected tasks, logical grouping of resources, or others. Rights may include read, write, print, export, send, or others. User attributes may be used to control access to resources. Resource identifiers may include application names, application identifiers, Universal Resource Locators (URLs), directory or file paths, directory or file names, or others. Resource attributes may include file types, file extensions, regular expression for matching file names, or others. Guest policies are policies relevant to a user or organization. Guest policies may be declarative, executable code, or others. Guest policies may be provided by a policy engine. Guest policies may be a subset of the plurality of policies on a policy engine relevant to a user.

In an implementation, the plurality of authentication and the plurality of authorization claims are stored unencrypted in an identity assertion and a cryptographic signature of the unencrypted content in the identity assertion is included to allow recipients of the identity assertion to verify the validity of the identity assertion.

In another implementation, the plurality of authentication and the plurality of authorization claims in an identity assertion are encrypted. The identity assertion includes an unencrypted header.

An identity assertion may be used to pass authentication and authorization data from an identity provider 404, 504 or 507 to a server application 403 or 503.

In an implementation, an identity assertion is JSON Web Token (JWT). JWT consists of three components: a header, a payload and a signature. In most cases, header and payload are signed according to JSON Web Signing (JWS) specifications.

In an implementation, the signature in JWT is a cryptographic hash of the combined Base64 encoded header, Base64 encoded payload and identity provider's secret. All three components in a JWT are Base64 encoded.

In an example, a server application receives a JWT in a response to an authentication request. The Base64 encoded JWT is:

eyJhbGciOiJSUzI1NiIsInR5cCI6IkpXVCJ9.eyJpc3MiOiJodHRwczovL2V4YW1wbGUuY2
9tIiwic3ViIjoiMTIzNDU2Nzg5MCIsImF1ZCI6InlvdXItY2xpZW50LWlkIiwiZXhwIjoxNjE
4ODg0NDc3LCJpYXQiOjE2MTg4ODA4NzcsImF1dGhfdGltZSI6MTYxODg4MDg3Niwib
m9uY2UiOiJyYW5kb20tbm9uY2UiLCJuYW1lIjoiSm9obiBEb2UiLCJlbWFpbCI6ImpvaG4
uZG9lQGV4YW1wbGUuY29tIn0.SflKxwRJSMeKKF2QT4fwpMeJf36POk6yJV_adQssw5
c

Base64 decoding the JWT produces header and payload in JSON format.

```
{
  “alg”: “RS256”,
  “typ”: “JWT”
}
{
  “iss”: “https://example.com”,
  “sub”: “1234567890”,
  “aud”: “your-client-id”,
  “exp”: 1618884477,
  “iat”: 1618880877,
  “auth_time”: 1618880876,
  “nonce”: “random-nonce”,
  “name”: “John Doe”,
  “email”: “john.doe@example.com”
}
```

FIG. 7 shows a functional block diagram 701 of an authorization provider 703 producing authorization claims 705 for an identity provider 702 dynamically based on polices. The identity provider sends an authorization claim request including information about a user and optionally with the resource being requested to the authorization provider. The authorization provider sends a guest policy request to a policy engine 704 with the user information and resources being requested if provided.

The policy engine evaluates policies dynamically and the outcome of policy evaluation (or authorization claim decision) determines: (a) roles to grant to the user; (b) attributes to assigned to the user; (c) resources that the user may access; (d) a plurality of guest policies that should be applied to the user; any combinations thereof, or others. Examples of roles that may be assigned include administrator, executive, manager, staff, purchasing, receiving, inventory, accounting, support, legal, or many more. Examples of attributes that may be assigned to a user include export control, name of a project, name of a group, name of a service, or many more. Examples of resources that a user may access include name of an application program, name of a folder, regular expression on file name, operations allowed on an application program, read or write access to a file, and many more. Guest policies are access or use control policies, rights control policies, data access policies, encryption policies, any combination thereof, or others. Guest policies may be stored in ACPL, XACML, JSON, or other formats. An example of guest policies that should be applied to the user may specify what actions the user may take or what resources the user may access while accessing information or documents in a partner organization.

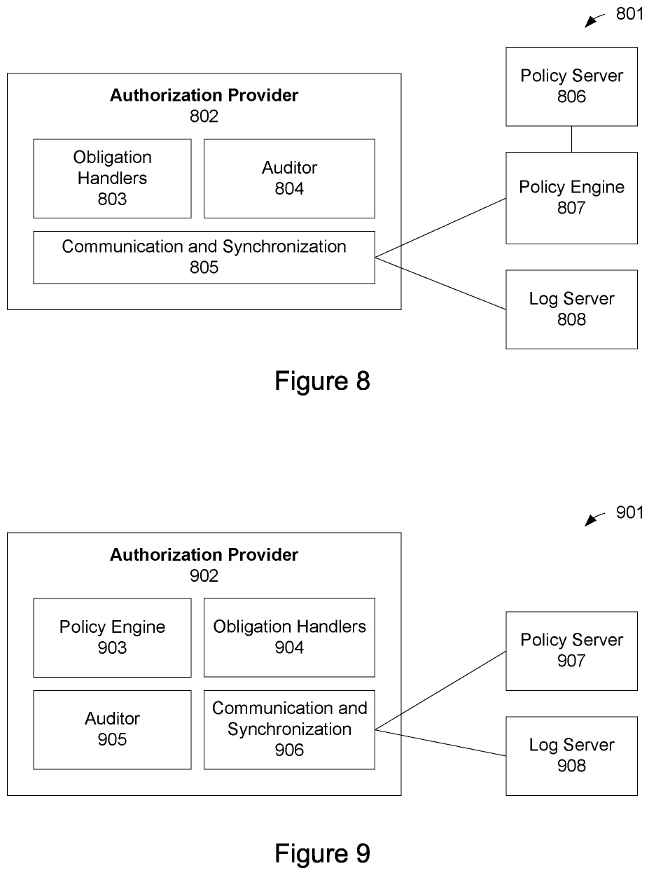

FIG. 8 shows a functional block diagram 801 of an authorization provider 802 using an external policy engine 807 to make authorization claim decisions. The authorization provider comprises of obligation handlers 803, optionally an auditor 804 and a communication and synchronization module 805. The obligation handlers are responsible for converting (or translating) authorization claim decisions into authorization claims. The auditor is responsible for logging authorization claim decisions to a log server 808. In an implementation, the auditor is a component of the authorization provider. In another implementation, the auditor is a component of the policy engine. The communication and synchronization module is responsible for communicating with an identity provider 702, the policy engine, and the log server. A policy server 806 provides a plurality of policies to the policy engine. The plurality of policies comprises authorization claim policies.

To obtain authorization claims dynamically for a user, the identity provider sends an authorization claim request to the authorization provider with information on the user that the identity provider successfully authenticated, and optionally resources being requested. The authorization provider sends a guest policy request to the policy engine with the information on the user and resources. The policy engine evaluates a subset of the plurality of policies relevant to the user and resources to produce an authorization claim decision. The policy engine returns the authorization claim decision to the authorization provider. The obligation handlers convert the authorization claim decision into authorization claims. The auditor sends the authorization claim request and related information to the log server. The authorization claims are returned to the identity provider.

FIG. 9 shows a functional block diagram 901 of an authorization provider 902 with an integrated policy engine 903. The authorization provider comprises of the policy engine, obligation handlers 904, optionally an auditor 905, and a communication and synchronization module 906. The policy engine is responsible for making authorization claim decisions based on a plurality of policies obtained from a policy server 907. The plurality of policies comprises authorization claim policies. The obligation handlers are responsible for converting (or translating) authorization claim decisions into authorization claims. The auditor is responsible for logging authorization claim decisions to a log server 908. The communication and synchronization module is responsible for communicating with an identity provider 702 and the policy server.

To obtain authorization claims dynamically for a user, the identity provider sends an authorization claim request to the authorization provider with information on the user that the identity provider successfully authenticated, and optionally resources being requested. The policy engine makes an authorization claim decision on authorization to grant to the user. In an example, the policy engine may decide based on the time a user logs on to a server application, and access to information or a document is available only to the time allowed by the plurality of policies. In another example, the policy engine may decide based on the computer a user used to access a server application and deny access if the computer does not meet requirements according to the plurality of policies. The authorization granted by the policy engine may be different on different requests. The authorization granted may be static (e.g., roles) or dynamic (e.g., guest policies that need to be evaluated at the time of access to decide to produce a policy decision). The policy engine evaluates a subset of the plurality of policies relevant to the user and resources to produce an authorization claim decision. The obligation handlers convert (or translate) the authorization claim decision into authorization claims. The auditor sends the authorization claim request and the authorization claim decision to the log server. The authorization claims are returned to the identity provider.

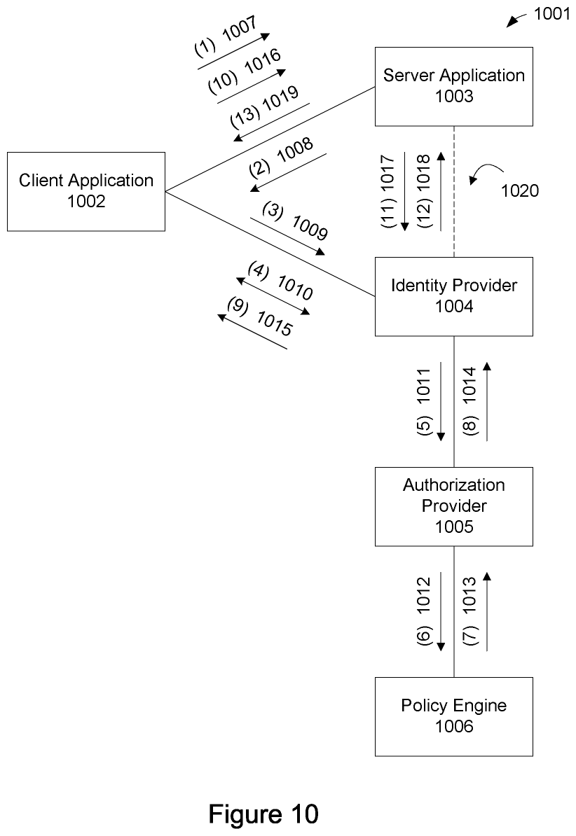

FIG. 10 shows a logic diagram 1001 of a server application 1003 delegating authentication function to an identity provider 1004 and an authorization provider 1005 producing authentication claims 705 dynamically for an authenticated user. The server application and the identity provider have an established trust relationship 1020. A policy engine 1006 makes an authorization claim decision on the authenticated user based on a plurality of authorization claim policies. The authorization provider converts (or translates) the authorization claim decision into authorization claims. Examples of server applications include web servers, Enterprise Resource Management (ERP) applications, Product Lifecycle Management (PLM) applications, collaborative platforms, analytical and reporting applications, source code control applications, application servers, or many others. The identity provider provides authentication services to server applications. It also manages identity information of users. The methods an identity provider uses to authenticate a user include user name/password, multi-factor authentication, biometric, pin, or others. Examples of authentication protocols that an identity provider implements include OIDC, SAML, or others. The server application establishes trust with the identity provider via a certificate, application programming interface (API) token, or others.

Authentication process begins when a user logs on to the server application 1003 using a client application 1002. Log on process typically starts with a client application sending an authentication request to a server application.

In step (1) 1007, the user attempts to log on to the server application. The client application sends a first authentication request to the server application.

In step (2) 1008, the server application receives the first authentication request from the client application. The server application and the identity provider 1004 have an established trust relationship 1020. The server application delegates authentication to the identity provider.

The server application responds to the first authentication request from the client application. The response comprises a first redirection instruction, redirecting authentication to the identity provider.

In step (3) 1009, the client application receives the response to the first authentication request from the server application. The response comprises the first redirection instruction. The client application sends a second authentication request to the identity provider.

In step (4) 1010, the identity provider receives the second authentication request from the client application. The identity provider attempts to authenticate the user. The authentication process may require additional exchanges between the identity provider and the client application.

The identity provider and the client application exchange information according to the authentication protocol being used. Examples of authentication protocols include challenge-response protocol, Challenge-Handshake Authentication Protocol (CHAP), Extensible Authentication Protocol (EAP), Remote Authentication Dial-in User Service (RADIUS), Kerberos, or others.

In step (5) 1011, if the identity provider successfully authenticated the user, the identity provider sends an authorization claim request to the authorization provider 1005 including information on the user and optionally resources requested by the user. If the identity provider fails to authenticate the user, the identity provider returns an error to the client application. The client application displays an error message, and the user login has failed.

In step (6) 1012, the authorization provider receives the authorization claim request from the identity provider. The authorization provider sends a guest policy request to the policy engine 1006 with information on the user and optionally resources requested by the user.

In step (7) 1013, the policy engine receives the guest policy request from the authorization provider. The policy engine selects a subset of the plurality of authorization claim policies relevant to the user and resources. The policy engine evaluates the subset of the plurality of authorization claim policies to produce an authorization claim decision. The policy engine returns the authorization claim decision to the authorization provider.

The authorization claim decision comprises roles, access or usage permissions, rights, user attributes, resource identifiers, resource attributes, guest policies, guest policy identifier, any combinations thereof, or others. Guest policies are policies relevant to a user or organization. Guest policies may be a subset of the plurality of authorization claim policies on the policy engine relevant to the user.

In step (8) 1014, the authorization provider receives a response to the guest policy request from the policy engine. The response comprises the authorization claim decision. The authorization provider converts (or translates) the authorization claim decision into a plurality of authorization claims. The authorization provider returns the plurality of authentication claims to the identity provider. The authorization provider may log the authorization claim request by sending related information to a log server 808 or 908.

In step (9) 1015, the identity provider receives a response to the authorization claim request from the authorization provider. The response comprises the plurality of authorization claims. The identity provider creates an identity assertion 601 comprising a plurality of authentication claims and the plurality of authorization claims. The identity assertion may be encrypted or digitally signed 604.

The plurality of authentication claims bears information about a user. Examples of authentication claims include user name, title, organizations, departments, intended audience, authentication request time, identity assertion expiration time, or others. The plurality of authorization claims bear information related to permissions granted to a user. Examples of authorization claims include roles, access or usage permissions, rights, user attributes, resource identifiers, resource attributes, guest policies, or others.

The identity provider responds to the second authentication request from the client application. The response comprises the identity assertion and a second redirection instruction, redirecting authentication request to the server application.

In step (10) 1016, the client application receives a response to the second authentication request from the identity provider. The response comprises the identity assertion and the second redirection instruction. The client application sends a third authentication request to the server application with the identity assertion.

In SAML implementation, the server application validates the identity assertion. If validation is successful, the authentication process completes successfully. SAML does not require steps (11) and (12), continue with step (13).

In OIDC implementation, the identity assertion is validated in a redemption step. Redemption is covered in steps (11) and (12).

In step (11) 1017, the server application sends a redemption request with the identity assertion to the identity provider.

In step (12) 1018, the identity provider receives the redemption request from the server application. The identity provider validates the identity assertion. If validation is successful, the identity provider responds with additional authentication claims and optionally with authorization claims. If validation fails, the identity provider returns an error.

In step (13) 1019, the server application responds to the third authentication request from the client application. If the identity assertion is validated successfully, the server application extracts information from the plurality of authentication claims and the plurality of authorization claims in the identity assertion. The server application uses the extracted information to construct a landing page for the user. A landing page is the first page displayed after a user logs on to a server application. A landing page is often called a user's home page in a web application. The response comprises the landing page. The client application displays the landing page.

If the identity assertion is not validated successfully, the response comprises an error code indicating authentication has failed. The client application displays an error message.

In an implementation, the server application and the identity provider establish trust using a certificate. The identity provider encrypts the identity assertion using its private key and the server application validates the identity assertion by decrypting the identity assertion using the identity provider's public key.

In another implementation, the server application and the identity provider establish trust using an application program interface (API) token.

In an implementation, the identity assertion includes a cryptographic signature of its content, and the server application validates the identity assertion using the cryptographic signature.

In another implementation, the server application sends the identity assertion to the identity provider, and the identity provider validates the identity assertion.

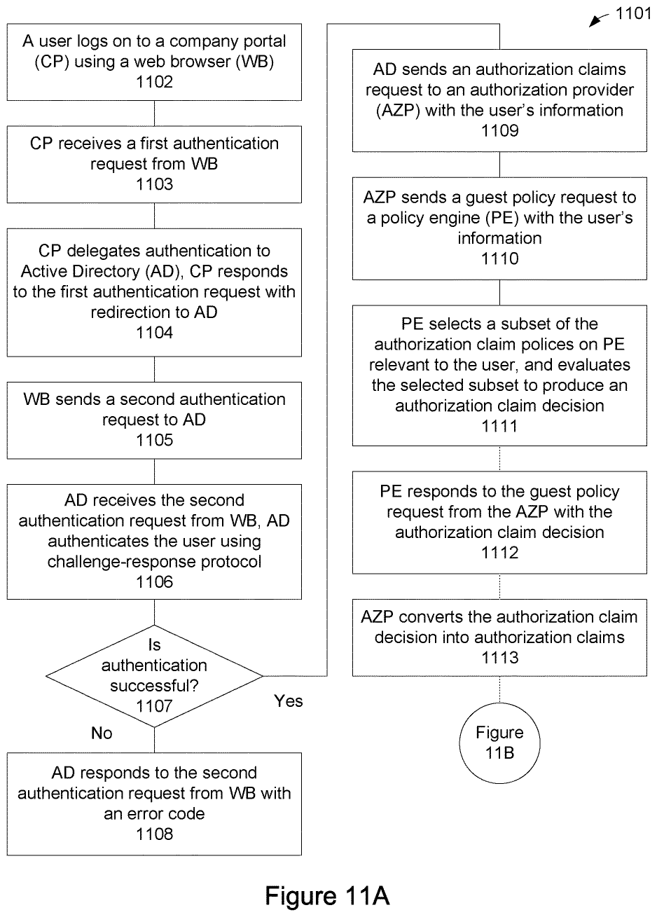

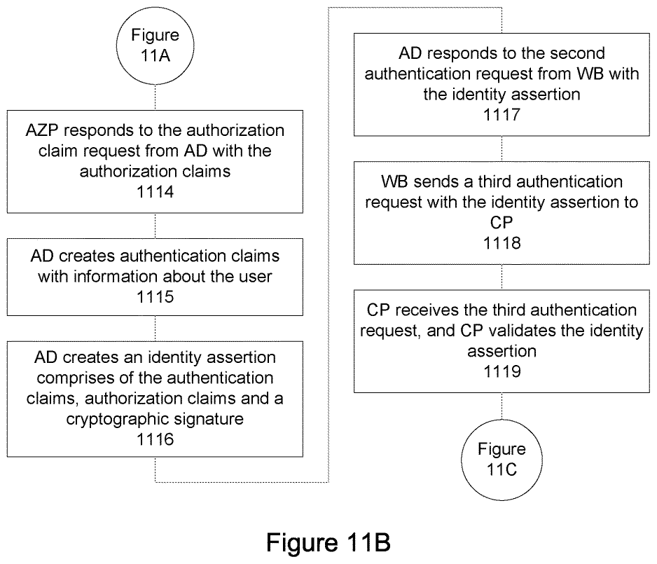

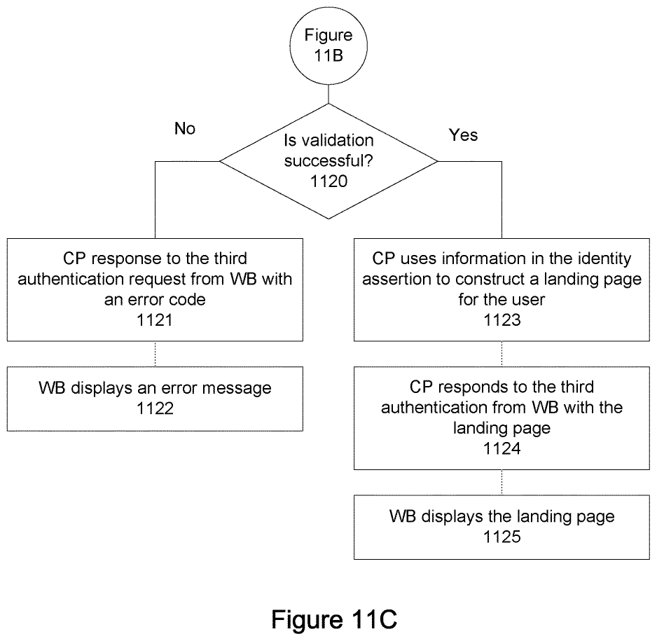

Referring to FIGS. 11A-11C, a flow diagram 1101 shows a user, John Doe, accessing a company portal 1003 using a web browser 1002 and the company portal authenticates the user by delegating authentication to Active Directory 1004 where identity provider functions are provided by Active Directory Federation Services.

In step 1102, the user logs on to the company portal (CP) 1003 using the web browser (WB) 1002. WB sends a first authentication request to CP. The first authentication request is a HTTPS request.

In step 1103, CP receives the first authentication request from WB.

In step 1104, since CP and Active Director (AD) 1004 have an established trust relationship 1020, CP delegates authentication to AD. CP responds to the first authentication request from WB. The response comprises a first redirection instruction, redirecting authentication to AD.

In step 1105, WB receives the response to the first authentication request from CP. The response comprises the first redirection instruction. WB sends a second authentication request to AD.

In step 1106, AD receives the second authentication request from WB. AD authenticates the user using challenge-response protocol. The user is asked to enter a two-factors authentication code.

In step 1108, if authentication is not successful, AD responds to the second authentication request from WB with an error code indicating authentication has failed. WB displays an error message.

In step 1109, if authentication is successful, AD sends an authorization claim request to an authorization provider (AZP) 1005 with the user's information.

In step 1110, AZP receives the authorization claim request from AD. AZP sends a guest policy request to a policy engine (PE) 1006 with the user's information.

In step 1111, PE receives the guest policy request from AZP. PE selects a subset of the plurality of authorization claim policies on PE relevant to the user. PE evaluates the subset of the plurality of authorization claim policies to produce an authorization claim decision.

In step 1112, PE responds to the guest policy request from AZP. The response comprises the authorization claim decision.

In step 1113, AZP receives the response to the guest policy request from PE. AZP converts (or translates) the authorization claim decision into a plurality of authorization claims.

In step 1114, AZP response to the authorization claim request from AD. The response comprises the plurality of authorization claims.

In step 1115, AD receives the response to the authorization claim request from AZP. AD creates a plurality of authentication claims with information about the user.

In step 1116, AD creates an identity assertion 601 comprises of the plurality of authentication claims, the plurality of authorization claims and a cryptographic signature.

In step 1117, AD responds to the second authentication request from WB. The response comprises the identity assertion and a second redirection instruction, redirecting authentication to the CP.

In step 1118, WB receives the response to the second authentication request from AD. The response comprises the second redirection instruction. WB sends a third authentication request with the identity assertion to CP.

In step 1119, CP receives the third authentication request from WB. CP validates the identity assertion.

In step 1121, if validation of the identity assertion fails, CP responds to the third authentication request from WB with an error code indicating authentication has failed.

In step 1122, WB receives the response to the third authentication request from CP. WB displays an error message.

In step 1123, if validation of the identity assertion is successful, CP extracts information from the plurality of authentication claims and the plurality of authorization claims. CP uses the information to construct a landing page for the user. A landing page is the first page displayed after a user logs on to a CP.

In an implementation, the plurality of authorization claims comprises a plurality of roles and permissions. CP uses the plurality of roles and permissions to control access and usage of resources by the user.

In step 1124, CP responds to the third authentication request from WB with the landing page.

In step 1125, WB receives the response to the third authentication request from CP. WB displays the landing page.

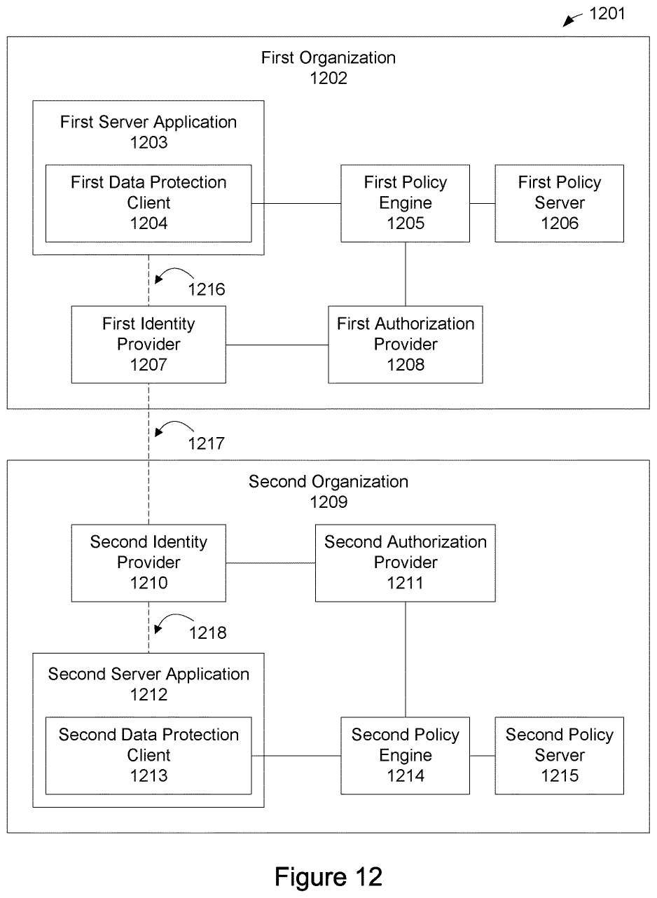

FIG. 12 shows a functional block diagram 1201 of federated authentication and authorization arrangements between two organizations 1202 and 1209. In this example, the two organizations share the same information management system architecture, both: (a) delegate authentication to identity providers 1207 and 1210; (b) produce authorization claims dynamically with authorization providers 1208 and 1211; (c) use data protection clients 1204 and 1213 to protect information or documents on or accessible from server applications 1203 and 1212; (d) implement one or more types of policies described above; and (e) use policy engines 1205 and 1214 to make authorization claim decisions.

In a first organization 1202, a first server application 1203 delegates authentication function to a first identity provider 1207. Examples of server applications include web servers, Enterprise Resource Management (ERP) applications, Product Lifecycle Management (PLM) applications, collaborative platforms, analytical and reporting applications, source code control applications, application servers, or many others. Examples of authentication protocols that an identity provider implement include OIDC, SAML, or others. The first server application has an established trust relationship 1216 with the first identity provider. Trust relationship may be established with certificate, application program interface (API) token, pin, or other methods. In an example, the first identity provider establishes a trust relationship with the first server application by providing a digital certificate to the first server application, thereby the first server application may use a public key in the digital certificate to encrypt or decrypt data sent to or received from the first identity provider.

When the first identity provider successfully authenticates a user, it returns an identity assertion to the first server application. The identity assertion comprises a plurality of authentication claims and a plurality of authorization claims. The plurality of authentication claims is created by the first identity provider with information related to the user. The plurality of authorization claims is created by a first authorization provider 1208 when requested by the first identity provider. The first authorization provider sends a guest policy request to a first policy engine 1205 for an authorization claim decision. The first authorization provider converts the authorization claim decision into a plurality of authorization claims. The first policy engine obtains policies from a first policy server 1206.

To protect information or documents on or accessible from the first server application, a first data protection client 1204 enforces policies on information or document access and usage. The first data protection client sends a policy decision request to the first policy engine for an access or use control decision.

In a second organization 1209, a second server application 1212 delegates authentication function to a second identity provider 1210. The second server application and the second identity provider have an established trust relationship 1218. The second identity provider authenticates users in the second organization. When a user is successfully authenticated, the second identity provider creates a plurality of authentication claims for the user. A plurality of authorization claims is created by a second authorization provider 1211. The second authorization provider sends a guest policy request to a second policy engine 1214 for an authorization claim decision. The second authorization provider converts the authorization claim decision into a plurality of authorization claims. The second policy engine obtains policies from a second policy server 1215. To protect information or documents on the second server application, a second data protection client 1213 enforces policies on information or document access and usage. The second data protection client sends a policy decision request to the second policy engine for an access control decision.

To support federated authentication and authorization, a trust relationship 1217 is established between the first identity provider and the second identity provider.

When a user in the first organization logs on to the first server application, the first server application delegates authentication function to the first identity provider. The first identity provider determines the user belongs to the first organization and the first identity provider authenticates the user. If the user is authenticated, the first identity provider returns an identity assertion to the first server application, and the user login completes successfully.

When a user in the second organization logs on to the first server application in the first organization, the first server application delegates authentication function to the first identity provider. The first identity provider determines the user belongs to the second organization and confirms that it has a trust relationship 1217 with the second identity provider. The first identity provider delegates authentication function to the second identity provider.

The second identity provider determines the user belongs to the second organization and the second identity provider authenticates the user. If the user is authenticated, the second identity provider creates a plurality of authentication claims with the user's information. The second identity provider requests authorization claims for the user from the second authorization provider. Authorization claims comprise roles, access or usage permissions, rights, user attributes, resource identifiers, resource attributes, guest policies, or others. Guest policies are policies relevant to the user or the second organization. Guest policies may be declarative, executable code, or others. Guest policies may be provided by the second policy engine. Guest policies may be a subset of the plurality of authorization claim policies on the second policy engine relevant to a user.

The second identity provider creates an identity assertion with the plurality of authentication claims and the plurality of authorization claims. The second identity provider returns the identity assertion to the first server application. The user login completes successfully.

Similarly, a guest user in the first organization attempts to access the second server application will be authenticated by the first identity provider under federated authentication. A local user in the first organization accessing the first server application in the first organization will be authenticated by the first identity provider. When the first identity provider determines the guest user belongs to the second organization, the first identity provider delegates authentication function to the second identity provider. If the guest user is authenticated successfully, the second identity provider requests the second authorization provider to create a plurality of authorization claims for the user.

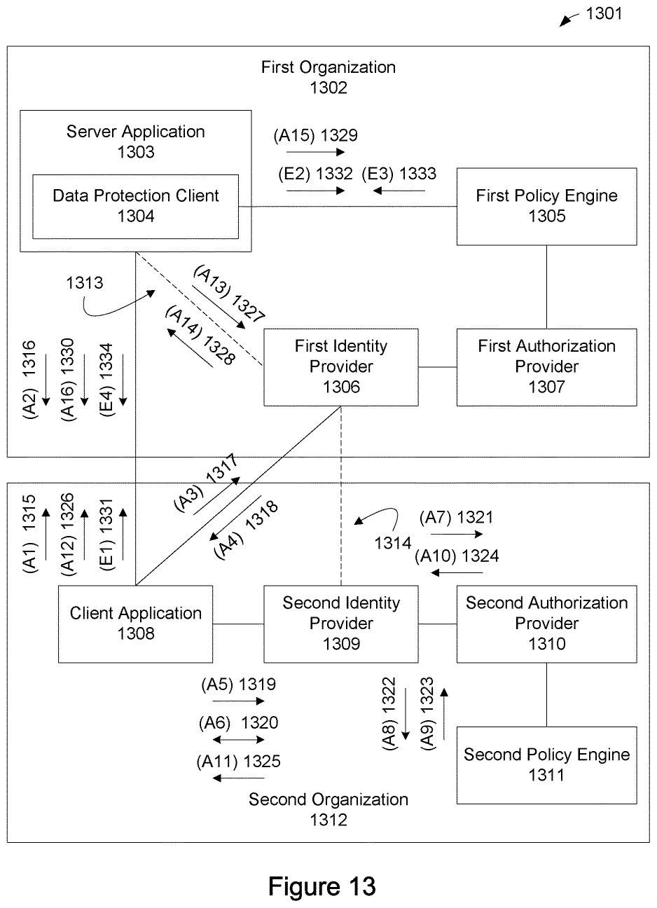

FIG. 13 shows a logic diagram 1301 of a data protection client 1304 protecting access to information or documents on a server application 1303 in a first organization 1302 by enforcing guest policies obtained from a second organization 1312 while authenticating a user from the second organization in federated authentication and authorization arrangements.

Authentication process begins when a user in a second organization 1312 or 1209 accesses a server application 1303 or 1203 in a first organization 1302 or 1202 using a client application 1308. Log on process typically starts with a client application sending an authentication request to a server application.

In step (A1) 1315, at time T1, the user in the second organization attempts to log on to the server application. The client application sends a first authentication request to the server application. If the client application is a web browser, the first authentication request is a HTTP or HTTPS request.

In step (A2) 1316, the server application receives the first authentication request from the client application. The server application and a first identity provider 1306 have an established trust relationship 1313. The server application delegates authentication to the first identity provider.

The server application responds to the first authentication request from the client application. The response comprises a first redirection instruction, redirecting authentication to the first identity provider.

In step (A3) 1317, the client application receives the response to the first authentication request from the server application. The response comprises the first redirection instruction. The client application sends a second authentication request to the first identity provider.

In step (A4) 1318, the first identity provider receives the second authentication request from the client application. The first identity provider determines the user is not a member of the first organization. The first identity provider tries to locate an identity provider that can authenticate the user. Using the information in the second authentication request or a user database maintained by the first identity provider, the first identity provider determines the user belongs to the second organization. The first identity provider confirms that it has a trust relationship 1314 or 1217 with a second identity provider 1309 or 1210 in the second organization.

The first identity provider responds to the second authentication request. The response comprises a first redirection instruction, redirecting authentication to the second identity provider.

In step (A5) 1319, the client application sends a third authentication request to the second identity provider.

In step (A6) 1320, the second identity provider receives the third authentication request from the client application. The second identity provider determines the user belongs to the second organization. The second identity provider attempts to authenticate the user. The authentication process may require additional exchanges between the second identity provider and the client application. The second identity provider and the client application exchange information according to the authentication protocol being used. Examples of authentication protocols include challenge-response protocol, Challenge-Handshake Authentication Protocol (CHAP), Extensible Authentication Protocol (EAP), Remote Authentication Dial-in User Service (RADIUS), Kerberos, or others.

In step (A7) 1321, if the second identity provider successfully authenticated the user, the second identity provider sends an authorization claim request to a second authorization provider 1310 or 1211 in the second organization including user information and optionally resources requested by the user. If the second identity provider fails to authenticate the user, the second identity provider returns an error code to the client application. The client application displays an error message, and the user login has failed.

In step (A8) 1322, the second authorization provider receives the authorization claim request from the second identity provider. The second authorization provider sends a guest policy request to a second policy engine 1311 or 1214 in the second organization including user information and optionally resources requested by the user.

In step (A9) 1323, the second policy engine receives the guest policy request from the second authorization provider. The second policy engine selects a subset of the plurality of authorization claim policies on the second policy engine relevant to the user and resources. The plurality of authorization claim policies is deployed from a second policy server 1215. The second policy engine evaluates the subset of the plurality of authorization claim policies to produce an authorization claim decision.

The second policy engine responds to the guest policy request from the second authorization provider. The response comprises the authorization claim decision.

In step (A10) 1324, the second authorization provider receives the response from the second policy engine. The authorization claim decision comprises a plurality of guest policies relevant to the user or the second organization (or Guest Policies III). The second authorization provider converts (or translates) the authorization claim decision into a plurality of authorization claims. Guest Policies III may be stored in ACPL, XACML, JSON, or other formats. The second authorization provider logs the authorization claim request by sending related information to a log server 808 or 908.

The second authorization provider responds to the authorization claim request from the second identity provider. The response comprises the plurality of authorization claims.

In step (A11) 1325, the second identity provider receives the response to the authorization claim request from the second authorization provider. The second identity provider creates an identity assertion 601 comprising a plurality of authentication claims, the plurality of authorization claims and a cryptographic signature. The identity assertion is digitally signed. The plurality of authentication claims provides information about the user. Examples of authentication claims include user name, title, organizations, departments, intended audience, authentication request time, identity assertion expiration time, or others.

The second identity provider responds to the third authentication request from the client application. The response comprises the identity assertion and a third redirection instruction, redirecting authentication request to the server application.

In step (A12) 1326, the client application receives the responses to the third authentication request from the second identity provider. The client application sends a fourth authentication request to the server application with the identity assertion.

In SAML implementation, the server application validates the identity assertion. If validation is successful, the authentication process completes successfully. SAML does not require steps (A13) and (A14), continue with step (A15).

In OIDC implementation, the identity assertion is validated in a redemption step. Redemption is covered in steps (A13) and (A14).

In step (A13) 1327, the server application sends a redemption request with the identity assertion to the first identity provider.

In step (A14) 1328, the first identity provider receives the redemption request. The first identity provider validates the redemption request. If validation is successful, the first identity provider responds with additional authentication claims and optionally with authorization claims. If validation fails, the first identity provider returns an error.

In step (A15) 1329, if the identity assertion is validated successfully, the server application extracts information from the plurality of authentication claims and the plurality of authorization claims in the identity assertion. The extracted information comprises Guest Policies III. The server application sends Guest Policies III to a data protection client 1304 or 1204. The data protection client sends Guest Policies III to a first policy engine 1305 or 1205. Guest Policies III will be used to make policy decisions on access and use of information or documents on the server application by the user.

In step (A16) 1330, the server application responds to the fourth authentication request from the client application. If the identity assertion is validated successfully, the server application uses the extracted information to construct a landing page for the user. A landing page is the first page displayed after a user logs on to a server application. A landing page is often called a user's home page in a web application. The response comprises the landing page. The client application displays the landing page.

If the identity assertion is not validated successfully, the response comprises an error code indicating authentication has failed. The client application displays an error message.

In an implementation, the first identity provider and the second identity provider establish trust using a certificate. The second identity provider encrypts the identity assertion using its private key and the first identity provider validates the identity assertion by decrypting the identity assertion using the second identity provider's public key.

In another implementation, the first identity provider and the second identity provider establish trust using an application program interface (API) token.

In an implementation, the identity assertion includes a cryptographic signature of its content, and the server application validates the identity assertion using the cryptographic signature.

After the user from the second organization 1312 successfully logs on to the server application 1303 in the first organization 1302, the user clicks on a link to a document on the landing page. The data protection client 1304 on the server application intercepts (or detects) the operation. The data protection client enforces the plurality of policies and Guest Policies III on the first policy engine 1305 in the first organization on the operation.

In step (E1) 1331, at time T2, the landing page is displayed on the client application. The user clicks on a link to a document on the landing page. The client application sends an open request to the server application to open the document. The open request comprises information on the document. Examples of information on the document include document identifier, file name, file path, file attribute, host name, or others. If the open request is a HTTPS GET request, the document is specified in an URL.

In step (E2) 1332, the server application receives the open request from the client application. The server application attempts to open the document. The data protection client intercepts (or detects) the open operation. The data protection client collects (or gathers) contextual information related to the open operation, user and document. Examples of contextual information include open operation, file name, file path, file attribute, application program name, host name, operating system, security setting, user name, user identifier, user attribute, location, time, or others.

The data protection client sends a policy decision request to the first policy engine with the contextual information.

In step (E3) 1333, the first policy engine receives the policy decision request from the data protection client. The first policy engine selects a subset of the plurality of policies on the first policy engine relevant to the user and the document (or Local Policies I) and Guest Policies III. The plurality of policies on the first policy engine is obtained from a first policy server 1206. The first policy engine evaluates the selected policies to produce a policy decision. The policy decision determines if the user is allowed to open the document.

In an implementation, the first policy engine evaluates Local Polices I and Guest Policies III together to produce a policy decision.

In another implementation, the first policy engine evaluates Local Policies I and Guest Policies III separately and combines the results to produce a policy decision.

In yet another implementation, the first policy engine evaluates Local Policies I to produce a first decision. If the first decision is allow, the first policy engine evaluates Guest Policies III to produce a second decision. If the first decision and the second decision are allow, policy decision is allow. Otherwise, policy decision is deny.

In yet another implementation, the first policy engine evaluates Guest Policies III to produce a first decision. If the first decision is allow, the first policy engine evaluates Local Policies I to produce a second decision. If the first decision and the second decision are allow, policy decision is allow. Otherwise, policy decision is deny.

The first policy engine responds to the policy decision request from the data protection client. The response comprises the policy decision.

In step (E4) 1334, the data protection client receives the response to the policy decision request from the first policy engine. The response comprises the policy decision. If the policy decision is allow, the data protection client allows the open operation and the document opens successfully. If the policy decision is deny, the data protection client denies the open operation and the document fails to open.

The server application responds to the open request from the client application. If the policy decision is allow, the response comprises the document. The client application displays the document.

If the policy decision is deny, the response comprises an error code indicating the server application failed to open the document. The client application displays an error message.

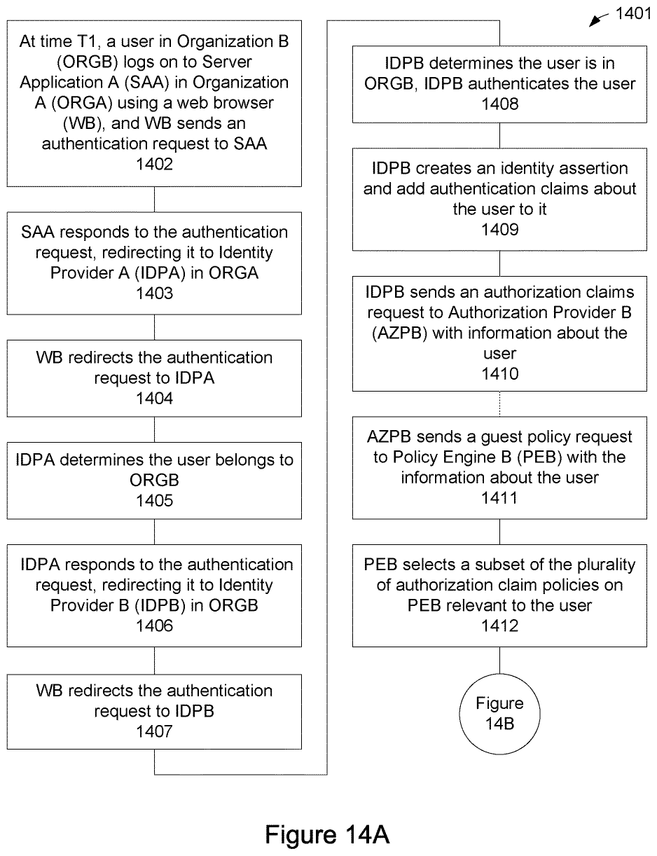

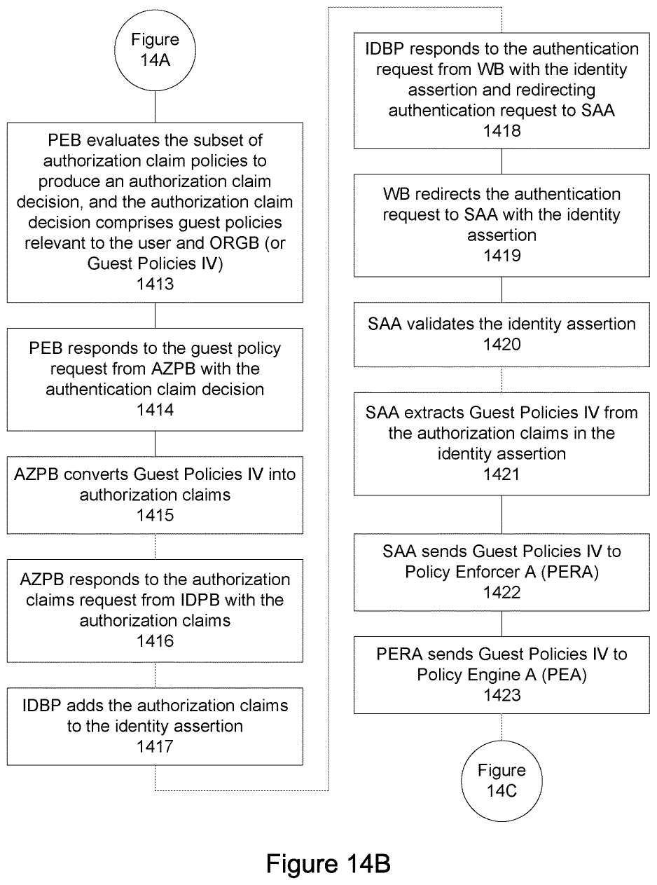

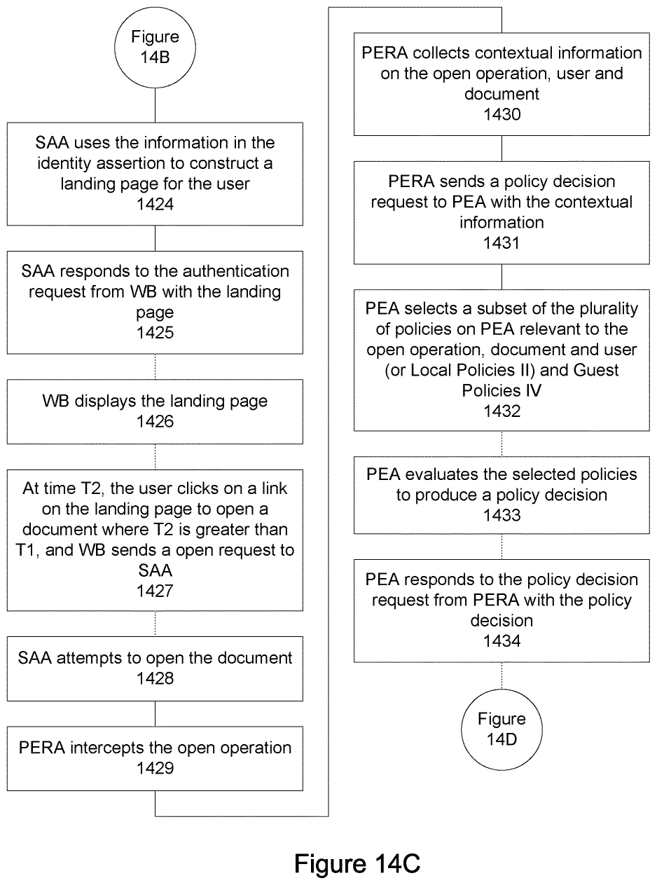

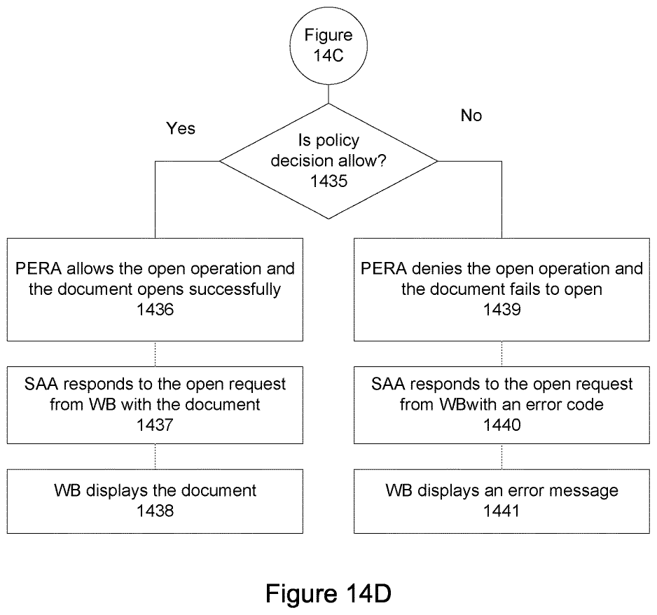

Referring to FIGS. 14A-14D, a flow diagram 1401 shows enforcement of guest policies from a second organization 1312 on access to a document on a server application 1303 in a first organization 1302.

In step 1402, at time T1, a user in Organization B (ORGB) 1209 or 1312 logs on to Server Application A (SAA) 1203 or 1303 in Organization A (ORGA) 1202 or 1302 using a web browser (WB) 1308. WB sends an authentication request to SAA. The authentication request is a HTTPS request.

In step 1403, SAA receives the authentication request from WB. Since Identity Provider A (IDPA) 1207 or 1306 in ORGA handles authentication for SAA, SAA redirects the authentication request to IDPA. SAA responds to the authentication request from WB. The response comprises a first redirection instruction, redirecting authentication to IDPA.

In step 1404, WB receives the response to the authentication request from SAA. The response composes the first redirection instruction. WB redirects the authentication request to IDPA.

In step 1405, IDPA receives the authentication request from WB. IDPA determines the user belongs to ORGB. IDPA confirms it has a trust relationship 1217 or 1314 with Identity Provider B (IDPB) 1210 or 1309 in ORGB.

In step 1406, IDPA responds to the authentication request from WB. The response comprises a second redirection instruction, redirecting the authentication request to IDPB.

In step 1407, WB receives the response to the authentication request from IDPA. The response composes the second redirection instruction. WB redirects the authentication request to IDPB.

In step 1408, IDPB receives the authentication request from WB. IDPB determines the user is in ORGB. IDPB authenticates the user.

In step 1409, if authentication is successful, IDPB creates an identity assertion. IDPB adds a plurality of authentication claims bearing information about the user to the identity assertion.

In step 1410, IDPB sends an authorization claim request to Authorization Provider B (AZPB) 1211 or 1310 with information about the user.

In step 1411, AZPB receives the authorization claim request from IDPB. AZPB sends a guest policy request to Policy Engine B (PEB) 1214 or 1311 with the information about the user.

In step 1412, PEB receives the guest policy request from AZPB. PEB selects a subset of the plurality of authorization claim policies on PEB relevant to the user.

In step 1413, PEB evaluates the subset of the plurality of authorization claim policies to produce an authorization claim decision.

In an implementation, the authorization claim decision comprises a plurality of guest policies relevant to the user and ORGB (or Guest Policies IV).

In another implementation, the authorization claim decision comprises instructions to produce guest policies relevant to the user and ORGB.

In yet another implementation, the authorization claim decision comprises an identifier. AZPB retrieves a plurality of guest policies based on the identifier. Examples of an identifier include name, Universal Unique Identifier (UUID), index, hash, or others.

In yet another implementation, the authorization claim decision comprises roles, access or usage permissions, rights, user attributes, resource identifiers, resource attributes, guest policies, any combinations thereof, or others.

In step 1414, PEB responds to the guest policy request from AZPB. The response comprises the authorization claim decision.

In step 1415, AZPB receives the response to the guest policy request from PEB. AZPB converts (or translates) Guest Policies IV into a plurality of authorization claims.

In step 1416, AZPB responds to the authorization claim request from IDPB. The response comprises the plurality of authorization claims.

In step 1417, IDPB receives the response to the authorization claim request from IDPB. IDPB adds the plurality of authorization claims to the identity assertion.

In step 1418, IDPB responds to the authentication request from WB. The response comprises the identity assertion and a second redirection instruction, redirecting the authentication request to SAA.

In step 1419, WB receives the response to the redirected authentication request from IDPB. WB redirects the authentication request to SAA with the identity assertion.

In step 1420, SAA receives the authentication request from WB with the identity assertion. SAA validates the identity assertion.

In step 1421, SAA extracts Guest Policies IV from the plurality of authorization claims in the identity assertion.

In step 1422, SAA sends Guest Policies IV to Policy Enforcer A (PERA) 1204 or 1304.

In step 1423, PERA receives Guest Policies IV from SAA. PERA sends Guest Policies IV to Policy Engine A (PEA) 1205 or 1305.

In step 1424, SAA uses the information in the identity assertion to construct a landing page for the user. A landing page is the first page displayed after a user logs on to a server application. A landing page is often called a user's home page in a web application.

In step 1425, SAA responds to the redirected authentication request from WB. The response comprises the landing page.

In step 1426, WB receives the response to the redirected authentication request from SAA. WB displays the landing page.

In step 1427, at time T2, the user clicks on a link on the landing page to open a document where T2 is greater than T1. WB 1308 sends an open request to SAA 1203 or 1303 to open the document. The open request comprises information on the document. Examples of information on the document include document identifier, file name, file path, file attribute, host name, or others. If the open request is a HTTP GET request, the document is specified in an URL.

In step 1428, SAA receives the open request from WB. SAA attempts to open the document.

In step 1429, PERA 1204 or 1304 intercepts (or detects) the open operation.

In step 1430, PERA collects (or gathers) contextual information on the open operation, user and document. Examples of contextual information include open operation, user name, user identifier, user attribute, file name, file path, file attribute, application program name, host name, operating system, security setting, location, time, or others.

In step 1431, PERA sends a policy decision request to PEA 1205 or 1305 with the contextual information.

In step 1432, PEA selects a subset of the plurality of policies on PEA relevant to the open operation, document and user (or Local Policies II) and Guest Policies IV. The plurality of policies on PEA is obtained from Policy Server A 1206.

In step 1433, PEA evaluates the selected policies to produce a policy decision. The policy decision determines if the user is allowed to open the document.

In an implementation, PEA evaluates Local Policies II and Guest Policies IV together to produce a policy decision.

In another implementation, PEA evaluates Local Policies II and Guest Policies IV separately and combines the results to produce a policy decision.

In yet another implementation, PEA evaluates Local Policies II to produce a first decision. If the first decision is allow, PEA evaluates Guest Policies IV to produce a second decision. If the first decision and the second decision are allow, policy decision is allow. Otherwise, policy decision is deny.

In yet another implementation, PEA evaluates Guest Policies IV to produce a first decision. If the first decision is allow, PEA evaluates Local Policies II to produce a second decision. If the first decision and the second decision are allow, policy decision is allow. Otherwise, policy decision is deny.

In step 1434, PEA responds to the policy decision request from PERA. The response comprises the policy decision.

In step 1436, PERA receives the response to the policy decision request from PEA. The response comprises the policy decision. If the policy decision is allow, PERA allows the open operation and the document opens successfully.

In step 1437, if the policy decision is allow, SAA responds to the open request from WB with the document.

In step 1438, if the policy decision is allow, WB receives the response to the open request. WB displays the document.

In step 1439, if the policy decision is deny, PERA denies the open operation and the document fails to open.

In step 1440, if the policy decision is deny, SAA responds to the open request from WB with an error code indicating SAA failed to open the document.

In step 1441, if the policy decision is deny, WB displays an error message.

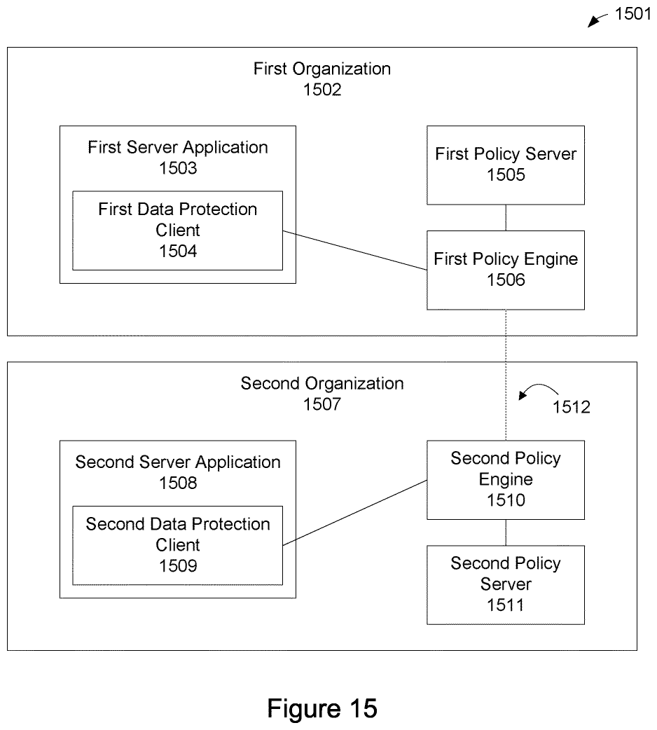

FIG. 15 shows a functional block diagram 1501 of cooperative policy enforcement across two organizations 1502 and 1507 with policy engines 1506 and 1510 in a peer-to-peer arrangement. In this example, the two organizations share the same information management system architecture, both: (a) use data protection clients 1504 and 1509 to protect information or documents on or accessible from server applications 1503 and 1508; (b) implement one or more types of policies described above; and (c) use policy engines 1506 and 1510 to make policy decisions for data protection clients. Examples of server applications include web servers, Enterprise Resource Management (ERP) applications, Product Lifecycle Management (PLM) applications, collaborative platforms, analytical and reporting applications, source code control applications, application servers, or many others.

In a first organization 1502, a first data protection client 1504 controls access to information or documents on or accessible from a first server application 1503 based on policies deployed to a first policy engine 1506 from a first policy server 1505.

When a user in the first organization accesses information or a document on the first server application, the first data protection client intercepts or detects an operation (e.g., open a document, open a web page, or send a database query to a database) by the first server application on the information or document. The first data protection client sends a policy decision request to the first policy engine with information about the operation, user and information or document. The first policy engine selects a subset of the first plurality of policies on the first policy engine relevant to the operation, user and information or document. The first policy engine evaluates the subset of the first plurality of policies to produce a policy decision. The policy decision comprises allow or deny, and optionally a plurality of obligations. Obligations are tasks to be carried out by the first policy engine or the first data protection client. If the policy decision is allow, the first server application opens the information or document successfully. If the policy decision is deny, the first server application fails to open the information or document.

In a second organization 1507, a second data protection client 1509 controls access to information or documents on or accessible from a second server application 1508 based on policies deployed to a second policy engine 1510 from a second policy server 1511.

When a user in the second organization accesses information or a document on the second application server, the second data protection client intercepts or detects an operation (e.g., open a document, open a web page, or send a database query to a database) by the second server application on the information or document. The second data protection client sends a policy decision request to the second policy engine with information about the operation, user and information or document. The second policy engine selects a subset of the second plurality of policies on the second policy engine relevant to the operation, user and information or document. The second policy engine evaluates the subset of the second plurality of policies to produce a policy decision. The policy decision comprises allow or deny, and optionally a plurality of obligations. Obligations are tasks to be carried out by the second policy engine or the second data protection client. If the policy decision is allow, the second server application opens the information or document successfully. If the policy decision is deny, the second server application fails to open the information or document.

A first policy engine 1506 has an established trust relationship 1512 with a second policy engine 1510. Trust relationships may be established with certificates, application program interface (API) tokens, pins, or other methods. In an example, the first policy engine establishes a trust relationship with the second policy engine by providing a digital certificate to the second policy engine, thereby the second policy engine may use a public key in the digital certificate to encrypt or decrypt data sent to or received from the first policy engine.

When a user in the second organization 1507 accesses information or a document on the first server application 1503 in the first organization 1502, the first data protection client 1504 intercepts or detects an operation (e.g., open a document, open a web page, or send a database query to a database) by the first server application on the information or document. The first data protection client sends a policy decision request to the first policy engine 1506 with information about the operation, user and information or document.

The first policy engine determines the user belongs to the second organization. The first policy engine confirms that it has a trust relationship 1512 with the second policy engine and decisions may be made in cooperation with the second policy engine. Therefore, the operation shall be allowed or denied based on the policies of both the first organization and the second organization.

The first policy engine selects a subset of the first plurality of policies on the first policy engine relevant to the operation, second organization and information or document. The first policy engine evaluates the subset of the first plurality of policies to produce a first decision. The first decision comprises allow or deny, and optionally a plurality of obligations. If the first decision is allow, the first policy engine proceeds to check if the user is allowed to open the information or document according to the policies of the second organization. If the first decision is deny, the first data protection client denies the operation to open the information or document.

In an implementation, the first policy engine sends a guest policy request to the second policy engine with information on the operation, user and information or document. The second policy engine selects a subset of the second plurality of policies on the second policy engine relevant to the operation, user and information or document (or Guest Policies V). The second policy engine returns Guest Policies V to the first policy engine. Guest Policies V controls access to the information or document in the first organization by the user. The first policy engine evaluates Guest Policies V to produce a second decision. If the first decision and the second decision are allow, policy decision is allow. Otherwise, policy decision is deny. If the policy decision is allow, the first data protection client allows the operation, and first server application opens the information or document successfully. If the policy decision is deny, the first data protection client denies the operation, and the first server application fails to open the information or document.

In another implementation, the first policy engine sends a guest policy request to the second policy engine with information on the user. The second policy engine selects a subset of the second plurality of policies on the second policy engine relevant to the user (or Guest Policies VI) and returns Guest Policies VI to the first policy engine. Guest Policies VI controls access to information or documents in the first organization by the user in the second organization. The first policy engine stores Guest Policies VI. The first policy engine shall use Guest Policies VI to make decisions on subsequent access to the information or documents by the user. The first policy engine evaluates Guest Policies VI to produce a third decision. The third decision comprises allow or deny, and optionally a plurality of obligations. If the third decision is allow, the first server application opens the information or document successfully. If the third decision is deny, the first server application fails to open the information or document.

In yet another implementation, the first policy engine sends a policy decision request to the second policy engine with the operation, user and information or document to produce a fourth decision. The fourth decision comprises allow or deny, and optionally a plurality of obligations. If the fourth decision is allow, the first server application opens the information or document successfully. If the fourth decision is deny, the first server application fails to open the information or document.

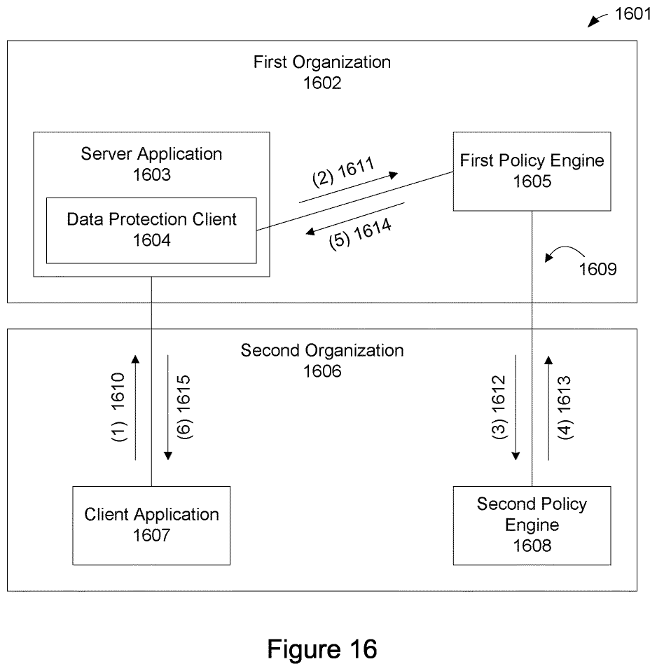

FIG. 16 shows a logic diagram 1601 of a server application 1603 in a first organization 1602 enforcing policies with a data protection client 1604 on access to information or documents by a user in a second organization 1606 where policy engines 1605 and 1608 in the two organizations collaborate in making policy decisions.

Authorization process begins when a user in the second organization 1507 or 1606 accesses the server application 1503 or 1603 in the first organization 1502 or 1602 using a client application 1607. Examples of client applications include web browsers, Microsoft Windows® Explorer, Microsoft Word®, Adobe Reader®, Linux applications, or many others.

In step (1) 1610, the user in the second organization opens a document on or accessible from the server application in the first organization using the client application. The client application sends a first open request to the server application.

In step (2) 1611, the server application receives the first open request from the client application. In the process of constructing a response, the server application opens the document. A data protection client 1504 or 1604 intercepts or detects the file open operation. The data protection client collects or gathers contextual information on the operation, user and document. Examples of contextual information include open operation, user name, user identifier, user attribute, file name, file path, file attribute, application program name, host name, operating system, security setting, location, time, or others.

The data protection client sends a policy decision request to a first policy engine 1506 or 1605 with the contextual information.

In step (3) 1612, the first policy engine receives the policy decision request from the data protection client. The first policy engine determines the user belongs to the second organization. The first policy engine confirms that it has a trust relationship 1512 or 1609 with a second policy engine 1510 or 1608 and policy decisions may be made in cooperation with the second policy engine.

The first policy engine selects a subset of the first plurality of policies on the first policy engine relevant to the file open operation, second organization and document. The first plurality of policies is deployed from a first policy server 1505. The first policy engine evaluates the subset of the first plurality of policies to produce a first decision. The first decision comprises allow or deny, and optionally a plurality of obligations. Obligations are tasks to be carried out by the first policy engine or the data protection client. If the first decision is allow, the first policy engine sends a guest policy request to the second policy engine with information on the user. If the first decision is deny, the data protection client denies access to the document by the server application.

In step (4) 1613, the second policy engine receives a guest policy request from the first policy engine. The second policy engine selects a subset of the second plurality of policies on the second policy engine relevant to the user (or Guest Policies VII). The second policy engine responds to the guest policy request from the first policy engine. The response comprises Guest Policies VII.

In step (5) 1614, the first policy engine receives the response from the second policy engine. The response comprises Guest Policies VII. The first policy engine stores Guest Policies VII locally. The first policy engine will use Guest Policies VII to make decisions on subsequent access to information or documents by the user. Guest Policies VII controls access to information or documents in the first organization by the user.

The first policy engine evaluates Guest Policies VII to produce a second decision. The second decision comprises allow or deny, and optionally a plurality of obligations.

The first policy engine responds to the policy decision request from the data protection client. The response comprises the second decision.

In step (6) 1615, the data protection client receives the response to the policy decision request. The response comprises the second decision. If the second decision is allow, the data protection client allows the file open operation. The server application opens the document successfully. The server application responds to the open request with the document. The client application displays the document.

If the second decision is deny, the data protection client denies the file open operation. The server application fails to open the document. The server application responds to the open request with an error code. The client application displays an error message.

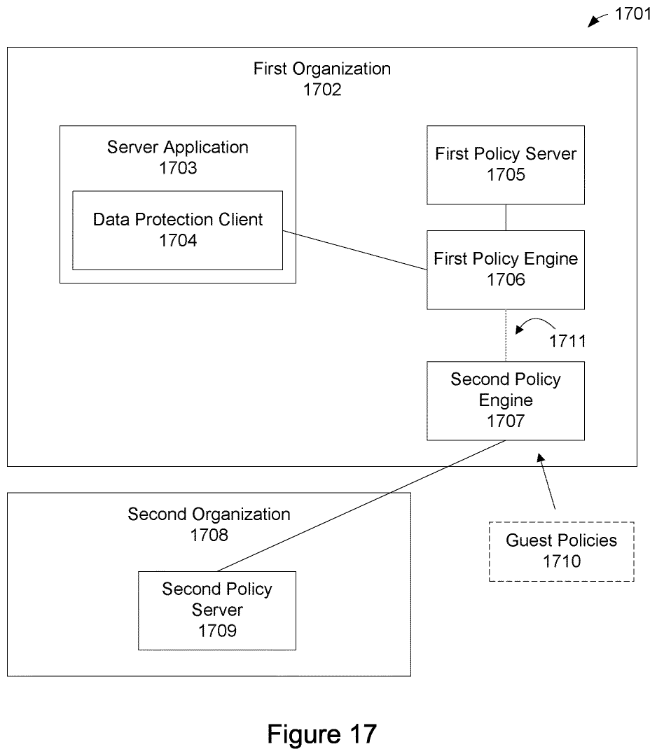

FIG. 17 shows a functional block diagram 1701 of cooperative policy enforcement across two organizations 1702 and 1708 with policy engines 1706 and 1707 co-location.

In this example, the two organizations are working together on a project that requires shared access to a particular set of information or documents stored in the first organization. Instead of having the first organization manages users in the second organization on access to the particular set of information or documents, the two organizations decided to set up federated authentication and federated authorization. Federating authentication across the two organizations allows the first organization to trust authentication took place in the second organization, thereby the first organization does not need to authenticate users in the second organization. Federating authorization across the two organizations allows the second organization to manage fine-grained access to the particular set of information or documents by the users in the second organization. The first organization only needs to set up a sandbox to ensure users in the second organization only have access to the particular set of information or documents.

To implement this working model, a plurality of policies is deployed from a first policy server 1705 to a first policy engine 1706 in the first organization 1702. The first plurality of policies comprises policies that restrict users in the second organization 1708 access to the particular set of information or documents. In addition, a plurality of guest policies is deployed from a second policy server 1709 in the second organization 1708 to a second policy engine 1707 hosted in the first organization. In another word, the first policy engine and the second policy engine are co-located in the first organization. While the second policy engine evaluates policies deployed from the second organization and applies to users in the second organization, the second policy engine is located close to the first policy engine.

Co-locating policy engines provides more predictable policy decision performance. Performance aside, this deployment model offers the same functionalities as that described under FIG. 15.

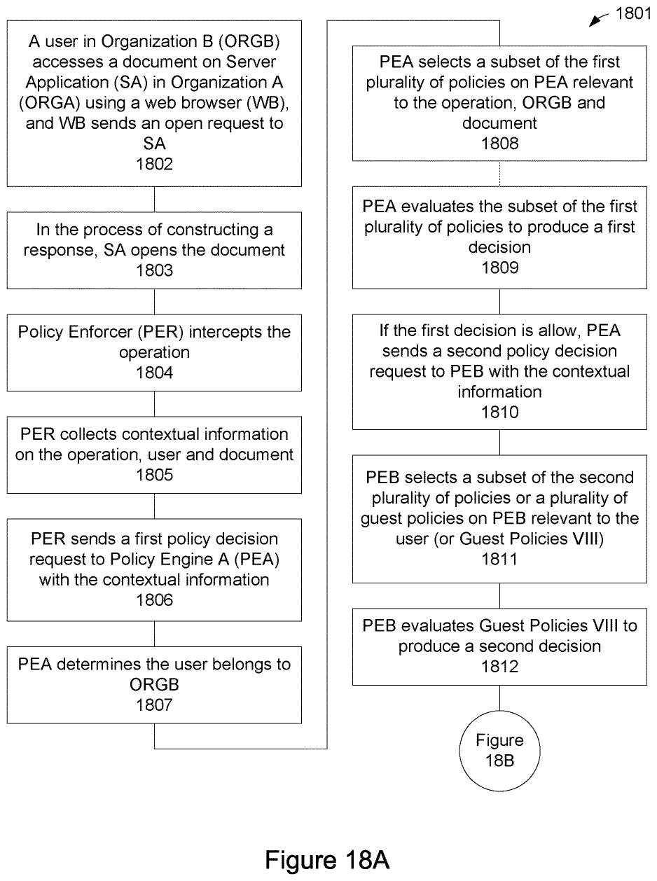

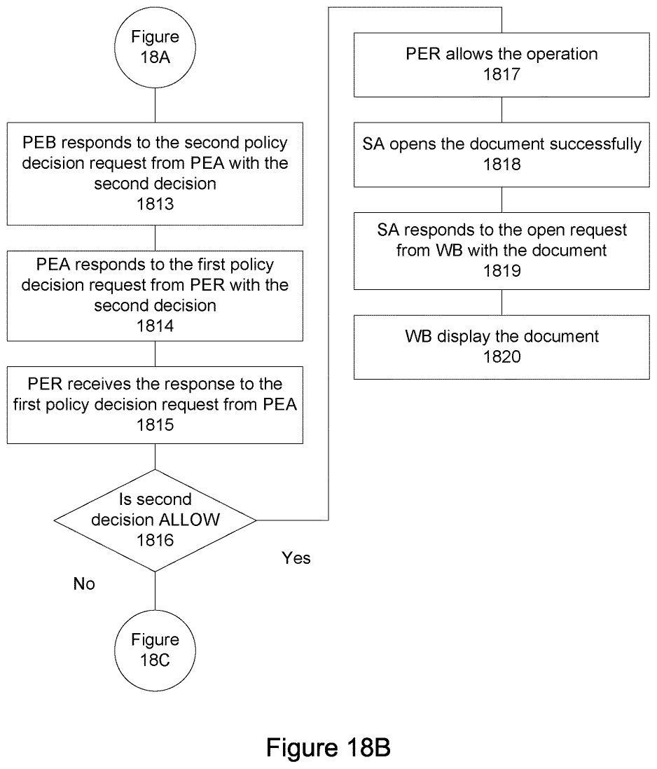

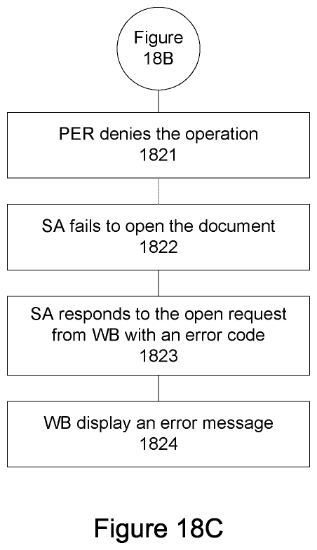

Referring to FIGS. 18A-18C, a flow diagram 1801 shows cooperative policy enforcement on access to a document on a server application 1503 or 1703 in a first organization 1502 or 1702 by a user from a second organization 1507 or 1708 where the two organizations collaborate in making access or use control decisions.

In step 1802, a user in Organization B (ORGB) 1507 or 1708 accesses a document on Server Application (SA) 1503 or 1703 in Organization A (ORGA) 1502 or 1702 using a web browser (WB) 1607. WB sends an open request to SA. The open request comprises information on the document. Examples of information on the document include document identifier, file name, file path, file attribute, host name, or others. If the open request is a HTTP GET request, the document is specified in an URL.

In step 1803, SA receives the open request from WB. In the process of constructing a response, SA opens the document.

In step 1804, Policy Enforcer (PER) 1504 or 1704 intercepts the operation opening the document.

In step 1805, PER collects contextual information on the operation, user and document. Examples of contextual information include open operation, user name, user identifier, user attribute, file name, file path, file attribute, application program name, host name, operating system, security setting, location, time, or others.

In step 1806, PER sends a first policy decision request to Policy Engine A (PEA) 1506 or 1706 with the contextual information.

In step 1807, PEA receives the first policy decision request from PER. PEA determines the user belongs to ORGB. PEA confirms that it has a trust relationship 1512 or 1711 with Policy Engine B (PEB) 1510 or 1707 and policy decisions may be made in cooperation with PEB.

In step 1808, PEA selects a subset of the first plurality of policies on PEA relevant to the operation, ORGB and document. The first plurality of policies on PEA is deployed from Policy Server A 1505 or 1705.

In step 1809, PEA evaluates the subset of the first plurality of policies to produce a first decision. The first decision comprises allow or deny, and optionally a plurality of obligations.

In step 1810, if the first decision is allow, PEA sends a second policy decision request to PEB with the contextual information.

In step 1811, if the first decision is allow, PEB receives the second policy decision request from PEA. PEB selects a subset of the second plurality of policies or a plurality of guest policies on PEB relevant to the user (or Guest Policies VIII). The second plurality of policies or the plurality of guest policies on PEB is deployed from Policy Server B 1511 or 1709. Guest Policies VIII controls access by the user to information or documents in ORGA.

In step 1812, if the first decision is allow, PEB evaluates Guest Policies VIII to produce a second decision. The second decision comprises allow or deny, and optionally a plurality of obligations.

In step 1813, if the first decision is allow, PEB responds to the second policy decision request from PEA The response comprises the second decision.

In step 1814, if the first decision is allow, PEA receives the response to the second policy decision request from PEB. The response comprises the second decision. PEA responds to the first policy decision request from PER. The response comprises the second decision.

In step 1815, if the first decision is allow, PER receives the response to the first policy decision request from PEA.

In step 1817, if the second decision is allow, PER allows the operation.

In step 1818, if the second decision is allow, SA opens the document successfully.

In step 1819, if the second decision is allow, SA responds to the open request from WB. The response comprises the document.

In step 1820, if the second decision is allow, WB receives the response to the open request from SA. The response comprises the document. WB displays the document.

In step 1821, if the second decision is deny, PER denies the operation.

In step 1822, if the second decision is deny, SA fails to open the document.

In step 1823, if the second decision is deny, SA responds to the open request from WB with an error code indicating that the document failed to open.

In step 1824, if the second decision is deny, WB receives the response to the open request from SA. WB displays an error message.

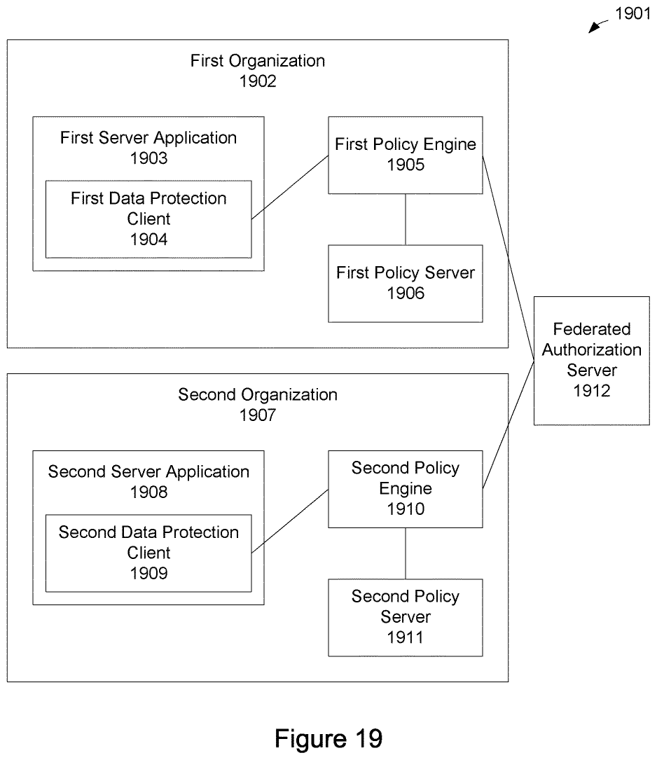

FIG. 19 shows a functional block diagram 1901 of cooperative policy enforcement across two organizations 1902 and 1907 with policy engines 1905 and 1910 connected through a federated authorization server 1912. In this example, the two organizations share the same information management system architecture, both: (a) use data protection clients 1904 and 1909 to protect information or documents on or accessible from server applications 1903 and 1908; (b) implement one or more types of policies described above; (c) use policy engines 1905 and 1910 to make policy decisions for data protection clients, and (d) policy engines subscribe to federated authorization services 1912. Examples of server applications include web servers, Enterprise Resource Management (ERP) applications, Product Lifecycle Management (PLM) applications, collaborative platforms, analytical and reporting applications, source code control applications, application servers, or many others.

Policy engines 1905 and 1910 subscribe to federated authorization services provided by a federated authorization server 1912. Federated authorization servers offer discovery, routing, or other services to the participating policy engines. A policy engine may use a discovery service to locate another policy engine within an organization or in another organization. A federated authorization server can route requests between any pair of participating police engines.

A policy engine subscribing to federated authorization services may establish a trust relationship with another policy engine in participation. Trust relationships may be established with certificates, application program interface (API) tokens, pins, or other methods. In an example, a first policy engine 1905 establishes a trust relationship with a second policy engine 1910 by providing a digital certificate to the second policy engine. The second policy engine may use a public key in the digital certificate to encrypt or decrypt data sent to or received from the first policy engine. A policy engine may request guest policies from a trusted policy engine. A policy engine may delegate policy decisions to a trusted policy engine.

In a first organization 1902, a first data protection client 1904 controls access to information or documents on or accessible from a first server application 1903 based on policies deployed to a first policy engine 1905 from a first policy server 1906.

When a user in the first organization accesses information or a document on the first server application, the first data protection client intercepts or detects an operation (e.g., open a document, open a web page, or send a database query to a database) by the first server application on the information or document. The first data protection client sends a policy decision request to the first policy engine with information about the operation, user and information or document. The first policy engine selects a subset of the first plurality of policies on the first policy engine relevant to the operation, user and information or document. The first policy engine evaluates the subset of the first plurality of policies to produce a policy decision. The policy decision comprises allow or deny, and optionally a plurality of obligations. Obligations are tasks to be carried out by the first policy engine or the first data protection client. If the decision is allow, the first server application opens the information or document successfully. If the policy decision is deny, the first server application fails to open the information or document.

In a second organization 1907, a second data protection client 1909 controls access to information or documents on or accessible from a second server application 1908 based on policies deployed to a second policy engine 1910 from a second policy server 1911.

When a user in the second organization accesses information or a document on the second server application, the second data protection client intercepts or detects an operation (e.g., open a document, open a web page, or send a database query to a database) by the second server application on the information or document. The second data protection client sends a policy decision request to the second policy engine with information about the operation, user and information or document. The second policy engine selects a subset of the second plurality of policies on the second policy engine relevant to the operation, user and information or document. The second policy engine evaluates the subset of the second plurality of policies to produce a policy decision. The policy decision comprises allow or deny, and optionally a plurality of obligations. Obligations are tasks to be carried out by the second policy engine or the second data protection client. If the policy decision is allow, the second server application opens the information or document successfully. If the policy decision is deny, the second server application fails to open the information or document.

Federated authorization server 1912 routes requests between a first policy engine 1905 and a second policy engine 1910. To allow users in the second organization access to information or documents on or accessible from the first server application in the first organization, a trust relationship is established between the first policy engine and the second policy engine. With the trust relationship, the first policy engine may delegate authorizing access by a user in the second organization to information or documents in the first organization to the second policy engine. The first policy engine may request guest policies on a user in the second organization on access to information or documents in the first organization from the second policy engine. Similarly, the second policy engine may delegate authorizing access by a user in the first organization to information or documents in the second organization to the first policy engine. The second policy engine may request guest policies on a user in the first organization on access to information or documents in the second organization from the first policy engine.

When a user in the second organization 1907 accesses information or a document on the first server application 1903 in the first organization 1902, the first data protection client 1904 intercepts or detects an operation (e.g., open a document, open a web page, or send a database query to a database) by the first server application on the information or document. The first data protection client sends a policy decision request to the first policy engine 1905 with information about the operation, user and information or document.

The first policy engine determines the user belongs to the second organization. The first policy engine confirms that it has a trust relationship with the second policy engine and decisions may be made in cooperation with the second policy engine. Therefore, the operation shall be allowed or denied based on the policies of both the first organization and the second organization.

The first policy engine selects a subset of the first plurality of policies on the first policy engine relevant to the operation, second organization and information or document. The first policy engine evaluates the subset of the first plurality of policies to produce a first decision. The first decision comprises allow or deny, and optionally a plurality of obligations. If the first decision is allow, the first policy engine proceeds to check if the user is allowed to open the information or document according to the policies of the second organization. If the first decision is deny, the first data protection client denies the operation to open the information or document.

In an implementation, the first policy engine sends a guest policy request addressed to the second policy engine to the federated authorization server 1912 with information on the user and information or document. The federated authorization server routes the guest policy request to the second policy engine. The second policy engine selects a subset of the second plurality of policies on the second policy engine relevant to the operation, user and information or document (or Guest Policies IX). The second policy engine returns Guest Policies IX to the first policy engine. Guest Policies IX controls access to the information or document in the first organization by the user. The first policy engine evaluates Guest Policies IX to produce a second decision. The second decision comprises allow or deny, and optionally a plurality of obligations. If the second decision is allow, the first server application opens the information or document successfully. If the second decision is deny, the first server application fails to open the information or document.

In another implementation, the first policy engine sends a guest policy request addressed to the second policy engine to the federated authorization server 1912 with information on the user. The federated authorization server routes the policy decision request to the second policy engine. The second policy engine selects a subset of the second plurality of policies on the second policy engine relevant to the user (or Guest Policies X) and returns Guest Policies X to the first policy engine. Guest Policies X controls access to information or documents in the first organization by the user in the second organization. The first policy engine stores Guest Policies X. The first policy engine shall use Guest Policies X to make decisions on subsequent access to information or documents by the user. The first policy engine evaluates Guest Policies X to produce a third decision. The third decision comprises allow or deny, and optionally a plurality of obligations. If the third decision is allow, the first server application opens the information or document successfully. If the third decision is deny, the first server application fails to open the information or document.

In yet another implementation, the first policy engine sends a policy decision request addressed to the second policy engine to the federated authorization server 1912 with the user and information or document. The federated authorization server routes the policy evaluation request to the second policy engine. The second policy engine selects a subset of the second plurality of policies on the second policy engine relevant to the operation, user and information or document. The second policy engine evaluates the subset of the second plurality of policies to produce a fourth decision. The fourth decision comprises allow or deny, and optionally a plurality of obligations. If the fourth decision is allow, the first server application opens the information or document successfully. If the fourth decision is deny, the first server application fails to open the information or document.

In yet another implementation, the first policy engine sends a policy decision request to the second policy engine with the operation, user and information or document to produce a fourth decision. The fourth decision comprises allow or deny, and optionally a plurality of obligations. If the fourth decision is allow, the first server application opens the information or document successfully. If the fourth decision is deny, the first server application fails to open the information or document.

The above discussion covers exchanges between two policies engines, however, the policy engine functions that handle federated authorization may be separated into different code modules. For those skilled in the art shall recognize that there are many ways to realize the same functionalities described above.

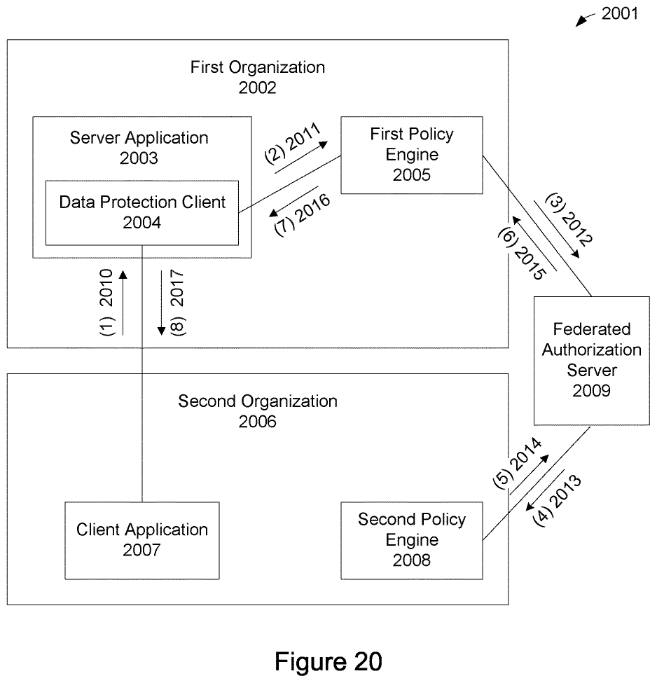

FIG. 20 shows a logic diagram 2001 of a server application 2003 in a first organization 2002 enforcing policies with a data protection client 2004 on access to information or documents by a user from a second organization 2006 where policy engines in the two organizations make policy decisions jointly while communicating through a federated authorization server 2009.

Authorization process begins when a user in the second organization 1907 or 2006 accesses the server application 1903 or 2003 in the first organization 1902 or 2002 using a client application 2007. Examples of client applications include web browsers, Microsoft Windows® Explorer, Microsoft Word®, Adobe Reader®, Linux applications, or many others.

In step (1) 2010, the user in the second organization accesses a document on or accessible from the server application in a first organization using the client application. The client application sends an open request to the server application.

In step (2) 2011, the server application receives the open request from the client application. In the process of constructing a response, the server application opens the document. A data protection client 1904 or 2004 intercepts or detects the operation. The data protection client collects or gathers contextual information on the operation, user and document. Examples of contextual information include open operation, user name, user identifier, user attribute, file name, file path, file attribute, application program name, host name, operating system, security setting, location, time, or others.

The data protection client sends a policy decision request to a first policy engine 1905 or 2005 with the contextual information.

In step (3) 2012, the first policy engine receives the policy decision request from the data protection client. The first policy engine determines the user belongs to the second organization. The first policy engine confirms that it has a trust relationship with a second policy engine 1910 or 2008 and decisions may be made in cooperation with the second policy engine.

The first policy engine selects a subset of the first plurality of policies on the first policy engine relevant to the operation, second organization and document. The first plurality of policies is deployed from a first policy server 1906. The first policy engine evaluates the subset of the first plurality of policies to produce a first decision. The first decision comprises allow or deny, and optionally a plurality of obligations. Obligations are tasks to be carried out by the first policy engine or the data protection client. If the first decision is allow, the first policy engine sends a guest policy request addressed to the second policy engine to a federated authorization server 1912 or 2009 with information on the user and document. If the first decision is deny, the data protection client denies the operation. The server application fails to open the document.

In step (4) 2013, the federated authorization server receives the guest policy request from the first policy engine. The federated authorization server determines that destination of the guest policy request is the second policy engine. The federated authorization server forwards the guest policy request to the second policy engine.

In step (5) 2014, the second policy engine receives the guest policy request from the federated authorization server. The second policy engine selects a subset of the second plurality of policies or a plurality of guest policies on the second policy engine relevant to the user (or Guest Policies XI). Guest Policies XI controls access by the user to information or documents in the first organization.

The second policy engine response to the guest policy request from the federated authorization server. The response comprises Guest Policies XI.

In step (6) 2015, the federated authorization server receives the response to the guest policy request from the second policy engine. The federated authorization server routes the response to the first policy engine.

In step (7) 2016, the first policy engine stores Guest Policies XI locally. The first policy engine will use Guest Policies XI to make decisions on subsequent access to information or documents by the user. The first policy engine evaluates Guest Policies XI to produce a second decision. The second decision comprises allow or deny, and optionally a plurality of obligations.

In step (8) 2017, if the second decision is allow, the server application opens the document successfully. The server application returns the document to the client application. If the second decision is deny, the server application fails to open the document. The server application returns an error to the client application indicating access to the document is denied.

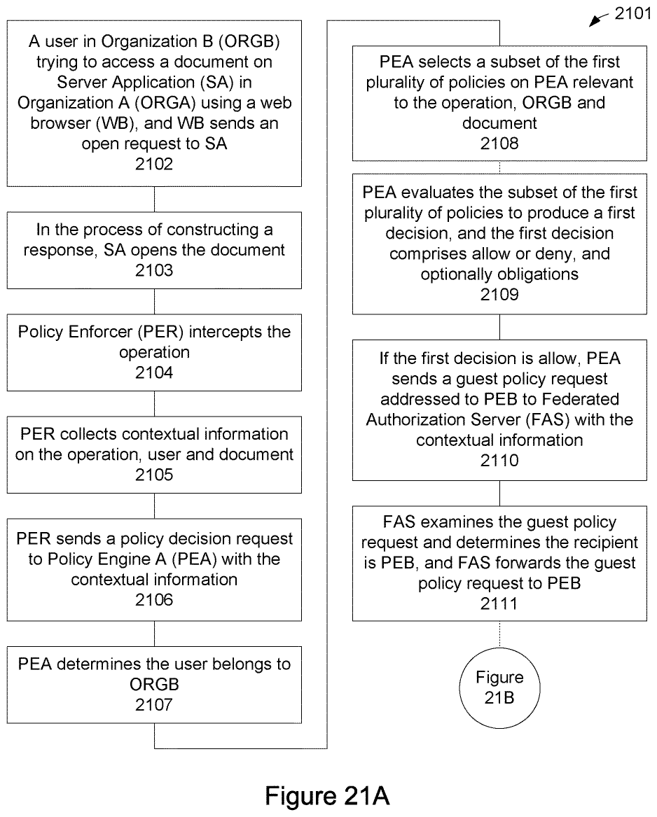

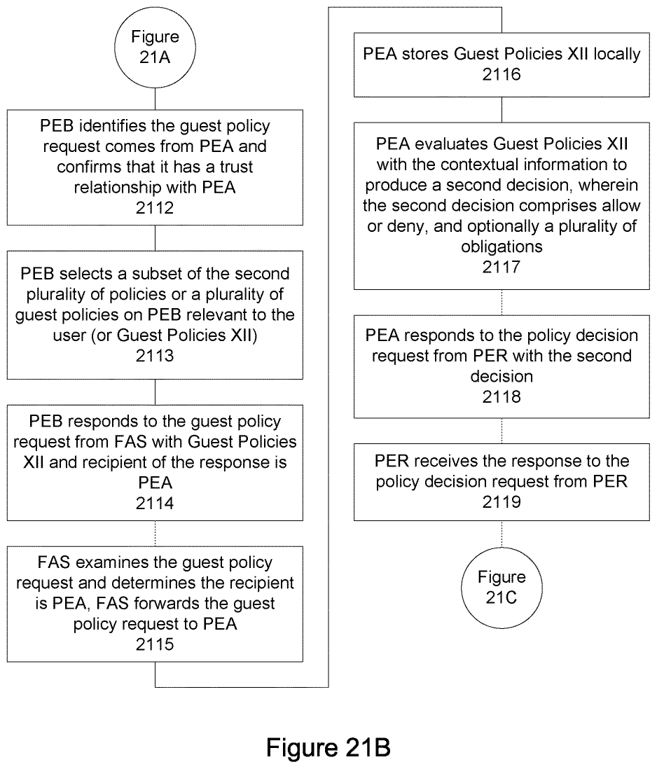

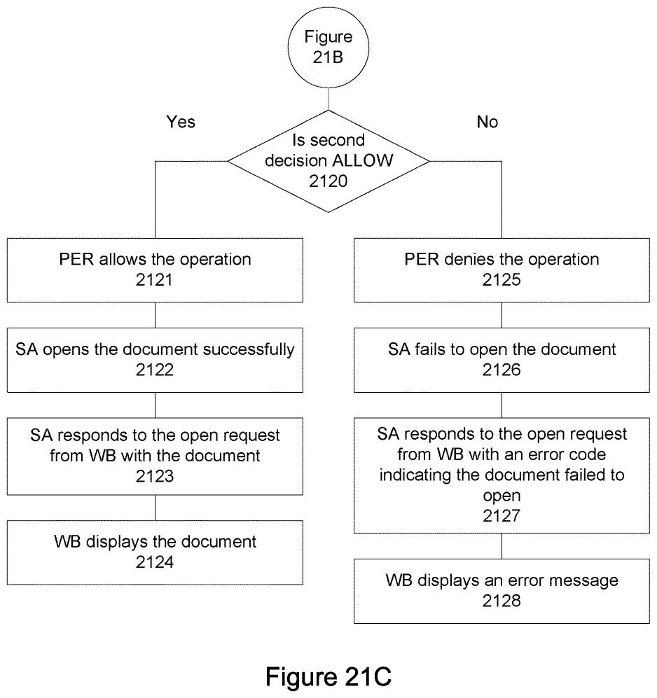

Referring to FIGS. 21A-21C, a flow diagram 2101 shows cooperative policy enforcement on access to a document in a first organization 2002 by a user from a second organization 2006 where policy decisions are made jointly by policy engines in the two organizations communicating through a federated authorization server 2009.

In an example, a user in Organization B (ORGB) 1907 or 2006 trying to access a document on Server Application (SA) 1903 or 2003 in Organization A (ORGA) 1902 or 2002 using a web browser (WB) 2007.

In step 2102, WB sends an open request to SA. The open request comprises information on the document. Examples of information on the document include document identifier, file name, file path, file attribute, host name, or others. If the open request is a HTTP GET request, the document is specified in an URL.

In step 2103, SA receives the open request from WB. In the process of constructing a response, SA opens the document.

In step 2104, Policy Enforcer (PER) 1904 or 2004 intercepts the operation opening the document.

In step 2105, PER collects contextual information on the operation, user and document. Examples of contextual information include open operation, user name, user identifier, user attribute, file name, file path, file attribute, application program name, host name, operating system, security setting, location, time, or others.

In step 2106, PER sends a policy decision request to Policy Engine A (PEA) 1905 or 2005 with the contextual information.

In step 2107, PEA receives the policy decision request from PER. PEA determines the user belongs to ORGB. PEA confirms that it has a trust relationship with Policy Engine B (PEB) 1910 or 2008 and decisions may be made in cooperation with PEB.

In step 2108, PEA selects a subset of the first plurality of policies on PEA relevant to the operation, ORGB and document. The first plurality of policies on PEA is deployed from Policy Server A 1906.

In step 2109, PEA evaluates the subset of the first plurality of policies to produce a first decision. The first decision comprises allow or deny, and optionally a plurality of obligations.

In step 2110, if the first decision is allow, PEA sends a guest policy request addressed to PEB to Federated Authorization Server (FAS) 1912 or 2009 with the contextual information.

In step 2111, if the first decision is allow, FAS receives the guest policy request from PEA. FAS examines the guest policy request and determines the recipient is PEB. FAS forwards the guest policy request to PEB.

In step 2112, if the first decision is allow, PEB receives the guest policy request from FAS. PEB identifies the guest policy request comes from PEA. PEB confirms that it has a trust relationship with PEA.

In step 2113, if the first decision is allow, PEB selects a subset of the second plurality of policies or a plurality of guest policies on PEB relevant to the user (or Guest Policies XII). The second plurality of policies on PEB is deployed from Policy Server B 1911. Guest Policies XII controls access by the user to information or documents in ORGA.

In step 2114, if the first decision is allow, PEB responds to the guest policy request from FAS. The response comprises Guest Policies XII. The recipient of the response is PEA.

In step 2115, if the first decision is allow, FAS receives the response to the guest policy request from PEB. FAS examines the guest policy request and determines the recipient is PEA. FAS forwards the guest policy request to PEA.

In step 2116, if the first decision is allow, PEA receives the guest policy request from FAS. PEA stores Guest Policies XII locally. PEA will use Guest Policies XII to make decisions on subsequent access to information or documents by the user.

In step 2117, if the first decision is allow, PEA evaluates Guest Policies XII with the contextual information to produce a second decision. The second decision comprises allow or deny, and optionally a plurality of obligations.

In step 2118, if the first decision is allow, PEA responds to the policy decision request from PER. The response comprises the second decision.

In step 2119, if the first decision is allow, PER receives the response to the policy decision request from PER.

In step 2121, if the second decision is allow, PER allows the operation.

In step 2122, if the second decision is allow, SA opens the document successfully.

In step 2123, if the second decision is allow, SA responds to the open request from WB. The response comprises the document.

In step 2124, if the second decision is allow, WB receives the response to the open request from SA. WB displays the document.

In step 2125, if the second decision is deny, PER denies the operation.

In step 2126, if the second decision is deny, SA fails to open the document.

In step 2127, if the second decision is deny, SA responds to the open request from WB with an error code indicating the document failed to open.

In step 2128, if the second decision is deny, WB receives the response to the open request from SA. WB displays an error message.

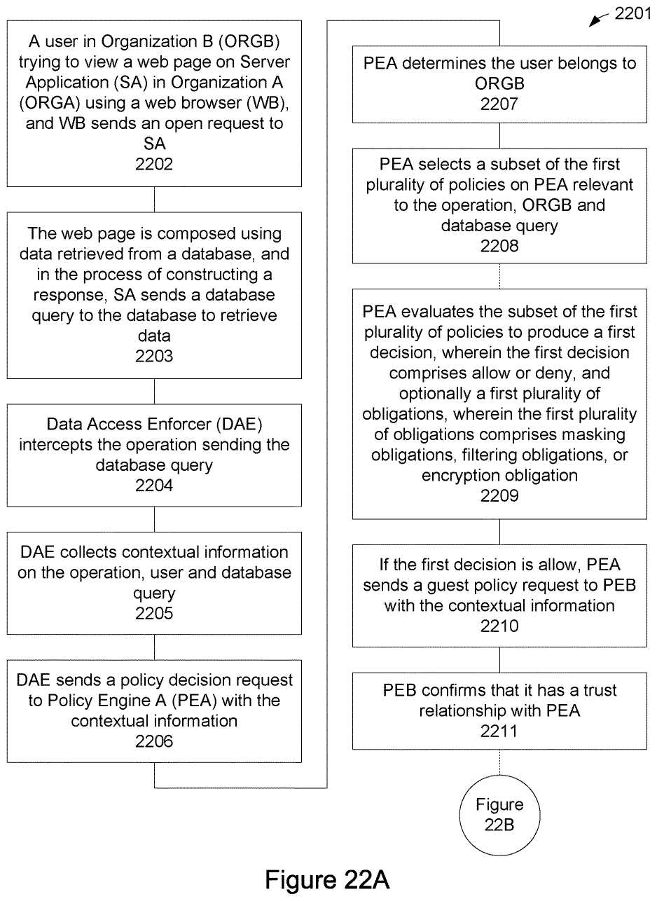

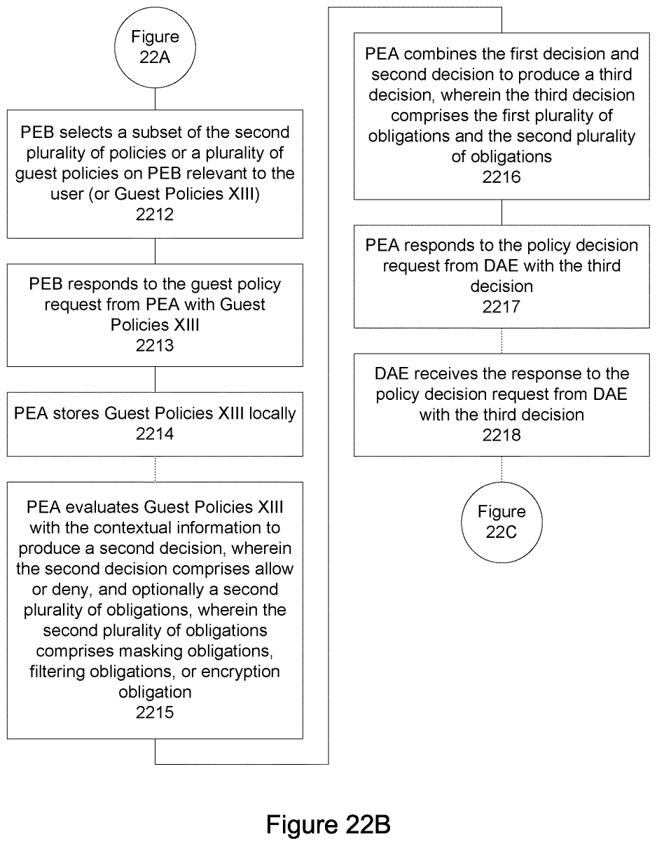

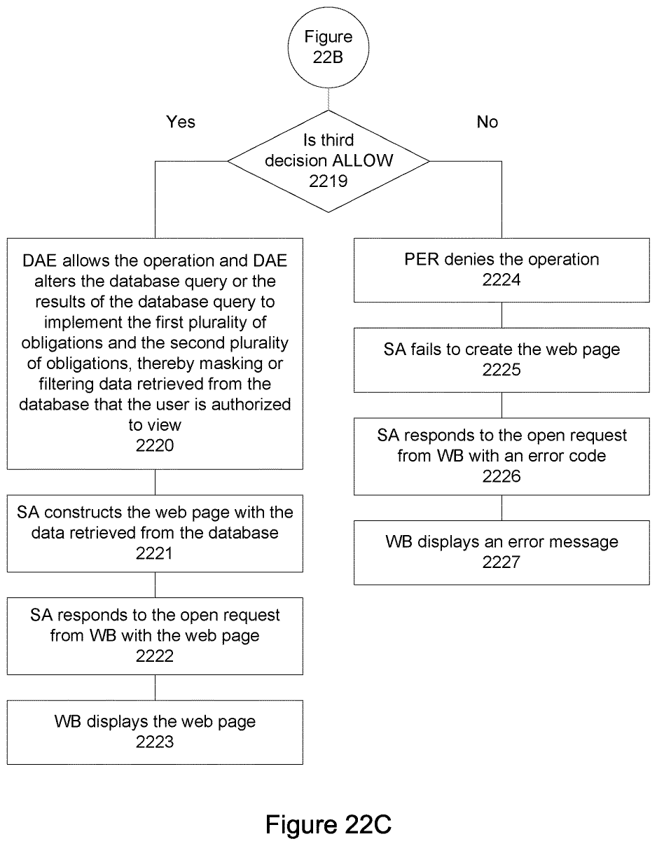

Referring to FIGS. 22A-22C, a flow diagram 2201 shows cooperative policy enforcement on viewing of data retrieved from a database in a first organization 2002 by a user from a second organization 2006 where access control and data obfuscation decisions are made jointly by policy engines in the two organizations.

In an example, a user in Organization B (ORGB) 1507, 1606, 1708, 1907 or 2006 trying to view a web page on Server Application (SA) 1503, 1603, 1703, 1903 or 2003 in Organization A (ORGA) 1502, 1602, 1702, 1902 or 2002 using a web browser (WB) 1607 or 2007. Policy Engine A (PEA) 1506, 1605, 1706, 1905 or 2005 in ORGA and Policy Engine B (PEB) 1510, 1608, 1707, 1910 or 2008 in ORGB or co-located in ORGA may communicate through a peer-to-peer connection 1512, 1609 or 1711 or federated authorization services 1912 or 2009.

In step 2202, WB sends an open request to SA. The open request comprises a Universal Resource Locator (URL) of the web page.

In step 2203, SA receives the open request from WB. The web page is composed using data retrieved from a database. In the process of constructing a response, SA sends a database query to the database to retrieve data.

In step 2204, Data Access Enforcer (DAE) 1504, 1604, 1704, 1904 or 2004 intercepts the operation sending the database query.

In step 2205, DAE collects contextual information on the operation, user and database query. Examples of contextual information include Java Database Connectivity (JDBC) operation, Open Database Connectivity (ODBC) operation, user name, user identifier, user attribute, database query, application program name, host name, operating system, security setting, location, time, or others.

In step 2206, DAE sends a policy decision request to PEA with the contextual information.

In step 2207, PEA receives the policy decision request from DAE. PEA determines the user belongs to ORGB. PEA confirms that it has a trust relationship with PEB and decisions may be made in cooperation with PEB.

In step 2208, PEA selects a subset of the first plurality of policies on PEA relevant to the operation, ORGB and database query. The first plurality of policies on PEA is deployed from Policy Server A 1505, 1705 or 1906.

In step 2209, PEA evaluates the subset of the first plurality of policies to produce a first decision. The first decision comprises allow or deny, and optionally a first plurality of obligations. The first plurality of obligations comprises masking obligations, filtering obligations, encryption obligation, any combinations thereof, or others. Masking obligation masks (or obfuscates, or redacts) data (e.g., fields or columns) returned by a database query (e.g., SQL). Filtering obligation filters (or restricts, or limits) data (e.g., records or rows) returned by a database query. Encryption obligation encrypts data (e.g., fields or columns) returned by a database query. The first decision protects data retrieved from the database from being viewed by users in ORGB who are not authorized to view the data.

In step 2210, if the first decision is allow, PEA sends a guest policy request to PEB with the contextual information.

In step 2211, if the first decision is allow, PEB receives the guest policy request from PEA. PEB confirms that it has a trust relationship with PEA.

In step 2212, if the first decision is allow, PEB selects a subset of the second plurality of policies or a plurality of guest policies on PEB relevant to the user (or Guest Policies XIII). The second plurality of policies on PEB is deployed from Policy Server B 1511, 1709 or 1911. Guest Policies XIII controls access by the user to data retrieved from the database in ORGA.

In step 2213, if the first decision is allow, PEB responds to the guest policy request from PEA. The response comprises Guest Policies XIII.

In step 2214, if the first decision is allow, PEA receives the guest policy request from PEB. PEA stores Guest Policies XIII locally. PEA will use Guest Policies XIII to make decisions on subsequent viewing of data from the database by the user.

In step 2215, if the first decision is allow, PEA evaluates Guest Policies XIII with the contextual information to produce a second decision. The second decision comprises allow or deny, and optionally a second plurality of obligations. The second plurality of obligations comprises masking obligations, filtering obligations, encryption obligation, any combinations thereof, or others. The second decision protects data retrieved from the database from being viewed by the user in ORGB who are not authorized to view the data.

In step 2216, if the first decision is allow, PEA combines the first decision and second decision to produce a third decision. The third decision comprises the first plurality of obligations and the second plurality of obligations.

In step 2217, if the first decision is allow, PEA responds to the policy decision request from DAE. The response comprises the third decision.

In step 2218, if the first decision is allow, DAE receives the response to the policy decision request from DAE. The response comprises the third decision.

In step 2220, if the third decision is allow, DAE allows the operation. DAE alters (or modifies) the database query or the results of the database query to implement the first plurality of obligations and the second plurality of obligations, thereby masking or filtering data retrieved from the database that the user is authorized to view.

In step 2221, if the third decision is allow, SA constructs the web page with the data retrieved from the database.

In step 2222, if the third decision is allow, SA responds to the open request from WB. The response comprises the web page.

In step 2223, if the third decision is allow, WB receives the response to the open request from SA. WB displays the web page.

In step 2224, if the third decision is deny, DAE denies the operation.

In step 2225, if the third decision is deny, SA fails to create the web page.

In step 2226, if the third decision is deny, SA responds to the open request from WB with an error code.

In step 2227, if the third decision is deny, WB receives the response to the open request from SA. WB displays an error message.

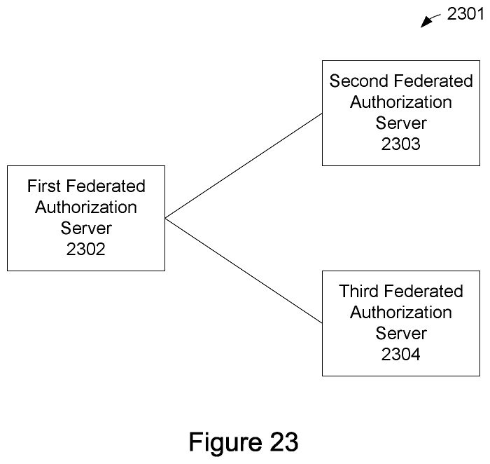

FIG. 23 shows a block diagram 2301 of federated authorization servers 2302, 2003 and 2304 in a hierarchical arrangement. Federated authorization servers may be arranged in a tree structure. Each federated authorization server maintains a routing table that provides information necessary for it to route requests (e.g., guest policy request or policy decision request) to their recipient policy engines.

In an example, a first federated authorization server 2302 is a root federate authorization server which connects to a second federated authorization server 2303 in a first organization 1902 or 2002 and a third federated authorization server 2304 in a second organization 1907 or 2006. The second federated authorization server connects to a first plurality of policy engines 1905 or 2005 in the first organization, and the third federated authorization server connects to a second plurality of policy engines 1910 or 2008 in the second organization. When a first policy engine in the first organization sends a guest policy request addressed to a second policy engine in the second organization through the second federated authorization server, the second federated authorization server forwards the guest policy request to the third federated authorization server if the second federated authorization server have prior communication with the second policy engine and maintains an entry on its routing table. Otherwise, the second federated authorization server forwards the guest policy request to the first federated authorization server. When the guest policy request is successfully routed to the second policy engine, the second federated authorization server saves the route information of the second policy engine to its routing table. The route information shall be used in subsequent communications with the second policy engine. The route information may expire after a period of time.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description shall enable others skilled in the art to best utilize and practice the invention in various embodiments and with various modifications as are suited to a particular use. The scope of the invention is defined by the following claims.

What is claimed is:

1. A method comprises:
providing a server application in a first organization having access to a plurality of information or documents, wherein the plurality of information or documents is protected by a data protection client;
providing a first policy engine in the first organization having a first plurality of policies, wherein the first policy engine makes decisions that control access to or use of the plurality of information or documents according to the first plurality of policies when requested by the data protection client;
providing a second policy engine in a second organization having a second plurality of policies;
providing a user in the second organization attempting to open a document on the server application using a web browser, wherein the document is protected by the data protection client;
at the web browser, sending an open request to the server application, wherein the open request comprises information on the document;
at the server application, opening the document to prepare a response to the open request;
at the data protection client, intercepting the open operation;
at the data protection client, collecting contextual information on the user, the open operation and the document;
at the data protection client, sending a policy decision request to the first policy engine, wherein the policy decision request comprises the contextual information;
at the first policy engine, determining the user belongs to the second organization;
at the first policy engine, selecting a subset of the first plurality of policies relevant to the second organization, the open operation and the document;
at the first policy engine, evaluating the subset of the first plurality of policies to produce a first decision, wherein the first decision determines if users in the second organization are allowed to open the document;
if the first decision is allow, at the first policy engine, sending a guest policy request to the second policy engine;
if the first decision is allow, at the second policy engine, responding to the guest policy request from the first policy engine, wherein the response comprises a plurality of guest policies, wherein the plurality of guest policies shall be used by the first policy engine to make decisions on access or use of the plurality of information or documents by the user;
if the first decision is allow, at the first policy engine, evaluating the plurality of guest policies to produce a second decision, wherein the second decision determines if the user is allowed to open the document;
if the first decision is deny, at the first policy engine, responding to the policy decision request from the data protection client, wherein the response comprises the first decision;
if the first decision is deny, at the data protection client, disallowing the open operation, wherein the server application fails to open the document;
if the first decision is deny, at the server application, responding to the open request from the web browser, wherein the response comprises a first error message;
if the first decision is deny, at the web browser, displaying the first error message;
if the second decision is allow, at the first policy engine, responding to the policy decision request from the data protection client, wherein the response comprises the second decision;
if the second decision is allow, at the data protection client, allowing the open operation, wherein the server application opens the document successfully;
if the second decision is allow, at the server application, responding to the open request from the web browser, wherein the response comprises the document;
if the second decision is allow, at the web browser, displaying the document;
if the second decision is deny, at the first policy engine, responding to the policy decision request from the data protection client, wherein the response comprises the second decision;
if the second decision is deny, at the data protection client, disallowing the open operation, wherein the server application fails to open the document;
if the second decision is deny, at the server application, responding to the open request from the web browser, wherein the response comprises a second error message; and
if the second decision is deny, at the web browser, displaying the second error message.

2. The method of claim 1 wherein the first plurality of policies comprises access or use control policies.

3. The method of claim 1 wherein the first plurality of policies comprises data access policies.

4. The method of claim 1 wherein the first policy engine and the second policy engine have an established trust relationship.

5. The method of claim 1 wherein at the first policy engine, determining the user belongs to the second organization further comprises:
extracting a domain name in an email address the user used to log on to the server application; and
comparing the domain name with known domain names of the second organization to determine if the user belongs to the second organization.

6. The method of claim 1 wherein the guest policy request comprises information on the user.

7. The method of claim 6 wherein if the first decision is allow, at the second policy engine, responding to the guest policy request from the first policy engine, wherein the response comprises a plurality of guest policies further comprises:
selecting a subset of the second plurality of policies relevant to the user, wherein the plurality of guest policies comprises the subset of the second plurality of policies, wherein the plurality of guest policies controls access or use of the plurality of information or documents in the first organization by the user.

8. The method of claim 6 wherein if the first decision is allow, at the second policy engine, responding to the guest policy request from the first policy engine, wherein the response comprises a plurality of guest policies further comprises:
selecting a subset of the second plurality of policies relevant to the user;
evaluating the subset of the second plurality of policies to produce a third decision; and
retrieving a plurality of guest policies based on the third decision, wherein the plurality of guest policies controls access or use of the plurality of information or documents in the first organization by the user.

9. The method of claim 1 wherein the guest policy request comprises the contextual information.

10. The method of claim 9 wherein if the first decision is allow, at the second policy engine, responding to the guest policy request from the first policy engine, wherein the response comprises a plurality of guest policies further comprises:
selecting a subset of the second plurality of policies relevant to the user, the open operation and the document, wherein the plurality of guest policies comprises the subset of the second plurality of policies, wherein the plurality of guest policies controls access or use of the plurality of information or documents in the first organization by the user.

11. The method of claim 1 further comprises:
if the second decision is allow, at the first policy engine, storing the plurality of guest policies, wherein the plurality of guest policies is used in subsequent policy decisions on access to the plurality of information or documents by the user.

12. The method of claim 11 wherein the plurality of guest policies being storing becomes invalid after a period of time.

13. The method of claim 12 wherein the first policy engine denies the user access or use of the plurality of information or documents when the plurality of guest policies becomes invalid.

14. The method of claim 1 wherein the second decision comprises policy effect and obligations.

15. A method comprises:
providing a first organization having a plurality of information or documents, wherein the plurality of information or documents is protected by a data protection client;
providing a first policy engine in the first organization having a first plurality of policies, wherein the first policy engine makes decisions that control access to or use of the plurality of information or documents according to the first plurality of policies when requested by the data protection client;
providing a second policy engine in a second organization having a second plurality of policies;
providing users in the second organization having access to the plurality of information or documents in the first organization, wherein the access is governed by the first plurality of policies and the second plurality of policies;
at the first policy engine, receiving a policy decision request from the data protection client, wherein the policy decision request comprises contextual information on a user, an open operation and a document;
at the first policy engine, determining the user belongs to the second organization;
at the first policy engine, selecting a subset of the first plurality of policies relevant to the second organization, the open operation and the document;
at the first policy engine, evaluating the subset of the first plurality of policies to produce a first decision, wherein the first decision determines if users in the second organization are allowed to open the document;
if the first decision is allow, at the first policy engine, sending a guest policy request to the second policy engine;
if the first decision is allow, at the second policy engine, selecting a subset of the second plurality of policies relevant to the user;
if the first decision is allow, at the second policy engine, responding to the guest policy request from the first policy engine, wherein the response comprises a plurality of guest policies, wherein the plurality of guest policies comprises the subset of the second plurality of policies, wherein the plurality of guest policies shall be used by the first policy engine to make decisions on access or use of the plurality of information or documents by the user;
if the first decision is allow, at the first policy engine, evaluating the plurality of guest policies to produce a second decision, wherein the second decision determines if the user is allowed to open the document;
if the first decision is allow, at the first policy engine, responding to the policy decision request from the data protection client, wherein the response comprises the second decision; and
if the first decision is deny, at the first policy engine, responding to the policy decision request from the data protection client, wherein the response comprises the first decision.

16. The method of claim 15 wherein the first plurality of policies comprises access or use control policies.

17. The method of claim 15 wherein the first policy engine and the second policy engine have an established trust relationship.

18. The method of claim 15 wherein the first policy engine and the second policy engine are in a peer-to-peer arrangement, wherein the first policy engine sends requests directly to the second policy engine.

19. The method of claim 15 wherein the first policy engine and the second policy engine are connected to a federated authorization server, wherein the federated authorization server routes requests from the first policy engine to the second policy engine.

20. The method of claim 15 wherein the second decision comprises policy effect and obligations.
